(19) United States
(12) Patent Application Publication
(10) Pub. No.: US 2021/0285599 A1
(43) Pub. Date: Sep. 16, 2021

(54) SUPPORT ASSEMBLY AND MOUNTING SYSTEM

(71) Applicant: Salto, LLC, Philadelphia, PA (US)

(72) Inventor: Salvatore Sisto, East Brunswick, NJ (US)

(21) Appl. No.: 17/336,736

(22) Filed: Jun. 2, 2021

Related U.S. Application Data
(63) Continuation-in-part of application No. 16/528,788, filed on Aug. 1, 2019, now Pat. No. 11,054,083.
Application No. 16/528,788 is a continuation-in-part of application No. 15/877,938, filed on Jan. 23, 2018, now Pat. No. 10,393,311.
Application No. 15/877,938 is a continuation of application No. 14/934,429, filed on Nov. 6, 2015, now Pat. No. 9,874,309.
Application No. 16/528,788 is a continuation-in-part of application No. 16/231,660, filed on Dec. 24, 2018, now Pat. No. 10,506,878.
Application No. 16/231,660 is a continuation-in-part of application No. 16/220,435, filed on Dec. 14, 2018, now Pat. No. 11,067,218.
Application No. 16/220,435 is a continuation of application No. 16/360,780, filed on Mar. 21, 2019, now Pat. No. 11,047,160.
(60) Provisional application No. 62/609,713, filed on Dec. 22, 2017.
(60) Provisional application No. 62/598,809, filed on Dec. 14, 2017.
(60) Provisional application No. 62/648,179, filed on Mar. 26, 2018.
(60) Provisional application No. 62/649,033, filed on Mar. 28, 2018.
(60) Provisional application No. 62/713,717, filed on Aug. 2, 2018.

(51) Int. Cl. F16M 13/02; A47B 96/02; A47K 17/02; A47K 3/12

(52) U.S. Cl. CPC F16M 13/025; A47K 3/125; A47K 17/022; A47B 96/022

(57) ABSTRACT

A support assembly that includes a structural member that is delimited by a first end and a second end with a first end cap configured to be at least partially disposed within the first end of the structural member and a second end cap configured to be at least partially disposed within the second end of the structural member to mount the structural member to a structure. The support assembly allows for forces to be applied in all directions without causing rotation or disengagement of the support assembly from a mounting structure.

### CROSS-REFERENCE TO RELATED APPLICATIONS

This application is a continuation-in-part of U.S. patent application Ser. No. 16/528,788, filed Aug. 1, 2019, which is a continuation-in-part of U.S. patent application Ser. No. 15/877,938, filed Jan. 23, 2018, now U.S. Pat. No. 10,393,311, which is a continuation of U.S. patent application Ser. No. 14/934,429, filed Nov. 6, 2015, now U.S. Pat. No. 9,874,309. U.S. patent application Ser. No. 16/528,788 is also a continuation-in-part of U.S. patent application Ser. No. 16/231,660, filed Dec. 24, 2018, now U.S. Pat. No. 10,506,878, which claims priority to U.S. Provisional Patent Application Ser. No. 62/609,713, filed Dec. 22, 2017.

This application is also a continuation-in-part of U.S. patent application Ser. No. 16/220,435 filed Dec. 14, 2018, which claims priority to U.S. Provisional Application No. 62/598,809 filed Dec. 14, 2017 and U.S. Provisional Application No. 62/648,179 filed Mar. 26, 2018.

This application is also a continuation of U.S. patent application Ser. No. 16/360,780 filed Mar. 21, 2019, which claims priority to U.S. Provisional Application No. 62/649,033 filed Mar. 28, 2018 and U.S. Provisional Application No. 62/713,717 filed Aug. 2, 2018.

The entireties of the aforementioned applications are hereby incorporated herein by reference.

### BACKGROUND

In one aspect, the present invention relates generally to a supporting structure and more particularly to a support assembly that is mountable between two converging structures.

Support assemblies that are mountable in a corner of a room between two converging walls are known. These support assemblies, such as footrests, grab bars, and shelving systems are commonly used, for example, in household showers, locker rooms, spas and the like. However, existing support assemblies do not allow for any significant force to be applied thereon without the support assembly rotating and/or becoming disengaged from a fixed position. As such, an individual can be severely injured due to the limited force that can safely sustained by known support assemblies.

Further, the present application also relates to racks for removable storage of containers in the form of bottles such as wine or other bottles.

Numerous types of racks are available for storage and display of containers such as wine or other bottles. Some storage racks are complex structures with many different components or parts, which are visually unattractive and more utilitarian in nature rather than ornamental. It is desirable to provide a container storage rack which combines the utilitarian aspects of the rack with a visually attractive and simple appearance that is aesthetically pleasing for displaying the containers in a public or private space.

In another aspect, the present invention relates generally to wall mounting systems and more particularly to mounting systems for fastening an accessory item, such as a shelf or other object, to a wall in an esthetically pleasing manner.

There are many instances where it is desirable to attach an accessory object or item to a wall, ceiling, or other surface. When sufficient structure exists to support the item, such as wood, metal, or masonry substructure, there are a variety of fasteners that will securely attach the item to the surface. However, hollow walls, ceilings, or other surfaces can present a situation where there is no structure behind the particular location of the fastener. For simplicity, the term “wall” will be understood to include walls, ceilings, or any other surface to which a fastener is attached. This presents a problem in that normal fasteners such as screws and nails can be easily pulled out from the wall because the wall material itself (drywall, for example) does not provide the required structure to securely hold the fastener.

Several types of fasteners exist that are specifically designed for use in a hollow wall. However, these designs often require force-distributing elements, such as plates or washers, on the wall surface that can be unsightly. These force-distributing elements can also create a space or gap between the exposed surface or face of the wall and the item being fastened to the wall. This space can cause an opening into which foreign material (such as food in a commercial kitchen) can fall and become lodged. In addition, the force-distributing elements may remain visible after the accessory item is mounted to the wall which may not be esthetically pleasing.

Accordingly, improved mounting systems that include some means of covering the force-distributing elements that also covers any space caused be the force-distributing elements are needed.

In yet another aspect, the present invention relates generally to doors, and more particularly to a door support and mounting assembly for mounting doors in a suspended sliding manner.

Sliding doors such as barn style door or similar are mounted in a suspended and linear sliding manner from an overhead support system of some type. This contrasts to conventional door mounting hardware which pivotably mount the doors via hinges to the vertical door jambs that define the doorway. Sliding doors do not consume the same room space necessary to operate a pivotably mounted door, and are therefore beneficial in tight spaces or other situations where a slidable door mounting is a desirable option. There are however drawbacks to current mounting hardware for sliding doors.

Hardware for mounting barn style doors typically use a fixed rail track and relatively large diameter pulley wheels which are attached to the door and roll along the rail as the door is opened or closed. U.S. Patent Application Publication No. 2017/0067276 discloses such an arrangement as an example. When the door is pushed in a direction along the rail, these large diameter pulleys are conducive for imparting significant momentum to the door once it starts rolling in a somewhat uncontrolled manner. The doors may therefore strike the ends of the track with considerable force causing damage and/or hardware mounting the track to the wall.

Another drawback to suspended barn style door mounting systems is a lack of means to resistant the door from moving and swaying in and out in a plane transverse to the direction of travel when a user pushes or leans against the large front/back side of the door. This can push the door off the rail and/or cause damage to the building structure. In addition, yet another drawback is that the mounting hardware for suspended sliding doors is sometimes bulky and unrefined in ornamental appearance, thereby limiting application of such installations to situations where aesthetics is not an overriding consideration. Thus, improvements are desired in suspended sliding door mounting hardware.

### BRIEF SUMMARY

The present invention is directed, in part, to a support assembly that allows for significant forces to be applied in all directions without causing rotation or disengagement of the support assembly from a mounting structure. This is because, as will be described in more detail below, the end caps of the support assembly are not mounted in parallel to each other. As a result, the rotational axes of the end caps contrast each other and in turn stabilize a structure extending between and from the end caps. Moment forces only exist in the area of the structure that exceeds the axes of the end caps. As such, the moment forces are minimized and the torsion forces are negated by opposing each other resulting in an assembly that is stable and does not rotate upon a force being applied thereto.

In one aspect, the invention may be a support assembly comprising: a first end cap configured to be coupled to a first support surface; a second end cap configured to be coupled to a second support surface that is substantially perpendicular to the first support surface; each of the first and second end caps comprising a block element; a support member comprising a first end face and a second end face, the first end face lying in a first plane and the second end face lying in a second plane that is substantially perpendicular to the first plane; a first slot formed into the first end face of the support member and a second slot formed into the second end face of the support member; and wherein the support member is coupled to the first and second end caps so that the block element of the first end cap is positioned within the first slot and the block element of the second end cap is positioned within the second slot to mount the support member from the first and second support surfaces.

In another aspect, the invention may be a support assembly comprising: a support member extending along a first axis and comprising a first end oriented at a first angle that is oblique relative to the first axis and a second end oriented at a second angle that is oblique relative to the first axis; a first end cap being mountable to a first support surface, the first end cap comprising a first body having a front surface and a rear surface and a first block element extending from the front surface; and a second end cap being mountable to a second support surface that is substantially perpendicular to the first support surface, the second end cap comprising a second body having a front surface and a rear surface and a second block element extending from the front surface; and wherein the support member is mounted to the first and second end caps with the first block element of the first end cap disposed within the first end of the support member and the second block element of the second end cap is disposed within the second end of the support member.

The present invention is also directed, in part, to a mounting system which provides an esthetically pleasing and secure anchoring system for attaching an accessory object or item to a hollow wall. This is accomplished by a special cover plate design that covers force-distributing mounting elements (e.g. plates or washers) on the surface of the wall and also covers any gap between the wall surface and the item or structural support for the item being fastened to the wall. Such accessory items may include shelves, soap dispensers, or other items. In some implementations, the mounting element and cover may be omitted and the accessory item or structural support for the item may be fastened directly to the wall, which may be hollow or solid. In one configuration, a cantilevered rectilinear perimeter frame may be mounted to the wall; which frame in turn supports the accessory item. The frame defines an upwardly open receptacle which receives at least a portion of the accessory item insert (e.g. shelf insert) therein. Various possible configurations and constructions of shelf inserts are disclosed herein. In another configuration, the item be may be a linearly elongated frameless shelf.

According to one aspect, a mounting system for fastening an item to a wall includes: a force-distributing plate configured to be positioned against an outer surface of the wall and between the item and the outer surface of the wall, the force-distributing plate creating a gap between the item and the outer surface of the wall; a cover that, when in an installed position, covers the force-distributing plate, the gap and an upper edge of the item, the cover having a first rear face and a second rear face; and a fastener that extends through the cover, the item, and the force-distributing plate and is configured to fasten the cover, the item, and the force-distributing plate to the wall; wherein the first rear face of the cover contacts the item in an installed position, and the second rear face of the cover contacts the outer surface of the wall in the installed position.

According to another aspect, a mounting system for fastening an accessory to a wall includes: a support structure configured for mounting an accessory thereto, the support structure comprising a plurality of side elements each including a vertical portion and a horizontal portion; a force-distributing plate configured to be positioned against an outer surface of the wall and between the wall and a mountable one of the side elements configured for fastening to the wall, the force-distributing plate creating a gap between the mountable one of the side elements and the outer surface of the wall; a cover configured to cover the force-distributing plate, the gap, and the mountable one of the side elements adjacent to the force-distributing plate, the cover having a first rear face and a second rear face; a fastener that extends through the cover, the mountable one of the side elements, and the force-distributing plate, the fastener being configured to fasten the cover, the mountable one of the side elements, and the force-distributing plate to the wall in stacked relationship; wherein the first rear face of the cover contacts the one of the side elements in an installed position, and the second rear face of the cover contacts the outer surface of the wall in the installed position. In one embodiment, the accessory is a shelf. In another embodiment, the accessory is a soap dispenser.

A method for mounting an item to a wall is also provided. The method includes: providing an item to be mounted to the wall, a cover, and a force-distributing plate configured for placement against a surface of the wall; forming an assembly by inserting in order a threaded shaft of the fastener with an expansion part coupled to the shaft through a hole in the cover, a hole in the item, a hole in the force-distributing plate, and a pre-drilled hole in the wall; abuttingly engaging the force-distributing plate against the wall; and tightening the fastener, wherein the expansion part changes from an unexpanded state prior to tightening to an expanded state securing the item to the wall.

According to another aspect, a shelf support system comprises: a wall defining an outer surface; a perimeter frame formed by a plurality of side elements, at least one of the side elements mounted to the wall which supports the perimeter frame in a cantilevered manner; the perimeter frame defining an upwardly open receptacle; and a shelf insert inserted into the upwardly open receptacle, the perimeter frame circumscribing the shelf insert and at least partially concealing a side surface of the shelf insert, a top surface of the shelf insert being exposed.

According to another aspect, a shelf support system comprises: a wall defining an outer surface; a perimeter frame formed by a plurality of side elements, at least one of the side elements mounted to the wall which supports the perimeter frame in a cantilevered manner; the perimeter frame defining an upwardly open receptacle; and a shelf insert including a lower portion inserted into the upwardly open receptacle and an upper portion defining a top surface which extends beyond top edges of the side elements of the perimeter frame which are not mounted to the wall to form cantilevered overhangs.

The present invention is also directed, in part, to a mounting system for hanging a door in a suspended and sliding “barn style” manner from the building structure that overcomes the shortcomings of prior door mounting hardware. The door mounting system disclosed herein has improved aesthetics while including features that provide smooth operation and sufficient structural strength for hanging the door. Advantageously, the present door mounting system further includes provisions which reduce the rolling momentum of the door and prevents sway in a plane transverse to the door's direction of travel. The mounting system may variously be used with door systems having a single or double operating doors. In addition, the mounting system may be used with any type of sliding door in various environments and applications such as shower doors, closet doors, interior or exterior doors, and others.

In one non-limiting embodiment, a door mounting system for sliding translation of a door includes a horizontally/longitudinally elongated support rail, a pair of wall mounts such as standoffs rigidly anchoring the support rail to a vertical support surface, a door bracket movably engaging the support rail, and a door supported by the door bracket in a suspended manner, wherein the door is linearly translatable along the support rail. The mounting system may further comprise a linear needle roller bearing disposed at an interface between the door bracket and the support rail to facilitate sliding movement of the door bracket along the support rail and/or a nylon bearing sheet attached to the door bracket and slideably engaging a side surface of the support rail. The door bracket may include a hook-shaped hanger and an anti-sway bracket in one embodiment which is configured to arrest movement of the door in a plane transverse to the door's direction of travel. In one construction, the support rail, door bracket, and mounting standoffs may be formed of stainless steel for moist operating environments such as bathrooms.

In one aspect, a door mounting system for sliding translation of a door includes: a longitudinally elongated support rail defining a horizontally oriented mounting axis; a pair of wall mounts rigidly anchoring the support rail to a vertical support surface; a door bracket movably engaging the support rail; a door supported by the door bracket in a suspended manner; and a linear roller bearing disposed at an interface between the door bracket and support rail to facilitate movement of the mounting bracket along the support rail; wherein the door is linearly translatable along the support rail.

According to another aspect, a door mounting system for sliding translation of a door includes: a longitudinally elongated support rail defining a mounting axis; a pair of wall mounts rigidly anchoring the support rail to a vertical support surface; a door bracket movably engaging the support rail, the door bracket including a pair of open ends and rearwardly open channel extending between the ends, the channel slideably receiving the support rail therein; a door supported by the door bracket in a suspended manner; and a linear roller bearing disposed at an interface between the door bracket and support rail inside the channel to facilitate movement of the mounting bracket along the support rail; wherein the door is linearly translatable along the support rail via rolling engagement between the roller bearing and the door bracket.

According to another aspect, a method for using a mounting system for sliding translation of a door includes: providing a longitudinally elongated support rail defining a mounting axis, a pair of elongated wall mounts rigidly attached to the support rail, a door bracket including an opposing pair of open ends and a rearwardly open channel extending between the ends, and a linear roller bearing disposed inside the channel; attaching the door bracket to a door; anchoring the support rail to a vertical support surface of a building; lifting the door with attached door bracket; inserting the support rail through the open ends of the door bracket into the channel; engaging the linear roller bearing with a top surface of the support rail; and sliding the door in one of two direction on the support rail.

In some embodiments, the method may further include: the door bracket further including an anti-sway clip; applying a lateral transverse force against the door; and engaging a stop surface of the anti-sway clip with the support rail to arrest motion of the door in a plane transverse to the mounting axis.

In yet other embodiments, the method may further include: the linear roller bearing having a U-shaped body comprising a top wall and at least one lateral sidewall extending downwards from the top wall, the top wall including a plurality of top needle rollers engaging the top surface of the support rail, and the at least one lateral sidewall including a plurality of lateral needle rollers oriented transversely to the top needle rollers; and the step of applying the lateral transverse force against the door further engages an upper rear surface of the support rail with the lateral needle rollers and the anti-sway clip engages a lower rear surface of the support rail to arrest motion of the door in a plane transverse to the mounting axis.

In yet other embodiments, the method may further include: the linear roller bearing having a U-shaped body comprising a top wall and at least one sidewall extending downwards from the top wall, the top wall including a plurality of top needle rollers engaging the top surface of the support rail, and the at least one sidewall including a plurality of lateral needle rollers oriented transversely to the top needle rollers; applying a lateral transverse force against the door; and engaging a rear surface of the support rail with the lateral needle rollers to arrest motion of the door in a plane transverse to the mounting axis.

In another aspect, a roller bearing includes: a U-shaped body comprising a top wall and a pair of lateral sidewalls extending downwards from the top wall; the top wall including a plurality of top needle rollers configured and arranged to engage a corresponding first planar support surface of a support structure; the sidewalls each including a plurality of lateral needle rollers configured and arranged to engage corresponding second and third planar support surfaces of the support structure which are each oriented perpendicularly to the first planar support surface.

### BRIEF DESCRIPTION OF THE DRAWINGS

The present invention will become more fully understood from the detailed description and the accompanying drawings, wherein:

FIG. 1 is perspective view of a rack apparatus in an installed state on a support structure according an embodiment of the present invention;

FIG. 2 is right side view of the rack apparatus of FIG. 1 in the installed state;

FIG. 3 is a front view of the rack apparatus of FIG. 1 looking towards the support structure;

FIG. 4 is a top view of the rack apparatus of FIG. 1 in the installed state;

FIG. 5 is a cross-sectional view of the rack apparatus along line V-V of FIG. 2;

FIG. 6 is a perspective view of the rack apparatus of FIG. 1 in an in-use state;

FIG. 7 is side view of the rack apparatus of FIG. 6 in the in-use state;

FIG. 8 is a front view of the rack apparatus of FIG. 6 in the in-use state;

FIG. 9 is a top view of the rack apparatus of FIG. 6 in the in-use state;

FIG. 10 is a cross-sectional view of the rack apparatus in the in-use state along line X-X of FIG. 7;

FIG. 11 is a close-up cross-sectional view of the rack apparatus along line XI-XI of FIG. 10 before insertion of a bottle;

FIG. 12 is perspective view of a rack apparatus in an installed state according a second embodiment of the present invention;

FIG. 13 is side view of the rack apparatus of FIG. 12 in the installed state;

FIG. 14 is a front view of the rack apparatus of FIG. 12;

FIG. 15 is a top view of the rack apparatus of FIG. 12 in the installed state;

FIG. 16 is a cross-sectional view of the rack apparatus along line VI-VI of FIG. 13;

FIG. 17 is a perspective view of the rack apparatus of FIG. 12 in an in-use state;

FIG. 18 is side view of the rack apparatus of FIG. 17 in the in-use state;

FIG. 19 is a front view of the rack apparatus of FIG. 17 in the in-use state;

FIG. 20 is a top view of the rack apparatus of FIG. 17 in the in-use state;

FIG. 21 is a cross-sectional view of the rack apparatus in the in-use state along line VII-VII of FIG. 18;

FIG. 22A is a close-up cross-sectional view of the rack apparatus along line VII-VII of FIG. 18 before insertion of a bottle;

FIG. 22B is the close-up cross-sectional view of FIG. 22A during insertion of the bottle;

FIG. 22C is the close-up cross-sectional view of FIG. 22A during insertion of the bottle;

FIG. 22D is the close-up cross-sectional view of FIG. 22A after insertion of the bottle into the in-use state;

FIG. 23 is perspective view of a rack apparatus in an installed state according a third embodiment of the present invention;

FIG. 24 is side view of the rack apparatus of FIG. 23 in the installed state;

FIG. 25 is a front view of the rack apparatus of FIG. 23;

FIG. 26 is a top view of the rack apparatus of FIG. 23 in the installed state;

FIG. 27 is a cross-sectional view of the rack apparatus along line VIII-VIII of FIG. 24;

FIG. 28 is a perspective view of the rack apparatus of FIG. 23 in an in-use state;

FIG. 29 is side view of the rack apparatus of FIG. 28 in the in-use state;

FIG. 30 is a front view of the rack apparatus of FIG. 28 in the in-use state;

FIG. 31 is a top view of the rack apparatus of FIG. 28 in the in-use state;

FIG. 32 is a cross-sectional view of the rack apparatus in the in-use state along line XXI-XXI of FIG. 29;

FIG. 33 is perspective view of a rack apparatus in an installed state according a fourth embodiment of the present invention;

FIG. 34 is side view of the rack apparatus of FIG. 33 in the installed state;

FIG. 35 is a front view of the rack apparatus of FIG. 33;

FIG. 36 is a top view of the rack apparatus of FIG. 33 in the installed state;

FIG. 37 is a cross-sectional view of the rack apparatus along line IX-IX of FIG. 34;

FIG. 38 is a perspective view of the rack apparatus of FIG. 33 in an in-use state;

FIG. 39 is side view of the rack apparatus of FIG. 33 in the in-use state;

FIG. 40 is a front view of the rack apparatus of FIG. 33 in the in-use state;

FIG. 41 is a top view of the rack apparatus of FIG. 33 in the in-use state; and

FIG. 42 is a cross-sectional view of the rack apparatus in the in-use state along line XXXI-XXXI of FIG. 39.

FIG. 43 is a perspective view of an embodiment of a support assembly of the present invention;

FIG. 44 is a perspective view of the support assembly of FIG. 43 with the end caps in an uninstalled state;

FIG. 45 is a front view of the support assembly of FIG. 43;

FIG. 46 is a rear view of the support assembly of FIG. 43;

FIG. 47 is a bottom view of the support assembly of FIG. 43;

FIG. 48 is a first perspective view of an end of the support assembly of FIG. 43;

FIG. 49 is a second perspective view of an end of the support assembly of FIG. 43;

FIG. 50 is a partial bottom view of an end of the support assembly of FIG. 43;

FIG. 51A is a perspective view of a first end cap of the support assembly of FIG. 43;

FIG. 51B is a perspective view of a second end cap of the support assembly of FIG. 43;

FIG. 52A is a front view of the first end cap of the support assembly of FIG. 43;

FIG. 52B is a front view of the second end cap of the support assembly of FIG. 43;

FIG. 53A is a rear view of the first end cap of the support assembly of FIG. 43;

FIG. 53B is a rear view of the second end cap of the support assembly of FIG. 43;

FIG. 54A is a top view of the first end cap of the support assembly of FIG. 43;

FIG. 54B is a top view of the second end cap of the support assembly of FIG. 43;

FIG. 55A is a side view of the first end cap of the support assembly of FIG. 43;

FIG. 55B is a side view of the second end cap of the support assembly of FIG. 43;

FIG. 56 is an installation view of the end caps and tubular member of the support assembly being fixed to a structure;

FIG. 57 is a perspective view of the support assembly in an assembled state, fixed to a structure;

FIG. 58 is a perspective view of the support assembly in an assembled state, fixed to a structure that includes a cantilevered plate;

FIG. 59 is a rear view of FIG. 58;

FIG. 60 is a front view of FIG. 58;

FIG. 61 is an upper perspective view of a mounting system with an accessory item in accordance with exemplary embodiments of the invention;

FIG. 62 is an upper perspective view of a mounting system in accordance with exemplary embodiments of the invention;

FIG. 63 is an upper perspective view of the mounting system of FIG. 61 in an unassembled state;

FIG. 64 is an upper perspective view of the mounting system of FIG. 62 in an unassembled state;

FIG. 65 is a front view of the mounting system of FIG. 61;

FIG. 66 is top view of the mounting system of FIG. 61;

FIG. 67 is a side view of the mounting system of FIG. 61 in an installed state;

FIG. 68 is a side sectional view of the mounting system of FIG. 61 in an installed state;

FIG. 69 is an upper perspective view of a mounting system with a perimeter frame support structure for supporting an accessory in accordance with exemplary embodiments of the invention;

FIG. 70 is a side view of the mounting system and support of FIG. 69 in an installed state;

FIG. 71 is a side sectional view of the mounting system and support of FIG. 69 in an installed state;

FIG. 72 is an upper perspective view of the support of FIG. 69;

FIG. 73 is a top view of the support of FIG. 69;

FIG. 74 is a bottom view of the support of FIG. 69;

FIG. 75 is a side view of the support of FIG. 69;

FIG. 76 is a production or workpiece blank used to fabricate the support of FIG. 69 prior to cutting;

FIG. 77 is the production blank of FIG. 16 after being cut to shape to be used to fabricate the support of FIG. 69;

FIG. 78 is an exploded upper perspective view of a shelf unit and the mounting system and support of FIG. 69;

FIG. 79 is an upper perspective view of the shelf unit, mounting system, and support of FIG. 78 in an assembled state;

FIG. 80 is a side sectional view of the shelf unit and mounting system and support of FIG. 79;

FIG. 81 is a top view of a shelf unit and the mounting system and support of FIG. 69 in an assembled state;

FIG. 82 is a bottom view of a shelf unit and the mounting system and support of FIG. 69 in an assembled state;

FIG. 83 is an exploded upper perspective view of a second embodiment of a shelf unit and the mounting system and support of FIG. 69;

FIG. 84 is an upper perspective view of the shelf unit and mounting system and support of FIG. 23 in an assembled state;

FIG. 85 is a side sectional view of the shelf unit and mounting system and support of FIG. 83;

FIG. 86 is a top view of the shelf unit and mounting system and support of FIG. 83;

FIG. 87 is a bottom view of the shelf unit and mounting system and support of FIG. 83;

FIG. 88 is side view of a soap dispenser in accordance with embodiments of the invention;

FIG. 89 is an exploded upper perspective view of the soap dispenser of FIG. 88 and the mounting system and support of FIG. 69;

FIG. 90 is a side view of the soap dispenser and mounting system and support of FIG. 29 in an assembled state;

FIG. 91 is an upper perspective view of a mounting system and support in accordance with exemplary embodiments of the invention;

FIG. 92 is an upper perspective view of the support of FIG. 91;

FIG. 93 is a top view of the support of FIG. 91;

FIG. 94 is a top view of the support of FIG. 91 showing a workpiece blank in an unassembled state prior to being bent to shape;

FIG. 95 is an exploded upper perspective view of a shelf unit and the mounting system and support of FIG. 91;

FIG. 96 is an upper perspective view of the shelf unit, mounting system, and support of FIG. 95 in an assembled state;

FIG. 97 is an upper perspective view of a shelf unit, mounting system, and support in accordance with exemplary embodiments of the invention in an assembled state;

FIG. 98 is a lower perspective view of the assembly of FIG. 97;

FIG. 99 is a lower perspective view of a shelf unit, mounting system, and support in accordance with exemplary embodiments of the invention in an assembled state;

FIG. 100 is an upper perspective view of the underside of the shelf unit of FIG. 99;

FIG. 101 is an upper perspective view of the underside of a shelf unit in accordance with exemplary embodiments of the invention;

FIG. 102 is an upper perspective view of the underside of a shelf unit in accordance with exemplary embodiments of the invention;

FIG. 103 is an upper perspective view of the underside of a shelf unit in accordance with exemplary embodiments of the invention;

FIG. 104 is a lower perspective view of a shelf unit of FIG. 103, a mounting system, and a support in accordance with exemplary embodiments of the invention in an assembled state.

FIG. 105 is a perspective view of a sliding door mounting system according to an embodiment of the present disclosure;

FIG. 106 is a top view thereof;

FIG. 107 is a front view thereof;

FIG. 108 is an end view thereof;

FIG. 109 is a perspective view of an alternative embodiment of a sliding door mounting system according to the present disclosure;

FIG. 110 is a top view thereof;

FIG. 111 is a front view thereof;

FIG. 112 is an end view thereof;

FIG. 113 is a rear perspective view of a door bracket of the door mounting systems of FIGS. 105 and 109;

FIG. 114 is a rear perspective view thereof;

FIG. 115 is a rear view thereof;

FIG. 116 is a front view thereof;

FIG. 117 is an end view thereof;

FIG. 118 is a top plan view thereof

FIG. 119 is a perspective view of a linear needle roller bearing of the door mounting systems of FIGS. 105 and 109;

FIG. 120 is an alternative embodiment of a base plate of the door mounting systems of FIGS. 1 and 5;

FIG. 121 is a perspective view of an alternative embodiment of a U-shaped linear roller bearing;

FIG. 122 is an enlarged view thereof taken from FIG. 121;

FIG. 123 is a bottom view thereof;

FIG. 124 is a first longitudinal cross-sectional view taken from FIG. 123;

FIG. 125 is a second longitudinal cross-sectional view taken from FIG. 123;

FIG. 126 is a transverse cross-sectional view taken from FIG. 123;

FIG. 127 is an end view of the linear roller bearing of FIG. 121;

FIG. 128 is an view of the door mounting system of FIG. 105 which alternatively incorporates the U-shaped linear roller bearing of FIG. 116;

FIG. 129 is a transverse cross-sectional end view of an alternative embodiment of a mounting door bracket configured for mounting to hollow door; and

FIG. 130 is a longitudinal cross sectional view taken in FIGS. 108 and 128 as indicated which is representative of both of the linear needle roller bearings of the door mounting system assemblies of FIGS. 108 and 128 with respect to engagement of the needle rollers with the top surface of the mounting rail.

All drawings are schematic and not necessarily to scale. Parts given a reference numerical designation in one figure may be considered to be the same parts where they appear in other figures without a numerical designation for brevity unless specifically labeled with a different part number and described herein.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means+/−5% of the reference value.

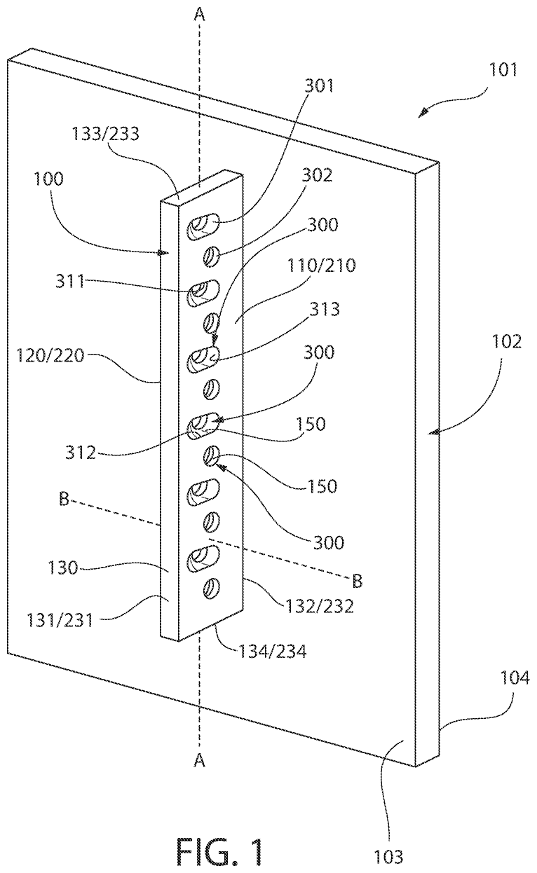

Referring now to FIGS. 1-4 and 6, the present invention includes a storage system 101 that comprises a support structure 102, a vertically oriented storage rack apparatus 100 (or “storage rack” or “rack” for brevity) coupled to the support structure, and at least one fastener 400. The rack apparatus 100 may be coupled to the support surface 102 by the at least one fastener 400—herein referred to as the “installed-state.” In preferred embodiments, at least two vertically spaced fasteners are provided. In the installed-state, the rack apparatus 100 may be used to support and store one or more containers 500—herein also referred to as the “in-use state.” The term “container” is used synonymously and interchangeably with the term “bottle” also referred to herein. Non-limiting examples of containers/bottles 500 include alcoholic and non-alcoholic beverage containers (e.g., wine bottles, etc.), as well as other non-beverage liquid containers (e.g. olive oil, etc.).

In a non-limiting embodiment, the support structure 102 may be a preferably rigid wall having an outer surface 103 that is opposite an inner surface 104. The outer surface 103 may face a room environment (i.e., the interior of a kitchen, restaurant, or the like) and the inner surface 104 may face a partition space or outer superstructure of a building (i.e., voids between adjacent dry wall boards and laterally spaced framing boards). Non-limiting examples of the wall may include dry-wall, gypsum board, plywood, and the like. The wall may optimally have a vertical orientation in one embodiment; however, the rack 100 may be used with a wall oriented at an acute angle to a vertical reference plane between 0 and 90 degrees.

The rack apparatus 100 may be vertically elongated in structure and oriented when installed on wall 102 comprising a first side or lateral major surface 110 that is opposite a second side or lateral major surface 120, and a plurality of side surfaces 130 that extend between the first and second major surfaces 110, 120. The major surfaces may be substantially parallel to each other and planar/flat in one embodiment as shown. In other possible configurations, the major surfaces may be arranged at an acute angle to each other. When facing the support surface wall 102, the first major surface 110 may be considered a left lateral major surface and the second major surface 120 may be considered a right lateral major surface for convenience of reference. The plurality of side surfaces 130 of rack apparatus 100 may collectively define a perimeter of each of the first major surface 110 and the second major surface 110.

The plurality of side surfaces 130 of rack apparatus 100 may comprise a first vertical front side surface 131 facing away from support structure 102 (e.g. wall) that is opposite a second vertical rear side surface 132 facing the support structure. The plurality of side surfaces 130 of rack apparatus 100 may further comprise an upward facing top surface 133 that is opposite a downward facing bottom surface 134. The first vertical side surface 131 of rack apparatus 100 may intersect the top surface 133 and the bottom surface 134 of rack apparatus 100. The second vertical side surface 132 may intersect the top surface 133 and the bottom surface 134 of rack apparatus 100. The first vertical side surface 131 and the second vertical side surface 132 of rack apparatus 100 may be substantially parallel. The top surface 133 and the bottom surface 134 of rack apparatus 100 may be substantially parallel.

The rack apparatus 100 may be elongated (i.e. length greater than lateral width and front-rear depth) such that the first and second major surfaces 110, 120 of the rack apparatus 100 extend along and substantially parallel to a longitudinal axis A-A, which defines a vertical centerline of the rack equally spaced between front and rear side surfaces and right and left lateral surfaces. The first vertical side surface 131 and the second vertical side surface 132 may extend along the longitudinal axis A-A. The longitudinal axis A-A may intersect the top surface 133 and the bottom surface 134. The rack apparatus 100 may further comprise a transverse axis B-B that extends perpendicular to the longitudinal axis A-A, whereby the transverse axis B-B intersects both the first and second major surface 110, 120 of the rack apparatus 100.

In the installed state, the second vertical rear surface 132 may face the outer surface 103 of the support structure 102. As discussed in greater detail herein, in the installed-state the fastener 400 may extend from the second vertical side surface 132 of the rack apparatus 100 and through the support structure 10. The second vertical side surface 132 of the rack apparatus 100 may abut and directly contact the outer surface 103 of the support structure 102. In the installed state, the first and second major surfaces 120 may be oriented in a direction that is substantially orthogonal to the outer surface 103 of the support structure 102.

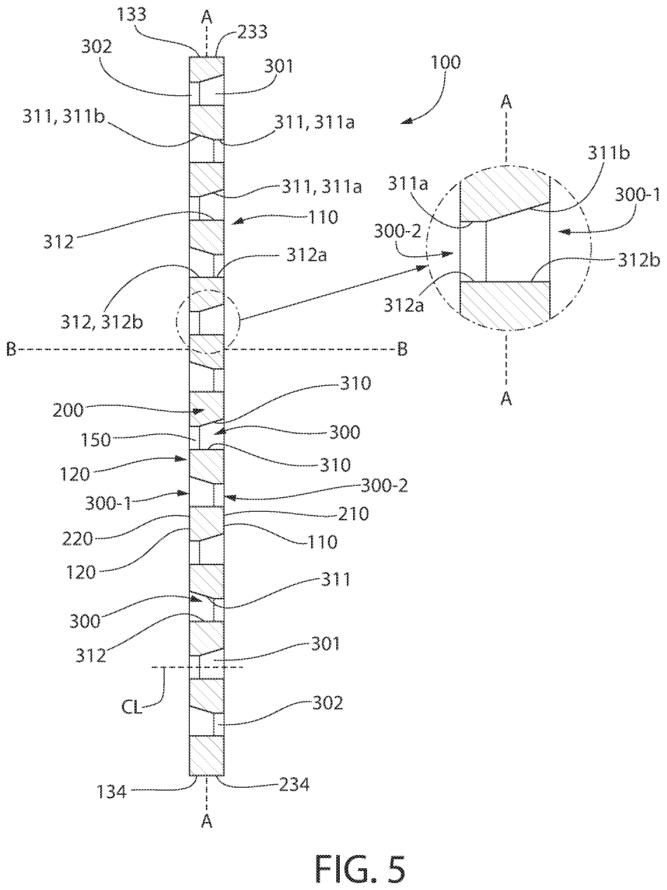

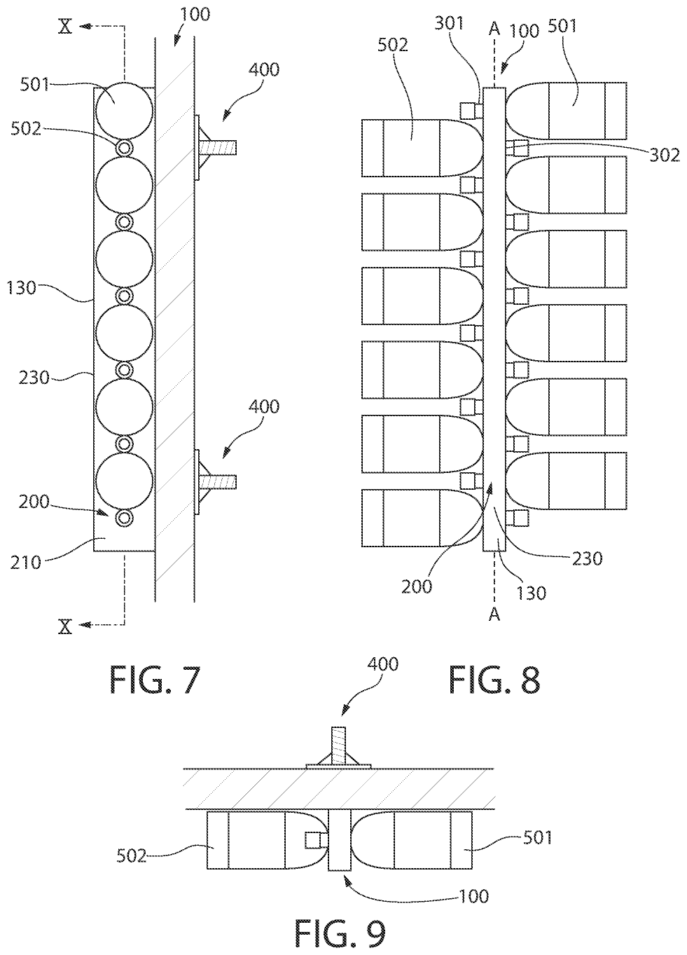

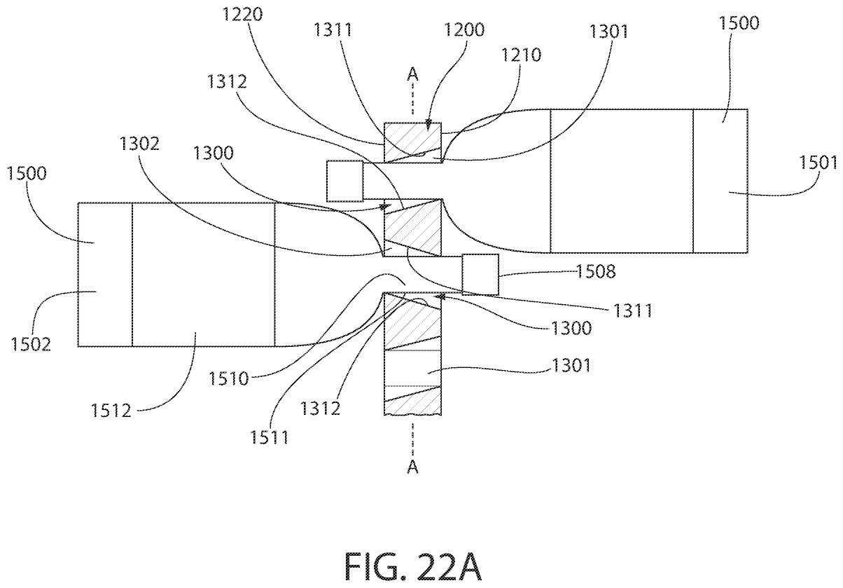

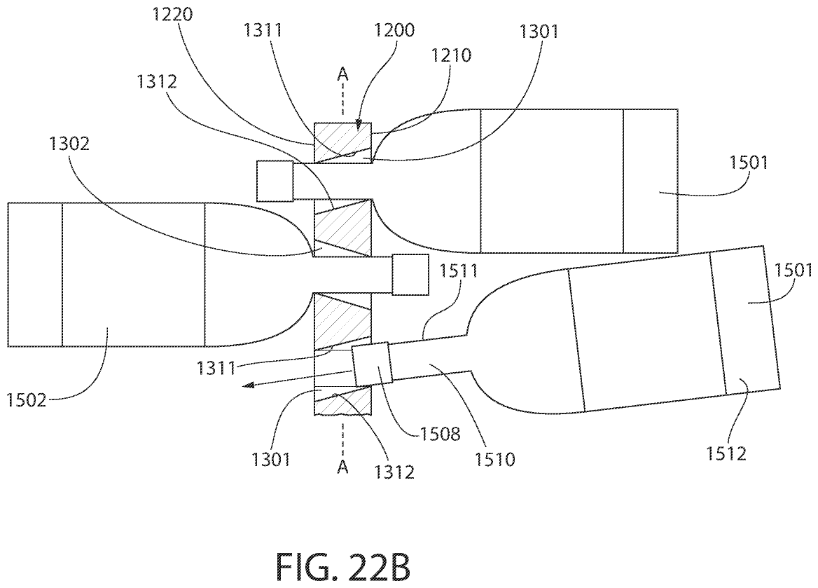

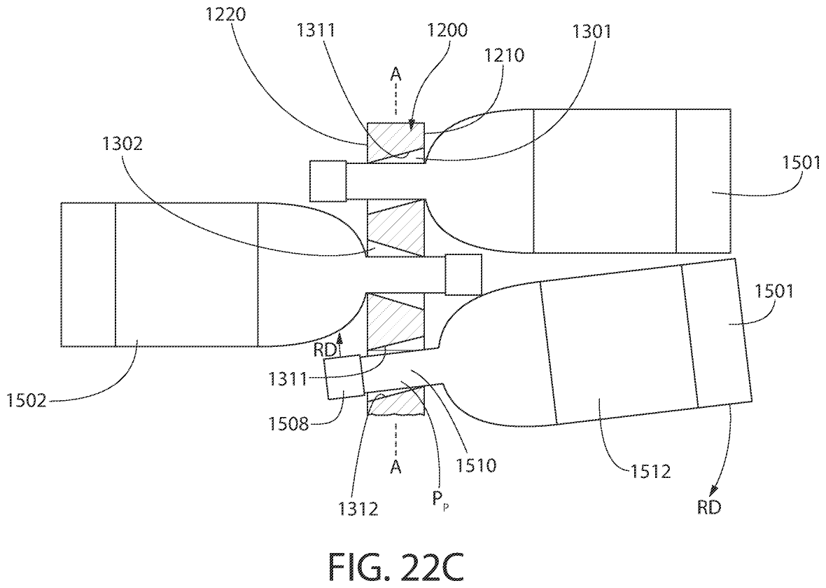

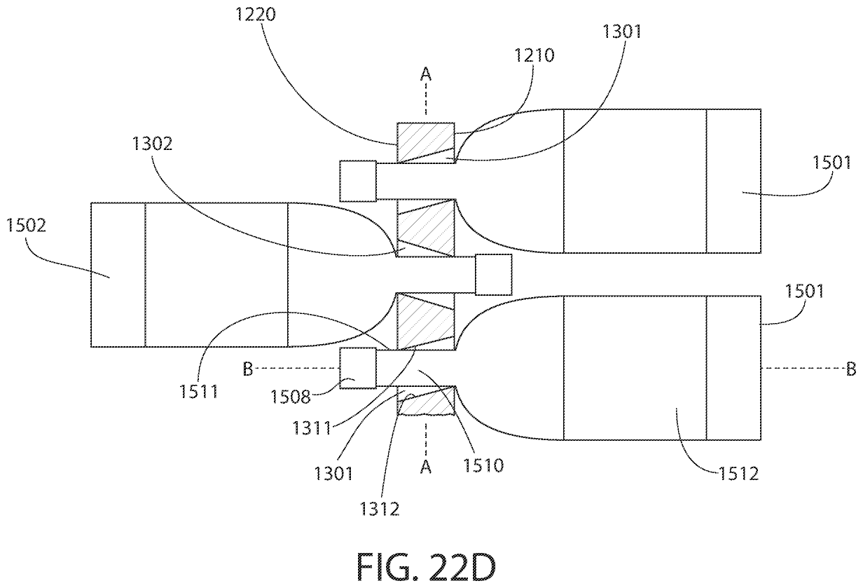

The body 200 of rack apparatus 100 comprises a plurality of vertically spaced apart container-mounting apertures 300 extending through and between major surfaces 110 and 120, as further described herein. The apertures are used to support the containers 500 from rack 100. In the embodiment of FIGS. 1-11, the mounting apertures 300 each define an aperture centerline CL which is oriented parallel to transverse axis B-B and perpendicular to longitudinal axis A-A (see, e.g. FIG. 5). In other embodiments, the mounting embodiments may be obliquely angled both the transverse and longitudinal axes (see, e.g. FIGS. 22A-B).

The rack apparatus 100 further comprises a plurality of container mounting features 150. These features include through passageways 150-1 defined by the mounting apertures 300 that extend from and through the first major surface 110 to the second major surface 120. As discussed in greater detail herein, the passageways 150-1 formed by each of the mounting features 150 may extend continuously from the first major surface 110 to the second major surface 120 to create an open channel there-between for inserting a neck portion of the container 500 therethrough. Each passageway 150-1 formed by each mounting feature 150 extends from the first major surface 110 to the second major surface 120 along a transverse axis B-B in a direction that is transverse the longitudinal axis A-A. The plurality of passageways 150-1 are arranged in a linear array that extends vertically along the longitudinal axis A-A, whereby each passageway is offset from an adjacent passage way by a non-zero distance as measured along the longitudinal axis A-A (the term “non-zero” connoting that the distance has some measurement value greater than zero).

In some embodiments, the rack apparatus 100 may further comprise an outer layer 200-2 that surrounds at least a portion of the body 200—as discussed in greater detail herein.

The rack body 200 may comprise a lateral first major surface 210 (e.g. right side when facing support structure wall 102) that is opposite a lateral second side major surface 220 (left side), and a plurality of side surfaces 230 that extend between the first and second major surfaces 210, 220 of the body 200. The plurality of side surfaces 230 may collectively define a perimeter of each of the first major surface 210 and the second major surface 210 of the body 200. The plurality of side surfaces 230 of the body 200 may comprise a first vertical front side surface 231 that is opposite a second vertical rear side surface 232. The plurality of side surfaces 230 of the body 200 may further comprise a top surface 233 that is opposite a bottom surface 234. The first vertical side surface 231 of the body 200 may intersect the top surface 233 and the bottom surface 234 of the body 200. The second vertical side surface 232 may intersect the top surface 233 and the bottom surface 234 of the body 200. The first vertical side surface 231 and the second vertical side surface 232 of the body 200 may be substantially parallel. The top surface 233 and the bottom surface 234 of the body 200 may be substantially parallel.

It bears noting that major surfaces 110, 120 of the rack apparatus 100 correspond to major surfaces 210, 220 of the rack body 200, respectively. Similarly, side surfaces 130 of the rack apparatus 100 described above (front 131, rear 132, top 133, bottom 134) each correspond to side surfaces 230 of the rack body 200 (front 231, rear 232, top 233, bottom 234). For convenience of reference, rack body 200 defines a lateral width between right and left lateral major surfaces 210, 220 (lateral major surfaces 110, 120), a depth between front and rear side surfaces 231, 232, and a length or height between top and bottom surfaces 233, and 234.

The surfaces 210 (right), 220 (left), 231 (front), 232 (rear), 233 (top), and 234 (bottom) are defined by right, left, front, rear, top, and bottom walls of the rack body 200 corresponding to these surfaces.

The rack body 200 is elongated in one embodiment such that the first and second major surfaces 210, 220 of the body 200 extend along and substantially parallel to the longitudinal axis A-A. The first vertical side surface 231 and the second vertical side surface 232 may extend along and parallel to the longitudinal axis A-A. The longitudinal axis A-A may intersect the top surface 233 and the bottom surface 234 of the body 200. The transverse axis B-B may intersect both the first and second major surface 210, 220 of the body 200.

The body 200 is preferably rigid in construction and may be formed from a first material such as wood, metal, ceramic, rigid/hard plastic, or a composite material (e.g. plywood, MDF, etc.) as some non-limiting examples. The first material may be rigid and have a first hardness. In a non-limiting example, the body 200 is formed from wood. In a non-limiting example, the body 200 may be formed from metal. The body 200 may be provided as a board or plank shaped piece of material, whereby the mounting apertures 300 are formed by cutting material from the board and/or plank. Non-limiting examples of cutting include drilling, CNC routing, and the like.

According to some embodiments, the first major surface 110 of the rack apparatus 100 may be formed from the body 200 such that the first major surface 110 comprises at least a portion of the first major surface 210 of the body 200. According to some embodiments, the second major surface 120 of the rack apparatus 100 may be formed from the body 200 such that the second major surface 120 may comprise at least a portion of the second major surface 220 of the body 200. According to some embodiments, the plurality of side surfaces 130 of the rack apparatus 100 may be formed from the body 200 such that at least one of the plurality of side surfaces 130 comprises at least a one of the plurality of side surfaces 230 of the body 200.

In particular, the first vertical side surface 131 of the rack apparatus 130 may comprise the first vertical side surface 231 of the body 200. The second vertical side surface 132 of the rack apparatus 130 may comprise the second vertical side surface 232 of the body 200. The top surface 133 of the rack apparatus 130 may comprise the top surface 233 of the body 233. The bottom surface 134 of the rack apparatus 130 may comprise the bottom surface 234 of the body 233.

According to the embodiments where the rack apparatus 100 may further comprise an outer layer 200-2 (represented by dashed lines in FIG. 3) to assist with retaining the container 500 (e.g. bottle) to the rack 200. The outer layer may form at least a portion of one or more of the first major surface 110 of the rack apparatus 100, the second major surface 120 of the rack apparatus 100, and/or one of the side surfaces 130 of the rack apparatus 100. In a non-limiting example, the outer layer 200-2 may be formed from a second material that is relatively softer than the first material which forms an inner core 200-1. The second material of the outer layer 200-2 may have a second hardness, whereby the second hardness is lower than the first hardness of the core material of the rack body 200. The second material may be formed a deformable resilient material in some embodiments. Non-limiting examples of the second material include organic polymers, inorganic polymers, elastomers, rubber, and composite materials as some non-limiting examples. The second material may be selected such to provide a frictional grip on rigid and hard materials from which the container 500 (e.g. bottle) may be constructed, such as hard plastic, glass, ceramic, metal, and the like. As discussed in greater detail here, the second material may help provide an increased frictional engagement/interference fit against an outer surface 511 of a container 500—specifically the outer surface 511 of a neck portion 510 of a container 500, to retain the container in the mounting aperture 300.

Referring now generally to FIGS. 1-2, 5 and 11, as discussed, the container mounting apertures 300 of rack 100 will now be discussed in greater detail. The plurality of apertures 300 form at least a portion of the mounting features 150 of the rack apparatus 100, along with the rack walls that define the apertures. Specifically, each aperture 300 forms the through passageway 150-1 of the mounting feature 150 that extends from the first major surface 110 to the second major surface 120 of the rack apparatus 100. Each aperture 300 is formed as a “closed-geometry” completely bounded and circumscribed by aperture walls 310 all around. Accordingly, aperture 300 does not penetrate the front or rear surfaces 131, 132 of the rack 100 in the present embodiment, only the major surfaces (see, e.g. FIG. 5). Each aperture 300 thus is defined by the aperture walls 310 that extend completely through the rack body 200 from the first major surface 110 of the rack apparatus 100 to the second major surface 120 of the rack apparatus 100.

As discussed in greater detail herein, each of the plurality of apertures 300 are configured to receive a portion of the container 500, specifically the narrowed neck portion, whereby at least a portion of the aperture walls 310 are configured to contact and engage an outer surface 511 of the neck portion of the container 500, thereby supporting the container 500 in a cantilevered manner when the storage system 101 is in the in-use state.

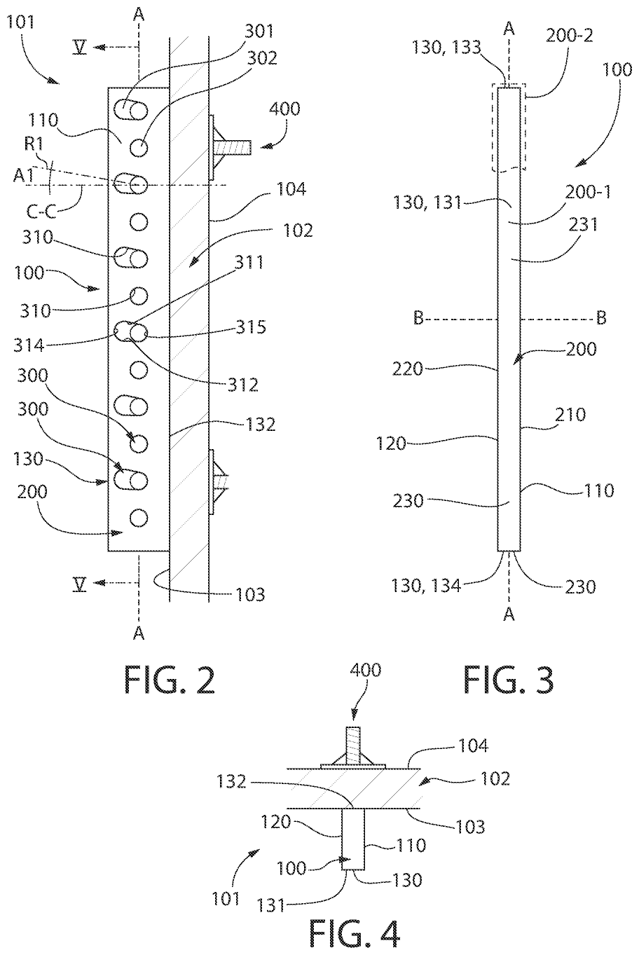

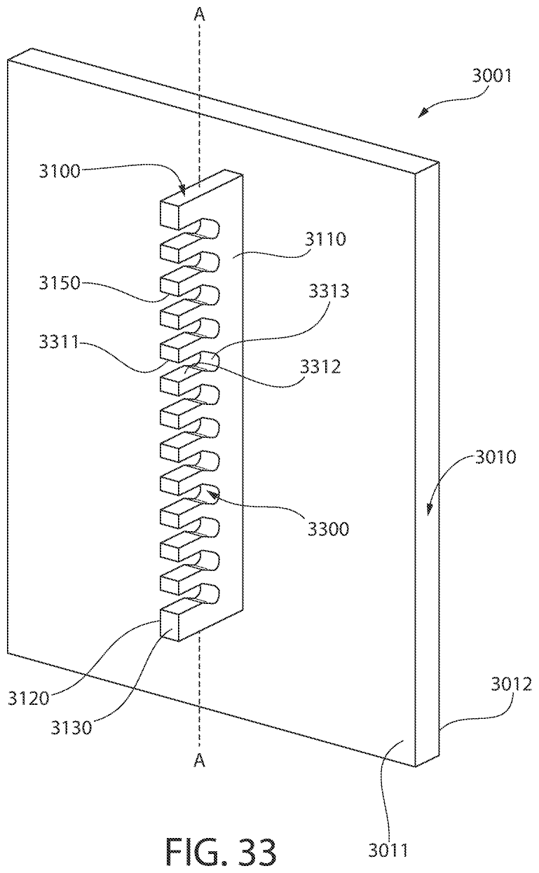

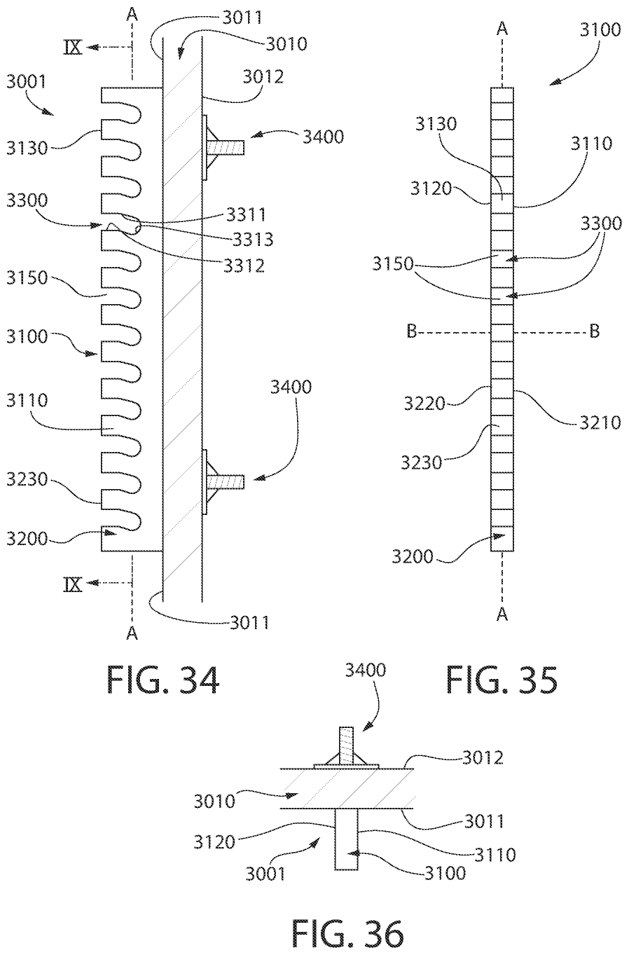

The aperture walls 310 may comprise an upper aperture wall 311 that is opposite a lower aperture wall 312. The aperture walls 310 may further comprise at least one aperture side wall 313 extending between the upper aperture wall 311 and the lower aperture wall 312 in some embodiments where the mounting apertures may have an open side wall and a closed side wall (see, e.g. FIGS. 33 and 34). In the present construction being addressed as shown in FIGS. 1, 2, 5, and 11 in which the mounting aperture has a “closed geometry” when viewed laterally (FIG. 2), two aperture side walls 313 comprising a front side wall 314 and rear side wall 315 are provided. The upper aperture wall 311, the lower aperture wall 312, and the aperture side walls 313 may form a continuous annular surface that collectively defines a closed-perimeter boundary or geometry of the aperture 300. Each of the lower aperture wall 312, upper aperture wall 311, and/or the aperture side walls 313 may be independently planar or curved.

The upper aperture wall 311 may define a surface that extends between the first major surface 210 of the body 200 and the second major surface 220 of the body 200 (but does not penetrate those surfaces) at an angle that is substantially perpendicular to the longitudinal axis A-A. In other embodiments, the upper aperture wall 311 may define a surface that extends between the first major surface 210 of the body 200 and the second major surface 220 of the body 200 at an angle that is oblique to the longitudinal axis A-A.

The lower aperture wall 312 may define a surface that extends between m the first major surface 210 of the body 200 and the second major surface 220 of the body 200 at an angle that is substantially perpendicular to the longitudinal axis A-A. In other embodiments, the lower aperture wall 312 may define a surface that extends between the first major surface 210 of the body 200 to the second major surface 220 of the body 200 at an angle that is oblique to the longitudinal axis A-A. Different portions of the walls 311 and 312 may be parallel or oblique.

The aperture side walls 313 may each define a surface that extends from the first lateral major surface 210 of the body 200 to the second lateral major surface 220 of the body 200 at an angle that is substantially parallel to the transverse axis B-B. In other embodiments, the aperture side walls 313 may define a surface that extends from the first major surface 210 of the body 200 to the second major surface 220 of the body 200 at an angle that is oblique to the transverse axis B-B. Different portions of the side walls 313 may be parallel or oblique.

In some embodiments, the upper aperture wall 311 may be a multi-directional surface having at least a first upper portion 311a and a second upper portion 311b. Referring to FIG. 5, the first upper portion 311a may extend from the first major surface 210 of the body 200 to the second upper portion 311b at a first angle relative to the longitudinal axis A-A. The second upper portion 311b may extend from the first upper portion 311a to the second major surface 220 of the body 200 at a second angle relative to the longitudinal axis A-A. The first and second angle of the first and second upper portions may be equal. In other embodiments, the first and second angle of the upper portions may be different.

The first angle formed between the first upper portion 311a and the longitudinal axis A-A may be substantially orthogonal or perpendicular (i.e. 90 degrees) as seen in FIG. 5. In other embodiments, the first angle formed between the first upper portion 311a and the longitudinal axis A-A may be oblique. The second angle formed between the second upper portion 311b and the longitudinal axis A-A may be substantially orthogonal or perpendicular. In other embodiments, the second angle formed between the second upper portion 311b and the longitudinal axis A-A may be oblique (see, e.g. FIG. 5). The second upper portion 311b may be laterally wider than the first upper portion 311a.

In some embodiments, the lower aperture wall 312 may be a multi-directional surface having at least a first lower portion 312a and a second lower portion 312b. The first lower portion 312a may extend from the first major surface 210 of the body 200 to the second lower portion 312b at a first angle relative to the longitudinal axis A-A. The second lower portion 312b may extend from the first lower portion 312a to the second major surface 220 of the body 200 at a second angle relative to the longitudinal axis A-A. The first and second angle of the lower portions 312a, 312b may be equal. In other embodiments, the first and second angle of the lower portions 312a, 312b may be different.

The first angle formed between the first lower portion 312a and the longitudinal axis A-A may be substantially orthogonal or perpendicular (see, e.g. FIG. 5). In other embodiments, the first angle formed between the first lower portion 312a and the longitudinal axis A-A may be oblique. The second angle formed between the second lower portion 312b and the longitudinal axis A-A may be substantially orthogonal or perpendicular (see, e.g. FIG. 5). In other embodiments, the second angle formed between the second lower portion 312b and the longitudinal axis A-A may be oblique. The second lower portion 312b may be wider than the first lower portion 312a.

In some embodiments, the first upper portion 311a and the first lower portion 312a may be parallel to each other (see, e.g. FIG. 5). In some embodiments, the first upper portion 311a and the first lower portion 312a may be non-parallel. In some embodiments, the second upper portion 311b and the second lower portion 312b may be parallel. In some embodiments, the second upper portion 311b and the second lower portion 312b may be non-parallel to each other as shown in FIG. 5. The illustrated embodiment forms an asymmetric surface defining a partial frustoconical shaped wall surface and concomitantly shaped entrance opening 300-1 between upper and lower second portions 311b and 312b, which is laterally offset to one major side surface 110 or 120 of the rack 100; the second upper portion 311b being obliquely angled and non-perpendicular to the longitudinal axis A-A (and obliquely angled to transverse axis B-B). The second lower portion 312b is perpendicular to longitudinal axis A-A and parallel to transverse axis B-B.

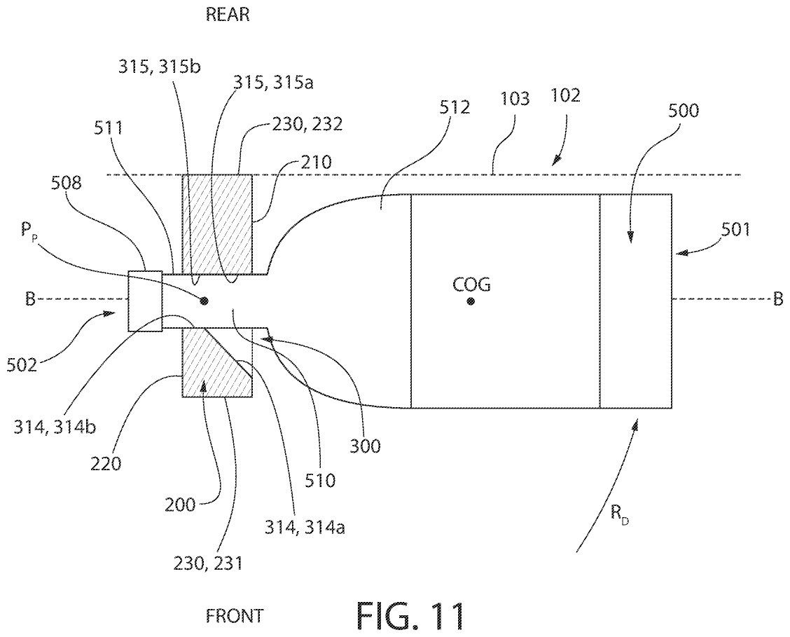

In some embodiments, referring to FIG. 11, the aperture side walls 313 may comprise a front aperture side wall 314 that is opposite a rear aperture side wall 315. As generally discussed with respect to the aperture side walls 313, the front aperture side wall 314 may extend between but does not penetrate the first and second major surfaces 210, 220 of the body 200 at an angle that is substantially parallel to the transverse axis B-B. In other embodiments as shown in FIG. 11, the front aperture side wall 314 may include a portion that is at an angle that is oblique to the transverse axis B-B.

With continuing reference to FIG. 11, as generally discussed with respect to the aperture side walls 313, the rear aperture side wall 315 may extend between but does not penetrate the first and second major surfaces 210, 220 of the body 200 at an angle that is substantially parallel to the transverse axis B-B as shown. In other embodiments, the rear aperture side wall 315 may include a portion that is at an angle that is oblique to the transverse axis B-B.

In some embodiments, the front aperture wall 314 may be a multi-directional surface having at least a first front portion 314a and a second front portion 314b. The first front portion 314a may extend at a first angle that is substantially parallel to the transverse axis B-B. In other embodiments, the first front portion 314a may extend from the first major surface 210 of the body 200 to the second front portion 314b at a first angle that is oblique to the transverse axis B-B as shown in FIG. 11. The second front portion 314b may extend from the first front portion 314a of the body 200 to the second major surface 220 of the body a second angle that is substantially parallel to the transverse axis B-B as shown. In other embodiments, the second front portion 314b may extend from the first front portion 314a to the second major surface 220 of the body 220 at a second angle that is oblique to the transverse axis B-B. The illustrated embodiment forms an asymmetric surface defining a partial frustoconical shaped wall surface and concomitantly shaped opening between front and rear first portions 314a and 315a, which is offset to towards the front surface 131 of the rack 100; the first front portion 314a being obliquely angled and non-perpendicular to the transverse axis B-B (see, e.g. FIG. 11). This places the front edge of the asymmetric surface defined by first front portion 314a closer to front surface 131 of rack 100 than the front edge of the circumferential surface defined by second front portion 314b.

The first and second angle of the first and second front portions 314a, 314b may be equal in lateral width. In other embodiments, the first and second angle of the first and second front portions 314a 314b may be different in lateral width with portion 314a being wider as shown in FIG. 11.

It bears noting that obliquely angled portion 314a of front wall 314 and obliquely angled portion 311b of upper wall 311 of the mounting apertures 300 may be considered to define sloped or inclined walls and surfaces. These sloped surfaces define the slot-shaped asymmetric frustoconical wall surface and opening as further described herein.

In some embodiments, the rear aperture wall 315 may be a multi-directional surface having at least a first rear portion 315a and a second rear portion 315b. The first rear portion 315a may extend from the first major surface 210 of the body 200 to the second rear portion 315b at a first angle that is substantially parallel to the transverse axis B-B as shown in FIG. 11. In other embodiments, the first rear portion 315a may extend from the first major surface 210 of the body 200 to the second rear portion 315b at a first angle that is oblique to the transverse axis B-B. The second rear portion 315b may extend from the first rear portion 315a of the body 200 to the second major surface 220 of the body a second angle that is substantially parallel to the transverse axis B-B as shown. In other embodiments, the second rear portion 315b may extend from the first rear portion 315a to the second major surface 220 of the body 220 at a second angle that is oblique to the transverse axis B-B.

The first and second angle of the first and second rear portions 315a, 315b may be equal in lateral width. In other embodiments, the first and second angle of the first and second rear portions 315a, 315b may be different in which the portion 315b may be wider.

As demonstrated by FIG. 11, a container 500 in the form of an elongated bottle may comprise a main liquid storage or body portion 512, a narrower elongated neck portion 510, and a top flange 508 at the mouth or opening of the container. Container 500 includes a bottom end 501 defined by main body portion 512 and an opposite top end 502 adjacent the top flange 508 which defines the mouth/opening for adding or extracting the liquid stored in the bottle. The body portion 512 and neck portion 510 may be generally cylindrical in shape in one embodiment as illustrated. Neck portion 510 is diametrically smaller than the body portion 512, and top flange 508 may be diametrically larger than the neck portion adjacent the top end 502. The neck portion 510 may have a greater length than the width of body 200 of the rack apparatus 100 as shown. This allows the neck portion and top flange 508 to be fully inserted through the openings in the body 200 for securing the containers 500 to the storage rack. It bears noting that in other embodiments of the bottle container, the main body portion 512 may have a shape other than cylindrical, such as for example without limitation polygonal (e.g. squared, hexagon, octagon, etc.). In such embodiments, neck portion 510 has a smaller cross-sectional area than that of the non-cylindrical body portions 512. The sidewalls of the body portion 512 may be straight as shown and/or have other profiles when viewed from the side such as bulbous or undulating configurations. The neck preferably remains cylindrical in shape in these alternate forms for engaging the container storage rack.

To put the rack apparatus 100 into use for storing containers, according to one non-limiting method, the top flange 508 and neck portion 510 of a container 500 (e.g. bottle) may be inserted laterally through the aperture 300 of the rack apparatus 100 such that the top flange 508 passes from the right first major surface 210 toward the left second major surface 220 of the body 200, and past the second major surface 220 of the body 200. Alternatively, for some of the apertures, the top flange 508 and neck portion 510 of another container may be inserted through the aperture 300 of the rack apparatus 100 such that the top flange 508 passes from the second major surface 220 toward the first major surface 210 of the body 200 and past the first major surface 210 of the body 200). The dimensions of the aperture 300 may be selected such that the passageway 150-1 has a diameter (or a height and width thought of another way) that is greater than the diameter of the top flange 508 and neck portion 510 of container 500. Having such diameter relationship allows for the top flange 508 to pass through the aperture 300 uninhibited. The aperture 300 however may have a diameter (height and width) which is smaller than the transverse cross-sectional area or diameter of the main storage portion 512 of the container (e.g. bottle).

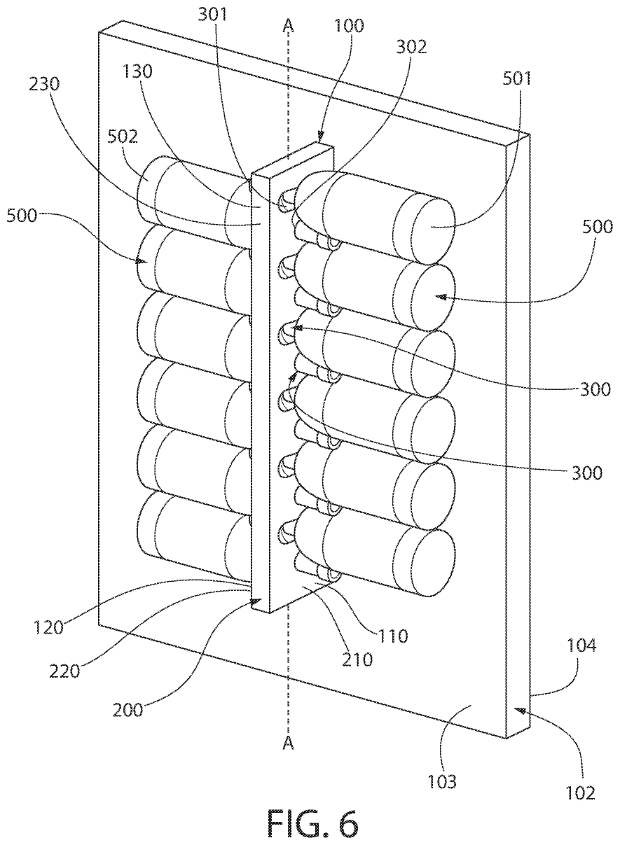

During the insertion step, the container 500 is preferably inserted by passing its neck portion 510 through the larger obround entrance opening of mounting aperture 300 formed by the frustoconical shaped wall surface at one end of the mounting aperture rather than the smaller circular opening formed by the cylindrical shaped wall surface at the opposite end of the aperture (see, e.g. FIGS. 6 and 11). The obround entrance opening 300-1 thus may be considered to define an “entrance” opening 300-1 of each mounting aperture at one end having a larger transverse cross-sectional area than the transverse cross-sectional area of the smaller circular opening at the other end that defines an “exit” opening 300-2 through which the neck portion 510 of the container 500 is projected therethrough when the container is fully inserted through the mounting aperture 300. The entrance opening 300-1 gradually diminishes in cross-sectional area moving inwards from the lateral major surface it penetrates (i.e. right or left major surface 110 or 120 depending on the orientation of the mounting aperture 300) towards the central portion of the mounting aperture 300. The entrance opening 300-01 eventually merges with the exit opening towards the other end of the aperture 300 (see, e.g. FIG. 5). Thought of another way, the frustoconical shaped wall surface at one end of the mounting aperture merges with the cylindrical shaped wall surface at the opposite end of the aperture at a point between the major surfaces 110, 120 of the rack body 200.

Moreover, during the foregoing insertion step, the container 500 may be initially inserted into the aperture 300 in either a direction that is parallel to the transverse axis B-B, or for convenience and preferably oblique to the transverse axis B-B (and vertical plane defined by the wall surface 103 of wall 102). The larger entrance opening 300-1 of the mounting aperture 300 facilitates insertion of the container neck and guides the neck towards the smaller opposite exit opening 300-2 of the aperture. The asymmetric partial frustoconical wall surfaces of the entrance portion 300-1 may thus be though of as a funnel which guides the container neck portions 510 through the aperture towards the exit opening.

When inserted into the aperture 300 at an oblique angle, a pivot point Pp is created where the neck portion 510 of the container 500 is located at a point between the first and second major surfaces 110, 120 of the rack apparatus 100. The bottle 500 may then be rotated about the pivot point Pp in a rotational direction R_{D} such that the body portion 512 of the bottle 500 moves closer to the second vertical side surface 232 of the body 200. Stated otherwise, the bottle 500 may be rotated about the pivot point Pp in a rotational direction R_{D} such that the body portion 512 of the bottle 500 moves closer to the outer surface 103 of the support structure 102 in the storage system 101. In moving about the rotational direction R_{D} towards the wall 102, the bottle 500 may move about the vertical longitudinal axis A-A as well as the transverse axis B-B depending on the specific configuration of the aperture walls 310.

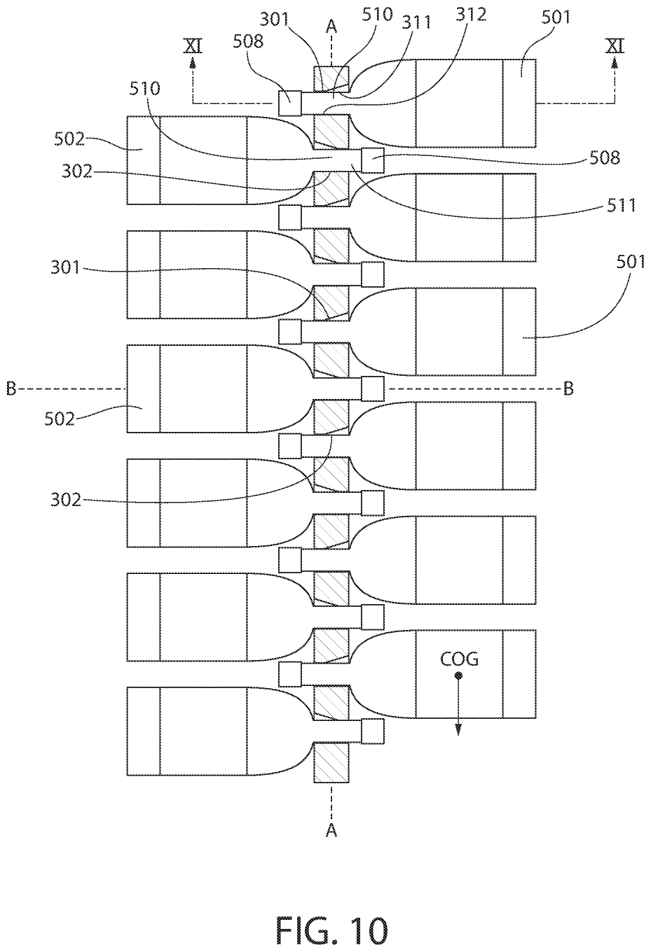

As demonstrated by FIGS. 10 and 11, once fully rotated about the pivot point Pp along the rotational direction R_{D}, the upper wall 311 may engage a portion of the top outer surface 511 of the neck portion 510 of the container 500. Once fully rotated about the pivot point Pp along the rotational direction R_{D}, the lower wall 312 may engage an opposite portion of the outer surface 511 of the neck portion 510 of the container 500. Once fully rotated about the pivot point Pp along the rotational direction R_{D}, the front aperture side wall 314 and/or the rear aperture side wall 315 may engage a portion of the outer surface 511 of the neck portion 510 of the container 500.

The engagement between at least one of the aperture walls 310 with the outer surface 511 of the neck portion 510 of the container stabilizes and retains the container 500 in a set position in the mounting aperture 300 and rack 100. The straight section 311a of upper aperture wall 311 of mounting aperture 300 (oriented parallel to transverse axis B-B) located in the smaller diameter cylindrical portion of the aperture adjacent the symmetrical exit opening 300-2 retains the container 500 in the rack 100 via engagement with the top surface 511 of the neck portion 510 of the container once fully inserted in mounting aperture 300 about the pivot point Pp. Correspondingly, the entire lower aperture wall 312 of the mounting aperture (i.e. both sections 312a and 312b oriented parallel to transverse axis B-B) engages the bottom surface 511 of the container neck portion 510. In the set or fully engaged position, the container 500 extends out laterally from the longitudinal axis A-A such that the container 500 is oriented substantially parallel to the transverse axis B-B of the rack apparatus 100 and supported in a cantilevered manner. Because the center of gravity COG of the container 500 associated with the bottle and its contents is located to laterally offset from to one side major side or the other of the rack (see, e.g. FIGS. 10 and 11), this creates a moment about the pivot point Pp which increases engagement with the walls in the mounting aperture to keep the container in position. The COG may therefore laterally offset from either lateral major surfaces 110 or 120 of the storage rack depending on the orientation of the container as seen in FIG. 10.

The distance between the upper aperture wall 311 and the lower aperture wall 312 is greater than the largest external vertical dimension (i.e. outer diameter of the neck portion 510 of the bottle 500). The distance between the front aperture side wall 314 and the rear aperture side wall 315 is also greater than the largest external horizontal dimension of the neck portion 510 of the bottle 500. The distance between the upper aperture wall 311 and the lower aperture wall 312 is also be greater than the largest external dimension of the top flange 508 of the bottle 500 in bottles 500 which include a pronounced flange. The distance between the front aperture side wall 314 and the rear aperture side wall 315 may be greater than the largest external dimension of the top flange 508 of the bottle 500. Under this relationship, there is sufficient clearance between the aperture walls 310 of mounting aperture 300 and the top flange 508 and/or the neck portion 510 of the bottle 500 to allow the bottle to be fully inserted through mounting aperture 300 and into the rack apparatus 100.

It bears noting that the rack 100 may be used with containers/bottles which do not have a pronounced top flange 508 with equal benefit. The invention is expressly not limited for use with bottles having top flanges illustrated herein.

According to this embodiment, the distance between the upper aperture wall 311 and the lower aperture wall 312 may vary along the transverse axis B-B between the first and second major surface 210, 220 of the body 200 due to the obliquely angled portions 311b of the upper wall 311. This angled portion 311B of the upper aperture wall 331 does not generally engage the neck portion 510 of container 500 when fully seated and retained in the rack 100. Similarly, the obliquely angled portion 314a of front aperture wall 314 does not engage the neck portion of the container. According to this embodiment, the distance between the front aperture wall 314 and the rear aperture wall 315 may vary along the transverse axis B-B between the first and second major surface 210, 220 of the body 200 due to the presence of angled portion 314a of the front aperture wall 314.

Referring now to FIGS. 1, 2, 5, 6, and 10, the plurality of apertures 300 on the rack apparatus 100 of the present invention further comprises a first aperture section 301 and a second aperture section 302. In one embodiment, the first aperture sections 301 may be elongated slots in transverse configuration and the second aperture sections 302 may be round or circular in transverse configuration as shown. Accordingly, each aperture 300 may therefore include a first aperture section 301 forming an elongated obround or oval opening at one end to advantageously facilitate initial insertion of the container neck 510 into the aperture from one of the lateral major sides 210 or 220 of the rack body 200, and a circular opening at an opposite end configured for removably locking and securing the container 500 to the rack via the neck portion 510 and enlarged flange 508 at the top of the container (e.g. bottle).

The slot-shaped first aperture sections 301 may be obliquely oriented in lateral side view rather than perpendicular to the longitudinal axis A-A and oblique to a horizontal axis C-C drawn front to rear of rack body 200 that extends through each slot (see, e.g. FIG. 2). Thus a reference line R1 drawn from the center of the rear wall 315 to the center of the front wall 314 is angled at an oblique angle A1 to the horizontal axis C-C. This obliquely angled orientation of slot-shaped aperture section 301 creates the obliquely angled portions 311b and 314b of each mounting apertures 300 previously described herein. It bears noting the arcuately curved surfaces of slot-shaped aperture sections 301 formed by oblique sections 311b, 314b are contiguous forming integral portions of the slots. Section 314b formed by front wall 314 extends upwards and then rearwards along the top wall 311 of each mounting aperture 300.

The mounting apertures 300 may be arranged in a spaced apart single linear array or column in rack 100 along longitudinal axis A-A. In one embodiment, the first and second aperture sections 301, 302 of each aperture 300 may be arranged array in an alternating pattern along longitudinal axis A-A in one embodiment as shown in FIG. 5. Every other mounting aperture 300 is laterally reversed in position horizontally as shown. For example, some of the apertures have the slot-shaped aperture sections 301 at the ends of the mounting apertures located at the right lateral major surface 110/210 of the rack, while every other one has the slot-shaped aperture sections at the left lateral major surface 120/220. The same applies by analogy to the circular-shaped second aperture sections 302. Because the circular shaped openings are configured to engage and retain the neck portions 510 (e.g. flange 508) of each bottle, this allows the bottles to be mounted in the alternating right-to-left arrangement as shown in FIG. 6. The larger main body portion 512 of each bottle will be located adjacent the slot-shaped section 301 of each mounting aperture 300, whereas the flange 508 at the top end of each bottle that defines the opening will be located adjacent to the circular shaped section 302 of the mounting aperture. The enlarged slot shaped sections 301 make it easier for the user to both insert and remove the bottles from the rack 100 with a minimal amount of accuracy.

The mounting apertures 300 each thus may have the same configuration and features described above, except that every other aperture moving in a vertical direction along the rack 100 has first and second aperture sections 301, 302 that are a mirrored image of the next adjacent mounting aperture along the longitudinal axis A-A (see, e.g. FIG. 5). The slot-shaped first aperture sections 301 have the greatest height the at open first end of the mounting apertures 300 and gradually diminish in height moving towards the opposite open second end of the aperture 300 having the circular aperture section 302 (see, e.g. FIG. 5). The upper wall 311b in the first section 310 of each aperture 300 is sloped and angled downwards at an oblique angle to transverse axis B-B moving between the lateral major surfaces 110, 120 from the first end towards the second end of the aperture. The upper wall 311b of the first section 301 of each aperture 300 is also sloped and angled downwards moving from the front surface 131 towards the rear surface 132 of the rack 100 (see, e.g. FIG. 2). The front wall 314a of the first section 301 of each aperture 300 is sloped or inclined rearwards moving from the open end at slot-shaped section 301 of the aperture towards the open end at circular-shaped section 302 (see, e.g. FIG. 11). The sloping/inclined upper and front walls 311, 314a wall collectively form the bell-shaped asymmetric partial-frustoconical shaped wall section and corresponding opening at one end of each container-mounting aperture 300 opposite the circular cylindrical shaped wall section and opening at the other end of the aperture, as previously described herein.

Under this foregoing configuration of the rack 100 and container mounting apertures 300, a plurality of containers 500 may be inserted into the first and second aperture sections 301, 302 of the rack apparatus 100, whereby the mirrored orientation of the first and second aperture sections 301, 302 allow for tight vertical packing of adjacent contains 500 along the longitudinal axis A-A. The phrase “tight vertical packing” refers to a first container 501 being inserted into the first aperture section 301 in a first direction along the transverse axis B-B and a second container 502 inserted into a second aperture section 302 in a second direction along the transverse axis B-B—whereby the first direction is a mirror of the second directions—and the body portion 512 of the first container 501 at least partially overlaps with the body portion 512 of the second container 502 in a direction orthogonal to the longitudinal axis A-A.

In some embodiments, the phrase “tight vertical packing” refers to two first containers 501 being inserted into first aperture sections 301 in the first direction and at least one second container 502 inserted into the second aperture section 302 in the second direction along the transverse axis B-B—whereby the body portion 512 of the second container 502 at least partially overlaps with the body portions 512 of the two first containers 501 in a direction orthogonal to the longitudinal axis A-A. Stated otherwise, each of the first and second containers 501, 502 being supported by the rack apparatus 100 such that the containers 501, 502 extend outward in a direction that is normal to the longitudinal axis A-A, and the neck portion 510 of a first container 501 may be located between two body portions 512 of two stacked second containers 502.

Under this foregoing arrangement, a vertical plane oriented substantially parallel to the longitudinal axis A-A and defined by either lateral major surface 110, 120 may intersect the neck portion 510 alone of a first container 501, and the larger main body portion 512 of an adjacent second container 502 when the container is fully inserted through the mounting aperture 300 in the rack 100 as seen in FIG. 10, or at least the neck portion adjoining the body portion if not fully inserted through the aperture.

As shown in FIGS. 10 and 11, it is important to note that in some case when mounting the containers 500 (e.g. bottles) in the rack 100, the diametrically enlarged top flanges 508 are not required to support and retain the containers in the container mounting apertures 300. If the containers were to become slightly dislodged from the illustrated positions such as by being bumped or during a seismic event, the flanges 508 act as failsafe mechanisms to catch the containers and prevent them from sliding out of the mounting apertures 300 in a lateral direction form either lateral major surfaces 110 or 120.

The vertical distance separating a first aperture section 301 and a second aperture section 302 of the next vertically adjacent mounting aperture 300 along the longitudinal axis A-A may be less than the largest width of the container 500 (i.e. at main portion 512). By emplacing the containers 500 in the rack 100 in opposing and alternating orientation as seen in FIG. 10, this allows tight packing of the containers to maximize the storage capacity of the rack and provide a visually interesting and attractive appearance suitable for public display in a restaurant or similar environment (as wall as for private use in a personal dwelling).

It bears special mention that in some embodiments, only the front aperture wall 314 may include an obliquely angled portion 314a or the upper aperture wall 311 may include the obliquely angled portion 311a. In preferred but non-limiting embodiments, as shown herein with respect to FIGS. 1-11, each mounting aperture includes both obliquely angled wall portions 314a and 311a to maximize convenience of container insertion into the rack 100 for the user.

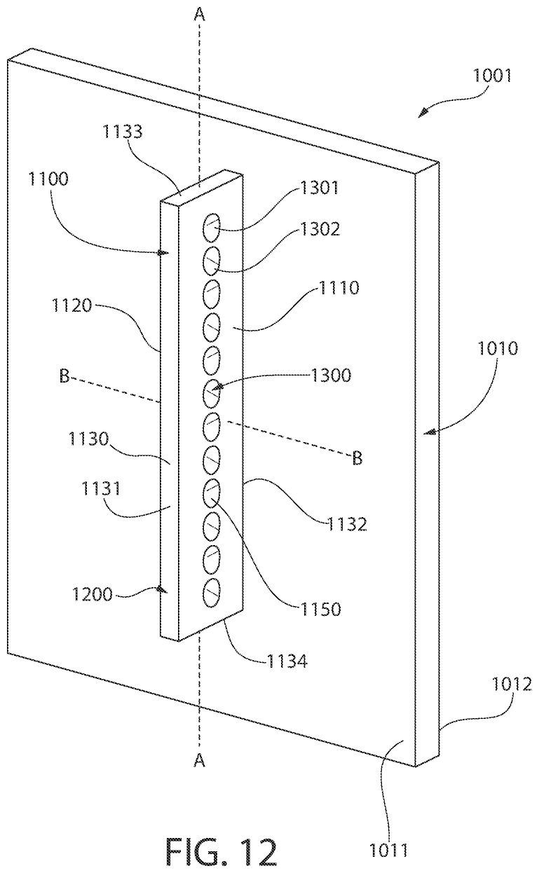

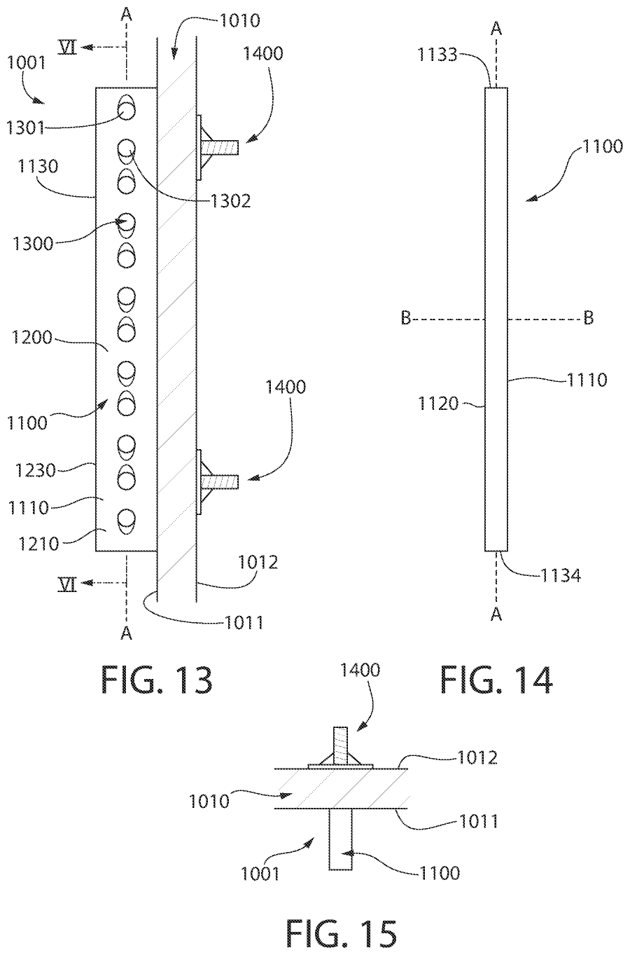

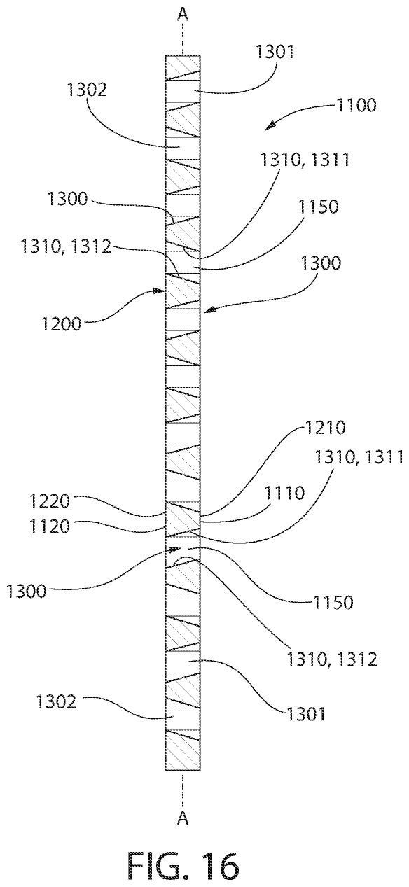

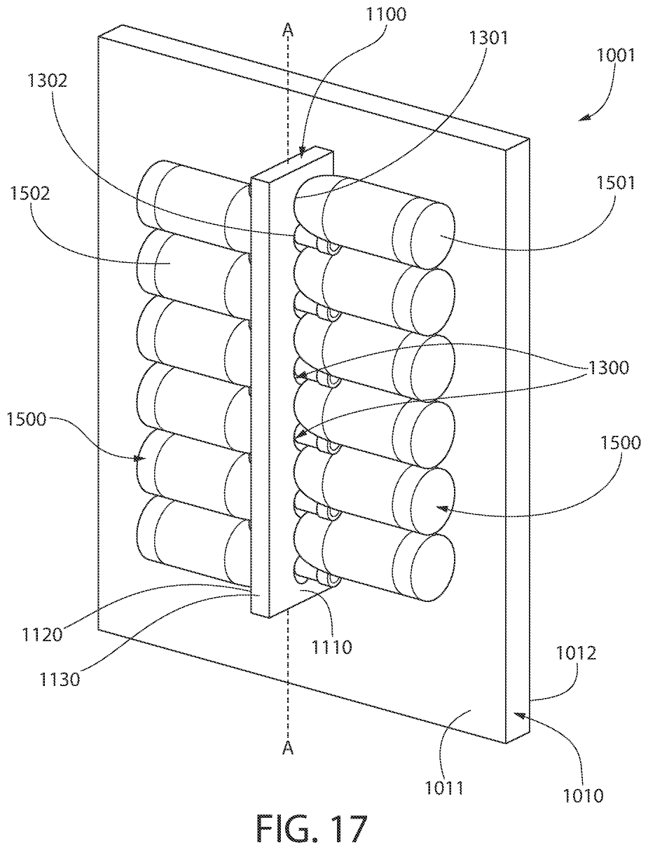

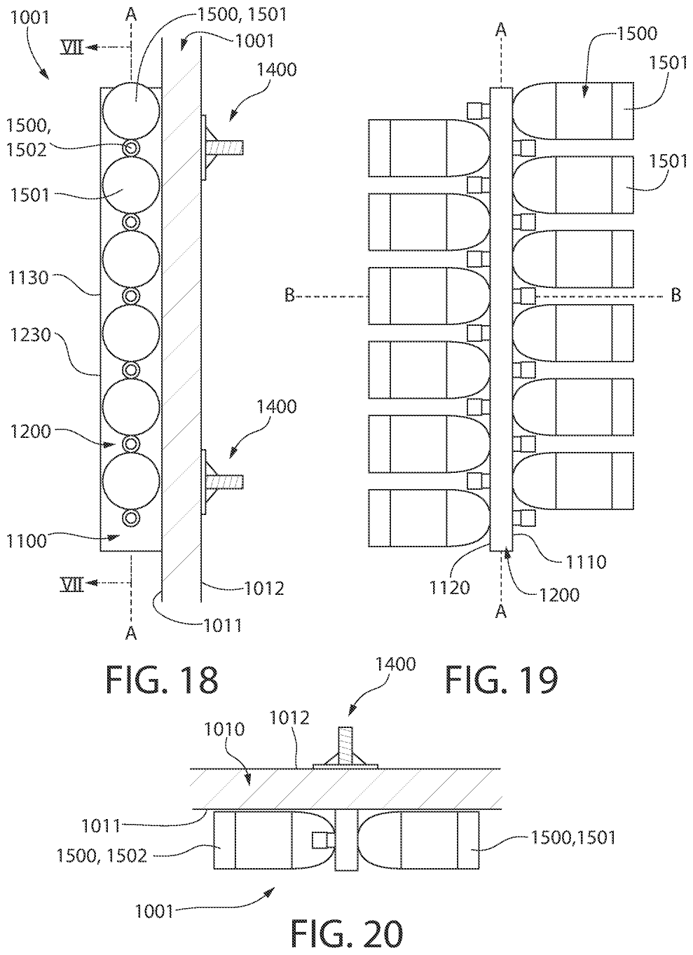

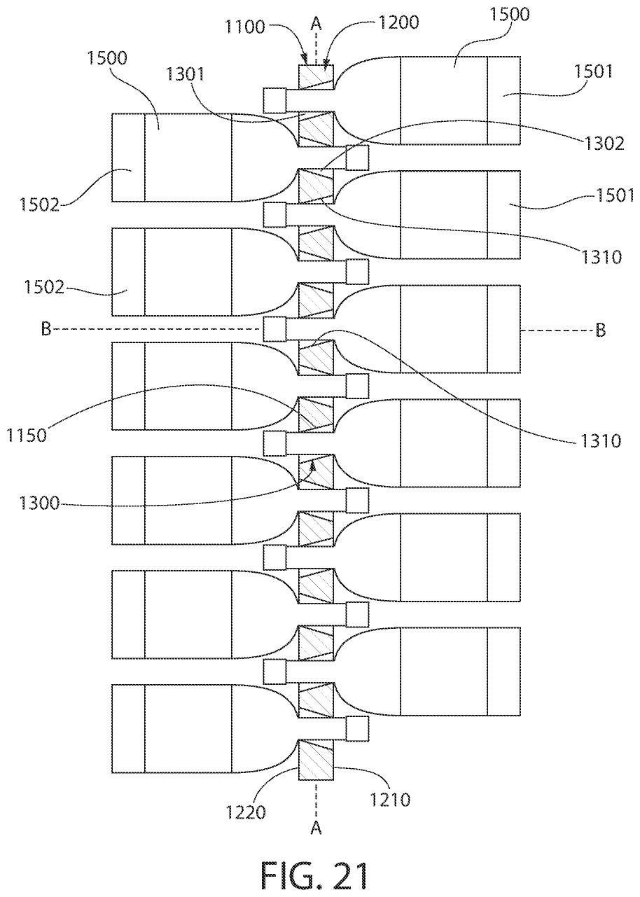

Referring now to FIGS. 12-22D, a rack apparatus 1100 and corresponding storage system 1001 is illustrated in accordance with another embodiment of the present invention. The storage system 1001 and rack apparatus 1100 is similar to the storage system 101 and rack apparatus 100 except as described herein below. The description of the storage system 1001 and rack apparatus 1100 above generally applies to the storage system 1001 and rack apparatus 1000 described below except with regard to the differences specifically noted below. A similar numbering scheme will be used for the storage system 1000 and rack apparatus 1100 as with the storage system 101 and rack apparatus 100 except that 1,000-series numbers will be used.

According to this embodiment, the apertures 1300 comprise aperture walls 1310 that may include an upper aperture wall 1311 that is opposite a lower aperture wall 1312. The aperture walls 1310 may further comprise at least one aperture side wall 1313 extending between the upper aperture wall 1311 and the lower aperture wall 1312. The upper aperture wall 1311, the lower aperture wall 1312, and the aperture side walls 1313 may form a continuous surface that collectively defines a closed-perimeter boundary of the aperture 1300. Each of the lower aperture wall 1312, upper aperture wall 1311, and/or the aperture side wall 1313 may be independently planar or curved.

According to this embodiment, the distance between the upper aperture wall 1311 and the lower aperture wall 1312 may remain substantially constant along the transverse axis B-B between the first and second major surface 1210, 1220 of the body 1200. According to this embodiment, the distance between the front aperture wall 1314 and the rear aperture wall 1315 may remain substantially constant along the transverse axis B-B between the first and second major surface 1210, 1220 of the body 1200.

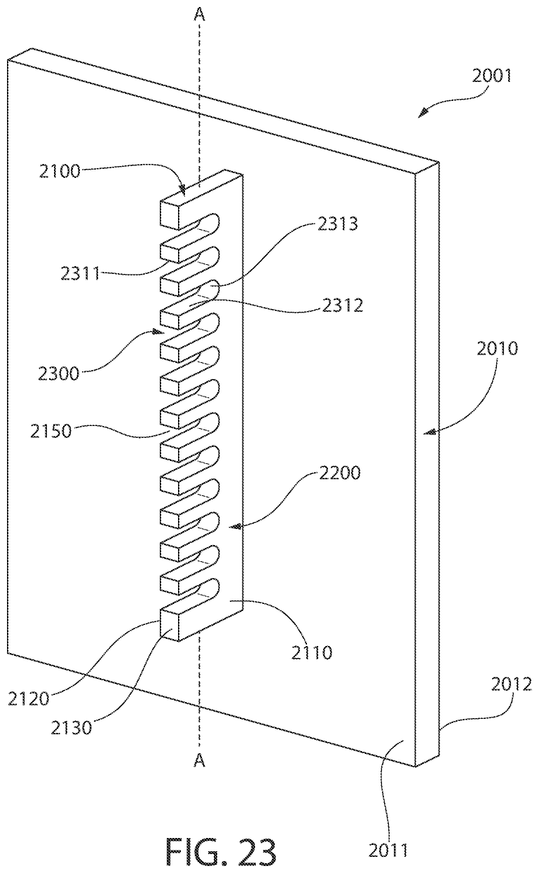

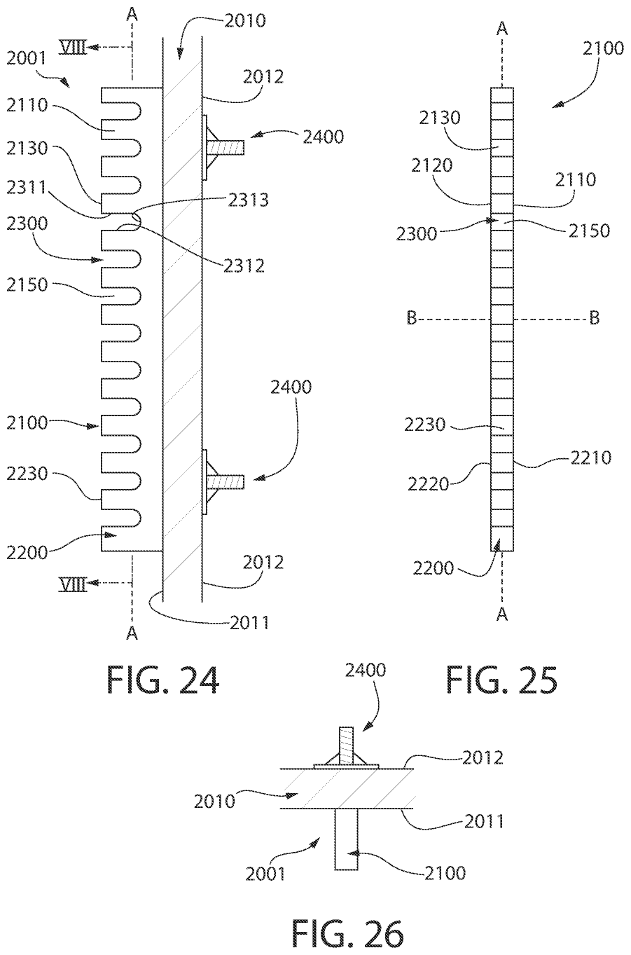

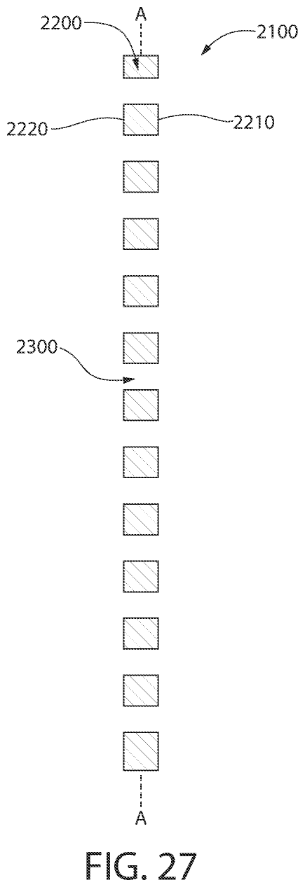

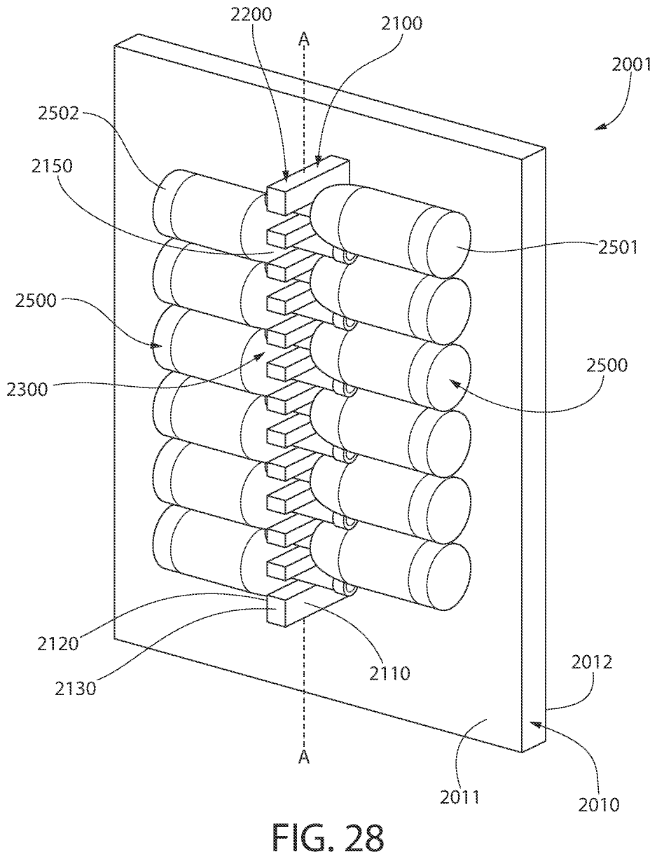

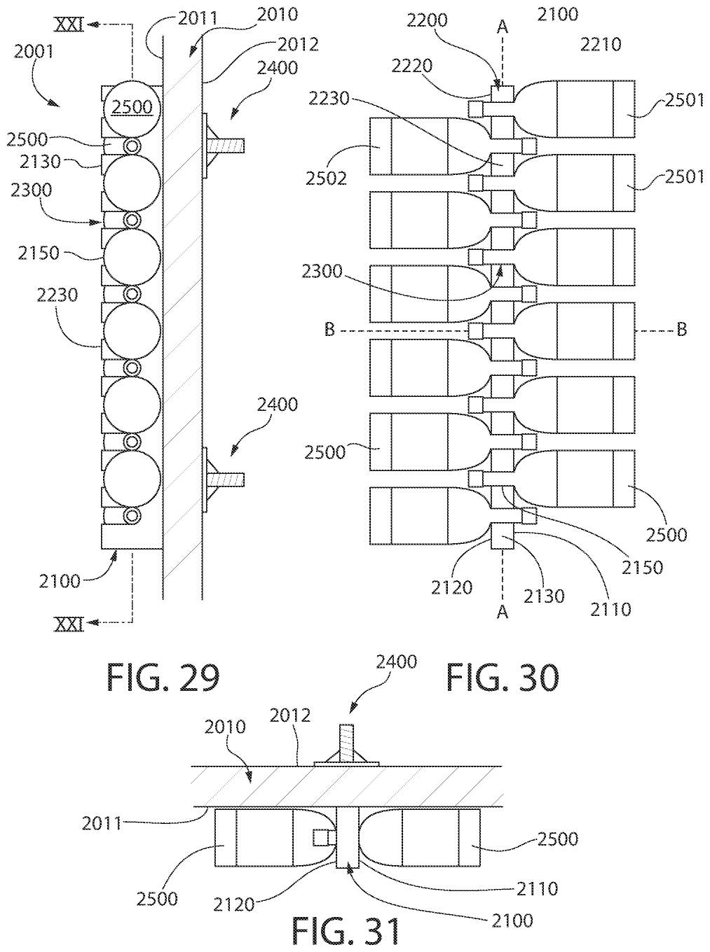

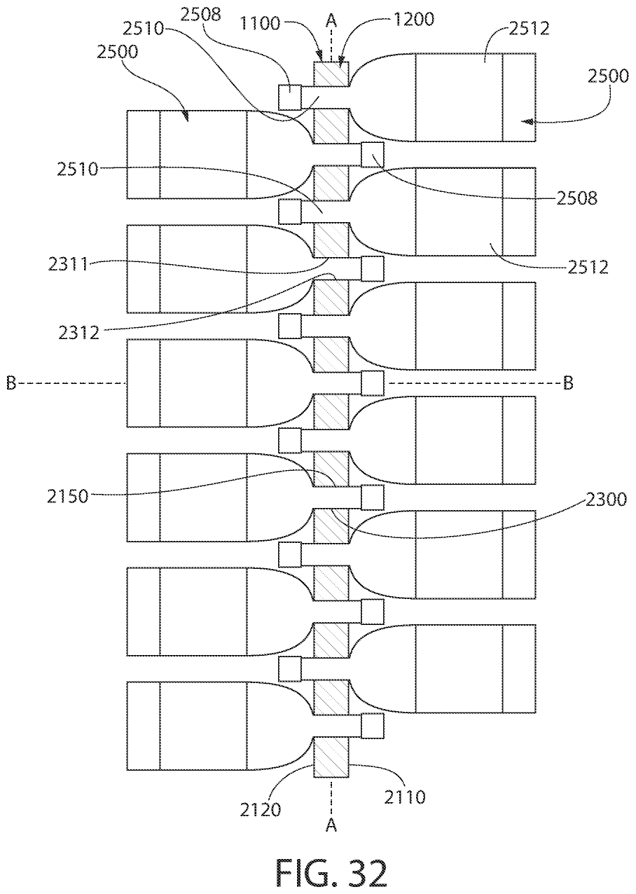

Referring now to FIGS. 23-32, a rack apparatus 2100 and corresponding storage system 2001 is illustrated in accordance with another embodiment of the present invention. The storage system 2001 and rack apparatus 2100 is similar to the storage system 101 and rack apparatus 100 except as described herein below. The description of the storage system 2001 and rack apparatus 2100 above generally applies to the storage system 2001 and rack apparatus 2000 described below except with regard to the differences specifically noted below. A similar numbering scheme will be used for the storage system 2000 and rack apparatus 2100 as with the storage system 101 and rack apparatus 100 except that 2,000-series numbers will be used.

According to this embodiment, the apertures 2300 comprise aperture walls 2310 that may include an upper aperture wall 2311 that is opposite a lower aperture wall 2312. The aperture walls 2310 may further comprise at least one aperture side wall 2313 extending between the upper aperture wall 2311 and the lower aperture wall 2312. The upper aperture wall 2311, the lower aperture wall 2312, and the aperture side walls 2313 may form a continuous surface. The continuous surface of this embodiment does not form a closed-perimeter encapsulating the aperture 2300—rather the continuous surface collectively defines a C-shaped channel having an open-end. Each of the lower aperture wall 2312, upper aperture wall 2311, and/or the aperture side wall 2313 may be independently planar or curved.

According to this embodiment, the open-end of the C-shaped channel may be present on one of the side surfaces 2130 of the body 2200 such that each of the upper aperture wall 2311 and the lower aperture wall 2312 intersect the side surface 2130 of the body 2200. The open-end of the C-shaped channel allows for a container 2500 to be inserted into the aperture 2300 along a direction that is substantially orthogonal to both the longitudinal axis A-A and the transverse axis B-B. Specifically, the container 2500 may be inserted into the aperture 2500 be inserting a neck portion 2510 through the open-end on the side surface 2130 in a direction extending from the first vertical side surface 2131 toward the second vertical side surface 2132 of the rack apparatus 3100.

According to this embodiment, the distance between the upper aperture wall 2311 and the lower aperture wall 2312 may remain substantially constant along the transverse axis B-B between the first and second major surface 2210, 2220 of the body 2200. According to this embodiment, the distance between the upper aperture wall 2311 and the lower aperture wall 2312 may be substantially equal to the largest external dimension of the neck portion 2510 of the container 2500. Additionally, according to this embodiment, the distance between the upper aperture wall 2311 and the lower aperture wall 2312 may be smaller than the largest external dimension of the top flange 2508 of the container 2500.

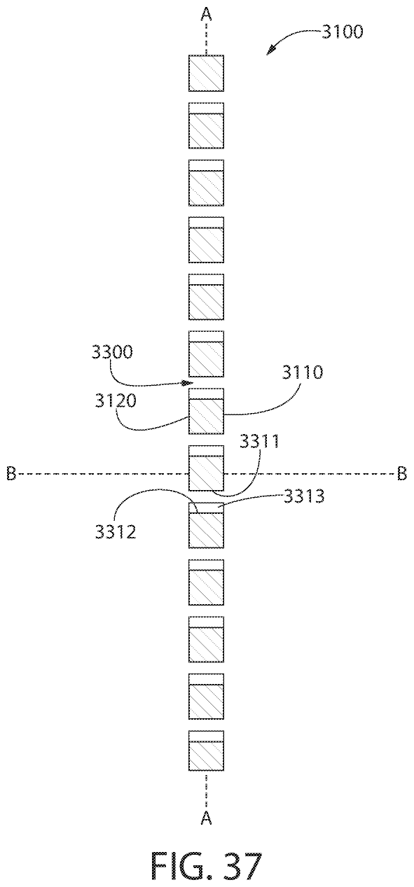

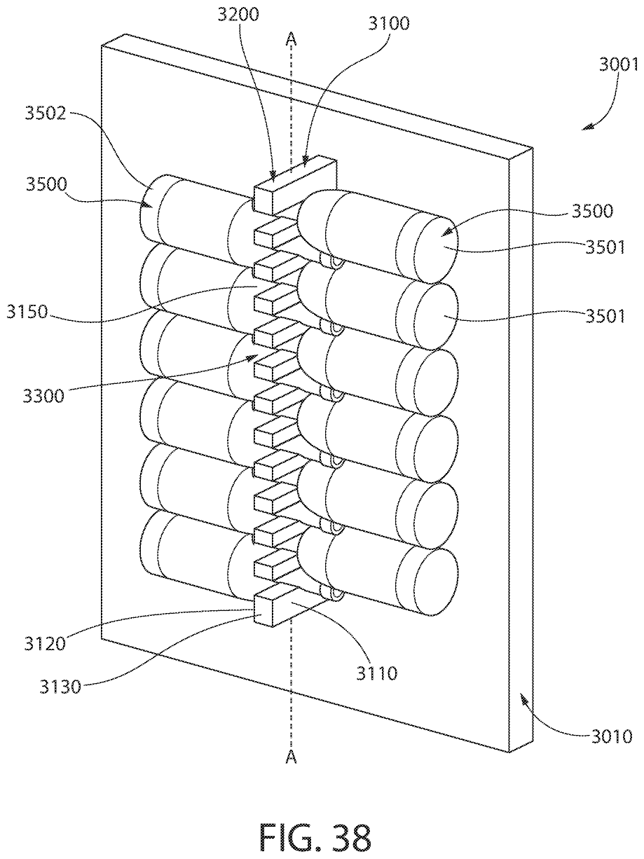

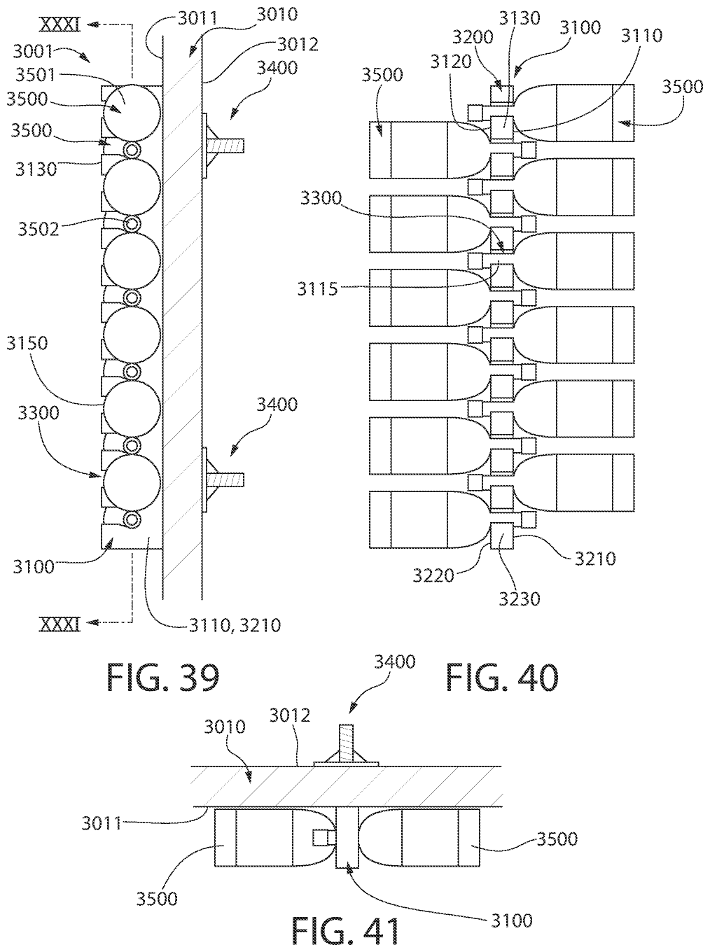

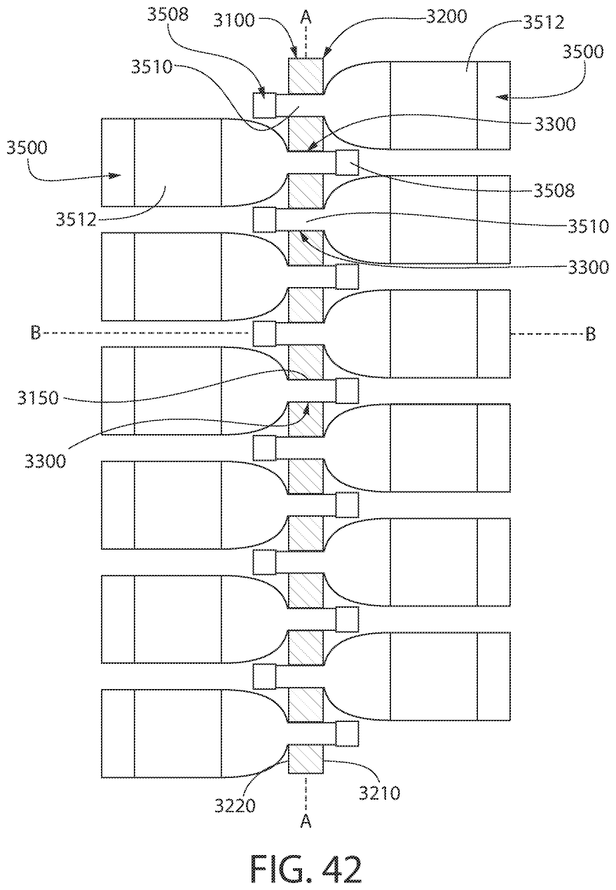

Referring now to FIGS. 33-42, a rack apparatus 3100 and corresponding storage system 3001 is illustrated in accordance with another embodiment of the present invention. The storage system 3001 and rack apparatus 3100 is similar to the storage system 101 and rack apparatus 100 except as described herein below. The description of the storage system 3001 and rack apparatus 3100 above generally applies to the storage system 3001 and rack apparatus 3000 described below except with regard to the differences specifically noted below. A similar numbering scheme will be used for the storage system 3000 and rack apparatus 3100 as with the storage system 101 and rack apparatus 100 except that 3,000-series numbers will be used.

According to this embodiment, the apertures 3300 comprise aperture walls 3310 that may include an upper aperture wall 3311 that is opposite a lower aperture wall 3312. The aperture walls 3310 may further comprise at least one aperture side wall 3313 extending between the upper aperture wall 3311 and the lower aperture wall 3312. The upper aperture wall 3311, the lower aperture wall 3312, and the aperture side walls 3313 may form a continuous surface. The continuous surface of this embodiment does not form a closed-perimeter encapsulating the aperture 3300—rather the continuous surface collectively defines a C-shaped channel having an open-end. Each of the lower aperture wall 3312, upper aperture wall 3311, and/or the aperture side wall 3313 may be independently planar or curved.

According to this embodiment, the open-end of the C-shaped channel may be present on one of the side surfaces 3130 of the body 3200 such that each of the upper aperture wall 3311 and the lower aperture wall 3312 intersect the side surface 3130 of the body 3200. The open-end of the C-shaped channel allows for a container 3500 to be inserted into the aperture 3300 along a direction that is substantially orthogonal to both the longitudinal axis A-A and the transverse axis B-B. Specifically, the container 3500 may be inserted into the aperture 3500 be inserting a neck portion 3510 through the open-end on the side surface 3130 in a direction extending from the first vertical side surface 3131 toward the second vertical side surface 3132 of the rack apparatus 3100.

According to this embodiment, the distance between the upper aperture wall 3311 and the lower aperture wall 3312 may remain substantially constant along the transverse axis B-B between the first and second major surface 3210, 3220 of the body 3200. According to this embodiment, the distance between the upper aperture wall 3311 and the lower aperture wall 3312 may be substantially equal to the largest external dimension of the neck portion 3510 of the container 3500. Additionally, according to this embodiment, the distance between the upper aperture wall 3311 and the lower aperture wall 3312 may be smaller than the largest external dimension of the top flange 3508 of the container 3500.

According to this embodiment, the position of the upper aperture wall 3311 and the lower aperture wall 3312 may vary along the longitudinal axis A-A when moving from the first vertical side surface 3131 toward the second vertical side surface 3132. Specifically, each aperture 3300 may comprise a front portion and a rear portion, whereby the front portion is adjacent to the first vertical side surface 3131 and the rear portion is adjacent to the second vertical side surface 3132. The rear portion may comprise the upper and lower aperture wall 3311, 3312 in a lower vertical position along the longitudinal axis A-A relative to the front portion for a single aperture 3300. The result is the rear portion being dropped below the front portion such that when a neck portion 3510 is inserted into the aperture 3300, the container is held in place both vertically and horizontally in the aperture 3300 by the vertical offset of the rear portion relative to the front portion.

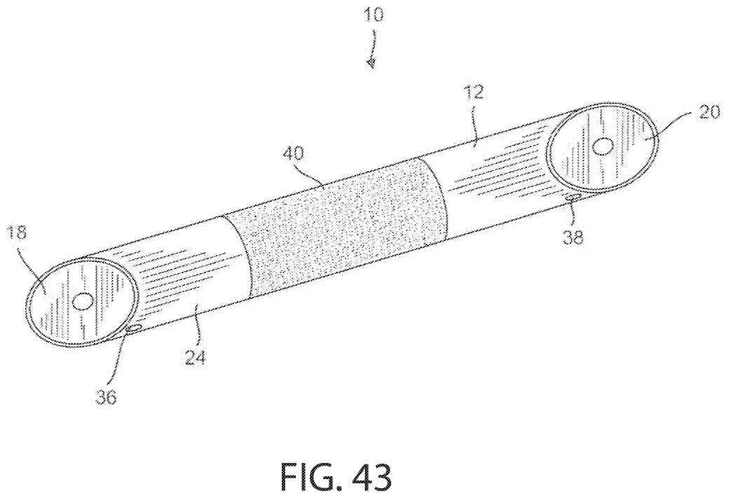

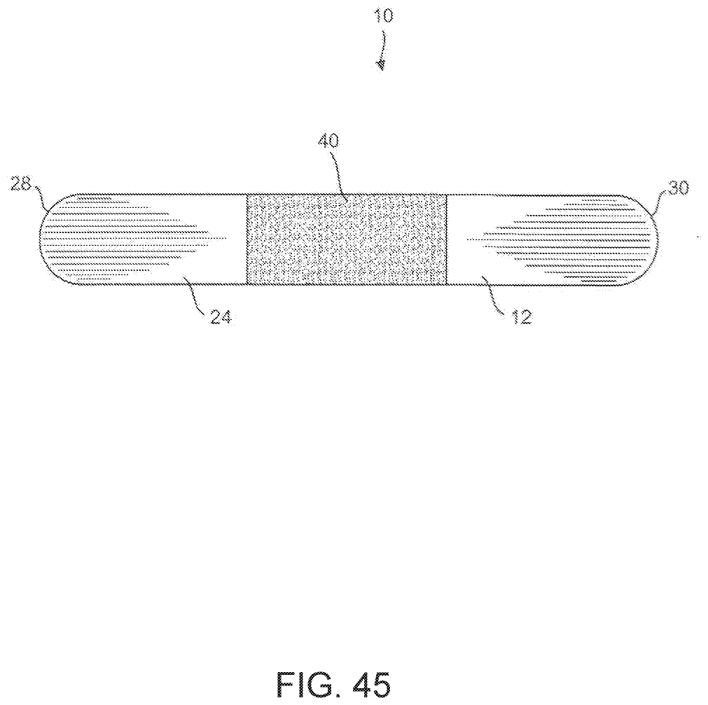

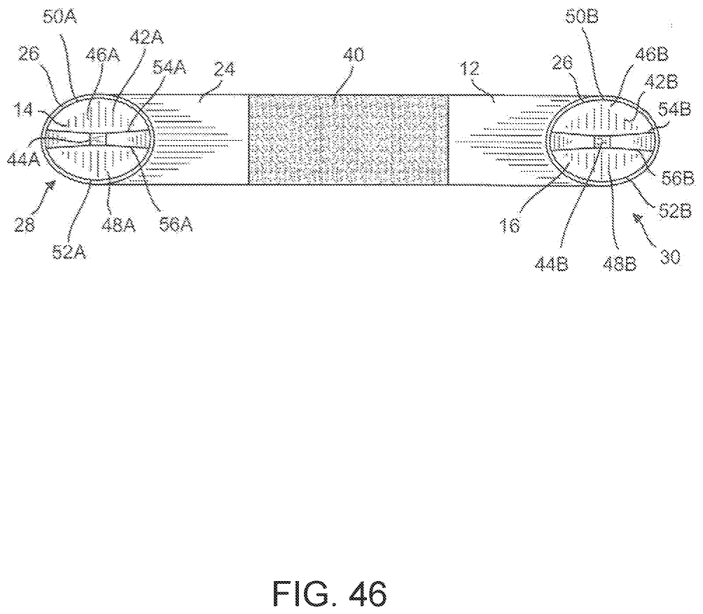

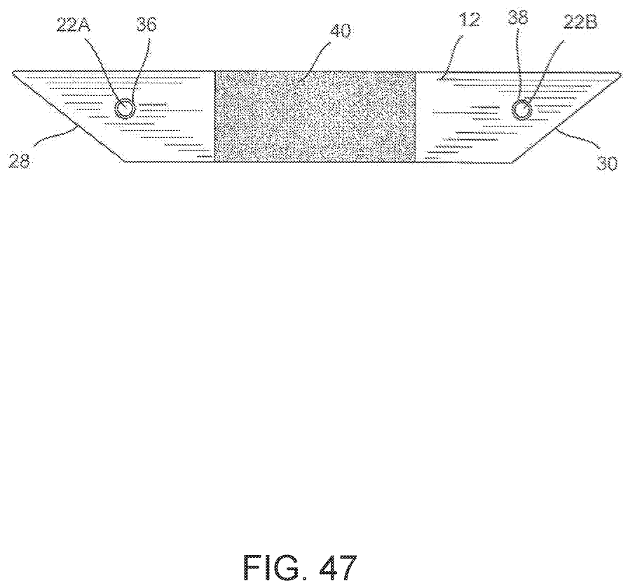

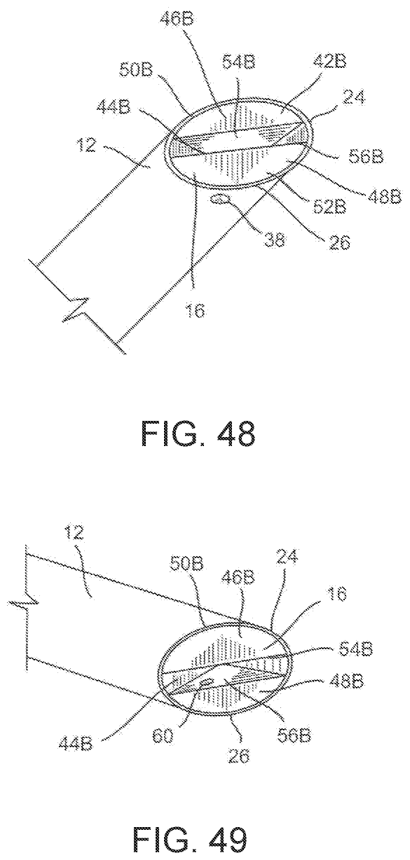

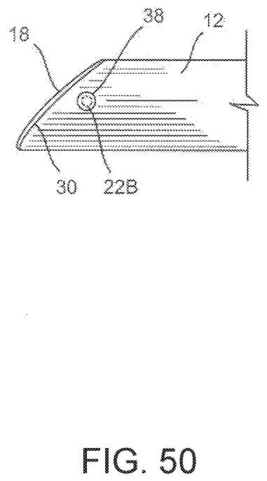

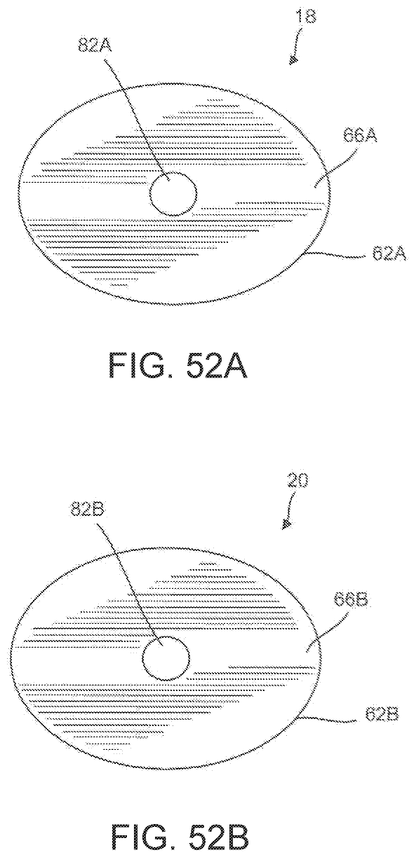

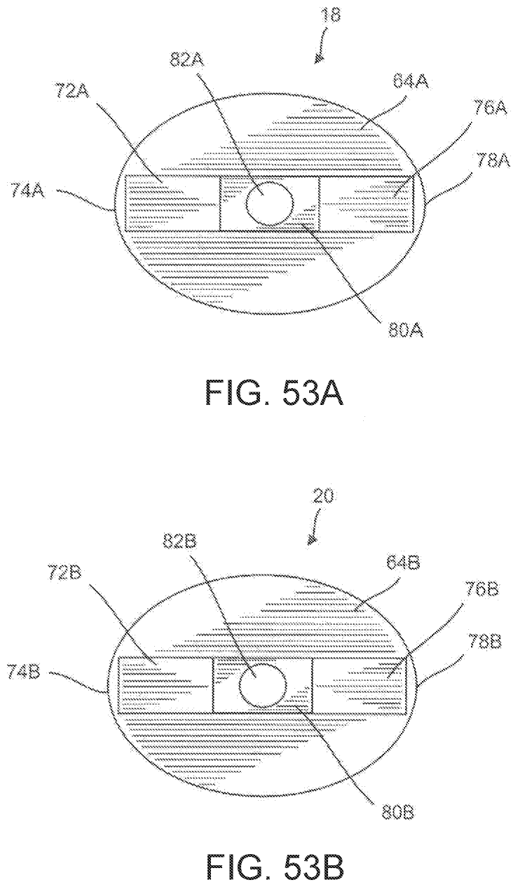

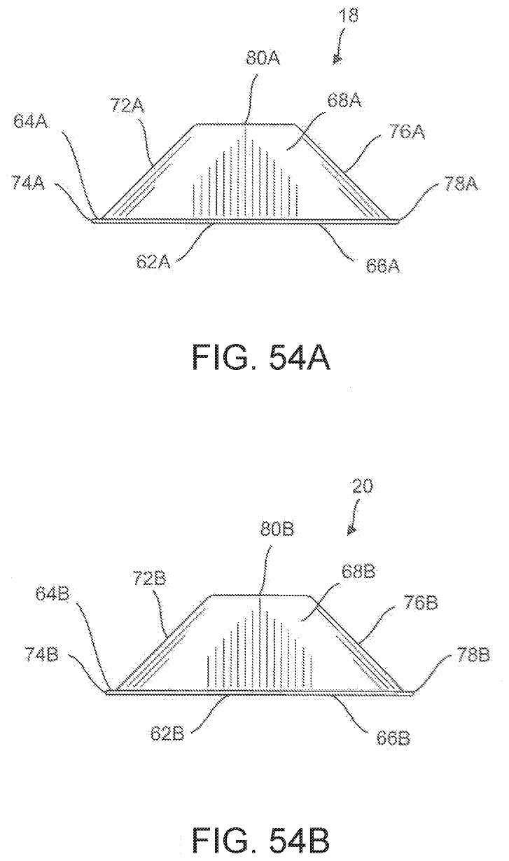

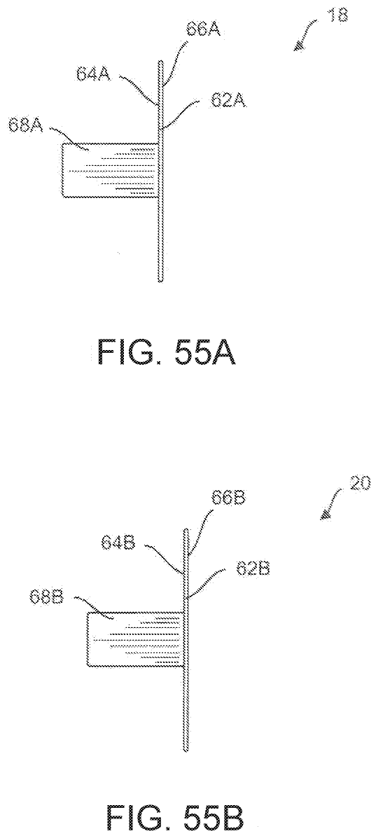

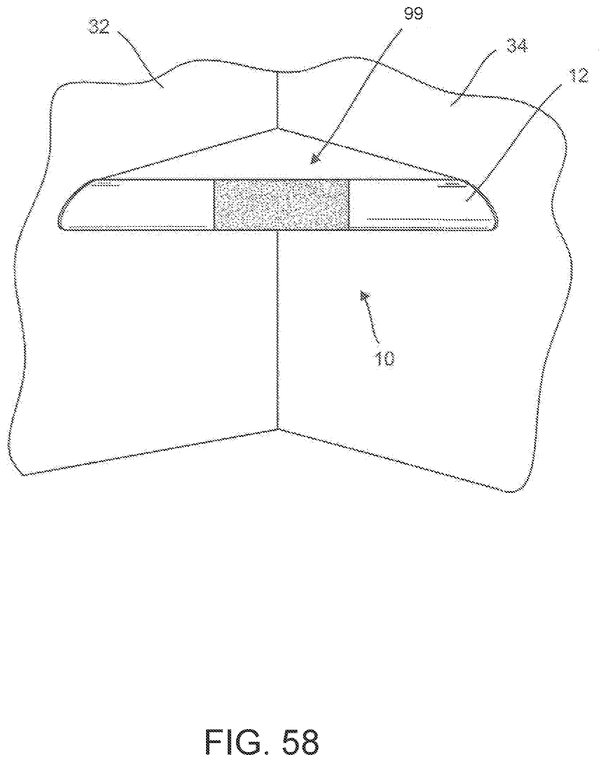

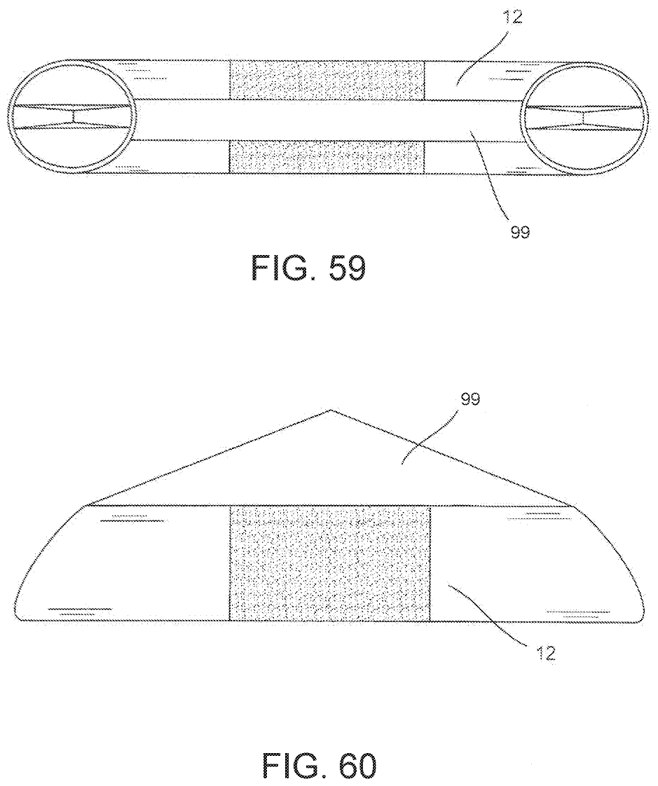

FIGS. 43-60 illustrate an embodiment of a support assembly, which is designated hereinafter by reference numeral 10. As will be described in more detail below, in general the support assembly 10 includes a substantially tubular member 12, a first insert 14, a second insert 16, a first end cap 18, a second end cap 20 and a plurality of fasteners 22A, 22B. The support assembly 10 can be used, for example, as a foot rest, a grab bar, a mounting structure in conjunction with bath accessories or as support for any structure (e.g., shelving). Although the support assembly 10 is shown as including a tubular member 12 that is substantially cylindrical, the tubular member 12 can be any supporting body of any shape that extends between at least a first end cap and a second end cap. For example, as shown in an embodiment in FIGS. 58-60, the support assembly includes a shelving support 99 that includes a cantilevered plate attached (e.g., welded) to a tubular member.

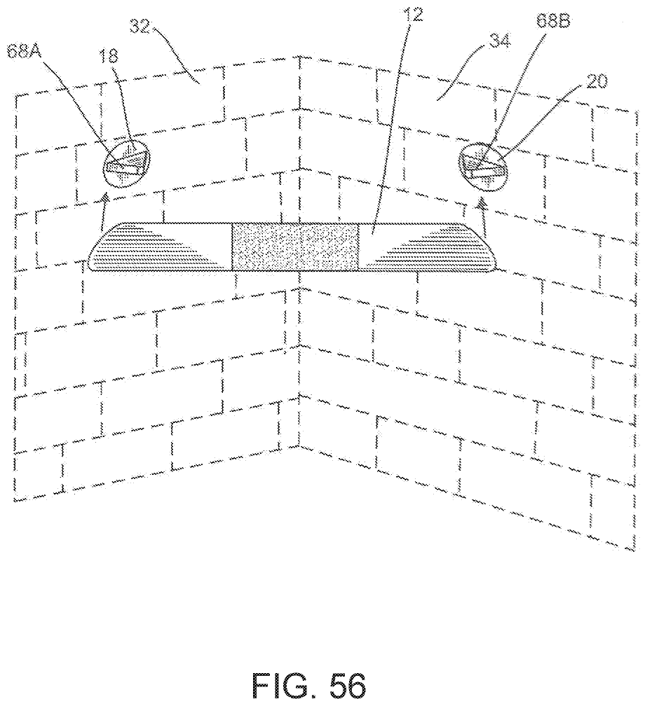

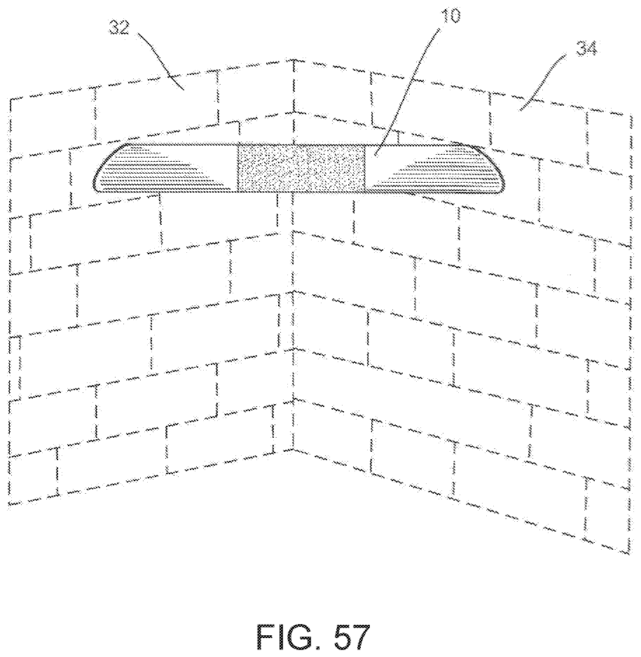

As shown in an embodiment in FIGS. 43-57, the tubular member 12 is an elongated hollow cylindrical structure that includes an outer surface 24 and an inner surface 26 and that is delimited between a first end 28 and a second end 30. The first end 28 and the second end 30 of the tubular member 12 are both angled such that a first plane extending along the first end 28 and a second plane extending along the second end 30 converge and intersect each other at a central point between the ends 28, 30 of the tubular member 12. As such, in an embodiment, the first angled end 28 and the second angled end 30 allow for the support assembly 10 to be mounted between two converging surfaces 32, 34 (See FIGS. 56 and 57) that are substantially perpendicular to each other. In an embodiment, the first end 28 and the second end 30 are both angled at approximately about 45 degrees.

As will be explained in more detail below, as shown in FIGS. 43, 44, and 47-50, a first opening 36 extends through the tubular member 12 substantially transverse to and near the first end 28 of the tubular member 12 and a second opening 38 extends through the tubular member 12 substantially transverse to and near the second end 30 of the tubular member 12.

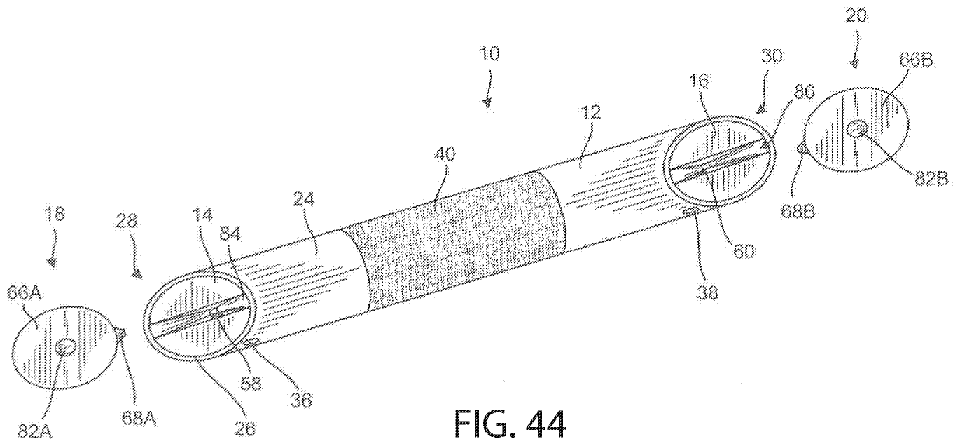

As shown in an embodiment in FIG. 44, the first end 28 and the second end 30 of the tubular member 12 are substantially ovoid. In an embodiment, the tubular member 12 is formed from metal such as stainless steel (e.g., 18/8 (304) stainless steel). However, the tubular member 12 can be formed from any material that is known or may become known that allows for sustaining a force to be applied thereto. As can be seen in an embodiment in FIG. 43, an anti-slip grip 40 can extend about at least a portion of the outer surface 24 of the tubular member 12.

As depicted, for example, in FIG. 44, the first insert 14 is fixed within the first end 28 of the tubular member 12 and the second insert 16 is fixed within the second end 30 of the tubular member 12. The first insert 14 and second insert 16 can be fixed within the tubular member by press fit, welding, bonding (e.g. using an adhesive), fastening or the like.

In an embodiment, the first insert 14 and the second insert 16, respectively include a body 42A, 42B that has a base 44A, 44B, a first projection 46A, 46B that extends from the base 44A, 44B in a first direction and a second projection 48A, 48B that is spaced from the first projection 46A, 46B and extends from the base 44A, 44B in the first direction as well. Both the first projection 46A, 46B and the second projection 48A, 48B include an outer surface 50A, 50B, 52A, 52B, respectively, that is contoured to be contactable with the inner surface 26 of the tubular member 12 and an inner surface 54A, 54B, 56A, 56B that extends substantially linearly from the base 44A, 44B of the first and second insert 14, 16, respectively. In an embodiment, the outer surfaces 50A, 50B, 52A, 52B of the inserts 14, 16 are substantially ovoid. As can be seen in FIG. 44, the first and second projections 46A, 46B, 48A, 48B extend at an angle from the base 44A, 44B that is substantially the same as the angle of the first end 28 of the tubular member 12. As such, the inner surfaces 54A, 54B, 56A, 56B of the projections 46A, 46B, 48A, 48B are substantially triangular. In an embodiment as shown in FIG. 49, the inner surfaces 54A, 54B, 56A, 56B of the first and second projection 46A, 46B, 48A, 48B each form a right triangle. However, the inserts 14, 16 can be configured to be any shape and/or size to accommodate the end caps 18, 20.

As shown in an embodiment in FIG. 44, a first hole 58 extends through one of the first projection 46A and the second projection 48A of the first insert 14 with the first insert 14 adaptable such that the first hole 58 is in alignment with the first opening 36 formed in the tubular member 12. As shown in FIGS. 44 and 49, a second hole 60 extends through one of the first projection 46B and the second projection 48B of the second insert 16, which is adaptable so that the second hole 60 is in alignment with the second opening 38. In an embodiment, the first hole 58 can be formed in both the first projection 46A and the second projection 48A of the first insert 14 and the second hole 60 can be formed in both the first projection 46B and the second projection 48B of the second insert 16.

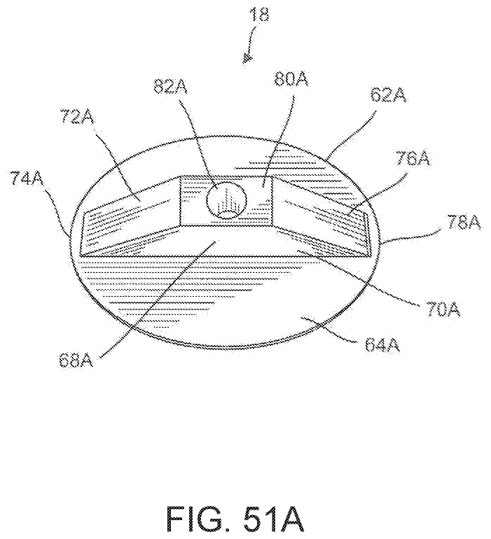

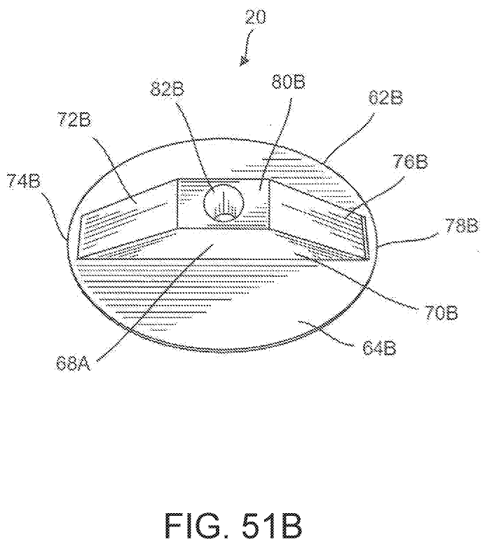

FIGS. 51-55 illustrate an embodiment the first end cap 18 and the second end cap 20 that are configured to be arranged within the first insert 14 and the second insert 16, respectively, to fix the tubular member 12 to a structure. The first end cap 18 and the second end cap 20, respectively include a body 62A, 62B that has a first surface 64A, 64B and a second surface 66A, 66B, which opposes the first surface 64A, 64B. As shown in an embodiment in FIGS. 51-53, the body 62A, 62B of the first and second end cap 18, 20, respectively, is substantially ovoid. A trapezoidal element 68A, 68B extends, respectively, from the first surface 64A, 64B of the body 62A, 62B of the end caps 18, 20. In an embodiment, the body 62A, 62B is substantially ovoid. However, the end caps can be of any shape and the elements that extend from the end caps can also be of any shape that substantially matches the opening within the inserts 12, 14.

In an embodiment, the trapezoidal element 68A, 68B includes a first base 70A, 70B that substantially extends along longitudinal diameter from the first surface 64A, 64B of the body 62A, 62B of the end caps 18, 20, a first sidewall 72A, 72B extends at or near a first end 74A, 74B of the first base 70A, 70B at an angle, a second sidewall 76A, 76B extends at or near a second end 78A, 78B of the first base 70A, 70B at an angle and a second base 80A, 80B that is spaced from and substantially parallel to the first base 70A, 70B and that extends between the first sidewall 72A, 72B and the second sidewall 76A, 76B. With the trapezoidal element 68A, 68B encompassing the end caps 18, 20 and interacting with the inserts 14, 16, respectively, rotational forces are substantially mitigated.

In an embodiment, the trapezoidal element 68A, 68B includes an opening 82A, 82B through which a fastener (e.g., a screw) can extend to fix the trapezoidal element 68A, 68B to a structure (see e.g., FIGS. 56 and 57). As can be seen in an embodiment in FIGS. 51-53, the opening 82A, 82B extends centrally from the second surface 66A, 66B of the body 62A, 62B of each of the end caps 18, 20 through the first base 70A, 70B and second base 80A, 80B of the trapezoidal element 68A, 68B. The trapezoidal element 68A, 68B herein allow room for the head of a mounting screw.

As shown in FIG. 56, upon fastening the end caps 18, 20 to a structure, the tubular element 12 can be slide over the trapezoidal elements 68A, 68B, arranging the first trapezoidal element 68A within a slot 84 of the first insert 14 formed between the inner surface 54A, 56A of the first and second projections 46A, 48A and the second trapezoidal element 68B within the slot 86 formed between the inner surface 54B, 56B of the first and second projections 46B, 48B of the second insert 16. A first fastener 22A can be inserted through the first opening 36 in the tubular member 12 and the first hole 58 of the first insert 14 and contact the trapezoidal element 68A to fix the first end cap 18 within the tubular member 12 and a second fastener 22B can be inserted through the second opening 38 in the tubular member 12 and the second hole 60 of the second insert 48 and contact the trapezoidal element 68B to fix the second end cap 20 within the tubular member 12. In an embodiment, the first hole 58 of the first insert 46 and the second hole 60 of the second insert 48 include threading (not shown) extending about each opening 58, 60 and the fastener 22A, 22B is a set screw with threading that fixes the end caps 18, 20 within the inserts 46, 48 and to the tubular member 12.

Because the end caps 18, 20 are not mounted in parallel to each other the rotational axes of the end caps 18, 20 contrast each other and in turn stabilize the tubular element 12. The moment forces only exist in the area of the tubular element 12 that exceeds the axes of the end caps. As such, the moment forces are minimized and the torsion forces are negated by opposing each other resulting in an assembly that is stable and does not rotate upon a force being applied thereto.

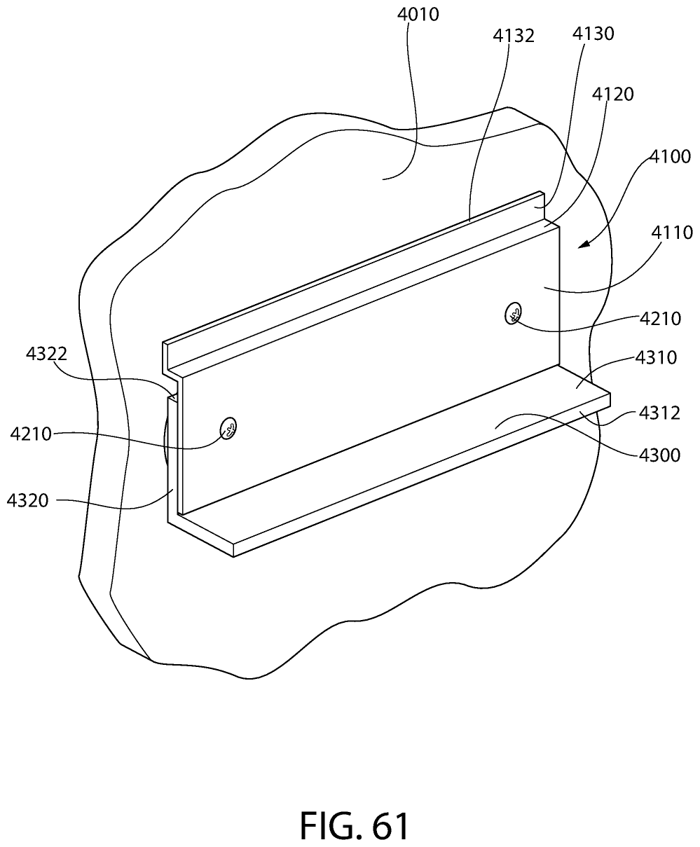

FIG. 61 shows an example of a fastening system in accordance with an embodiment of the invention in an assembled state. In this example, the fastening system includes a cover 4100 that covers a mountable accessory object or item, in this non-limiting case a shelf 4300, that is fastened to wall 4010 by fasteners 4200 (represented in this figure by fastener heads 4210). The cover 4100 and shelf 4300 may be horizontally elongated in one embodiment.

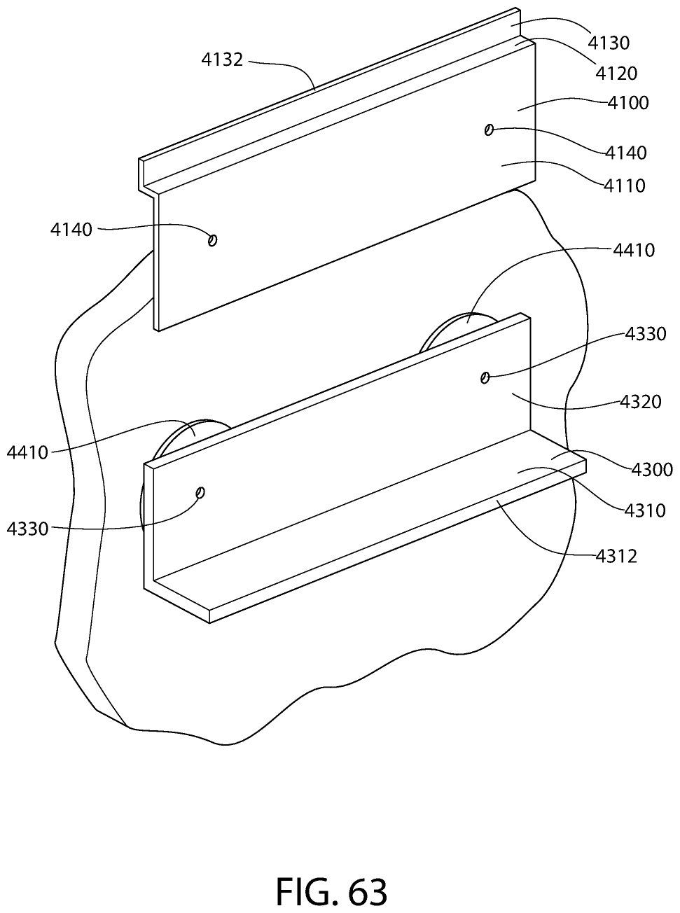

FIG. 63 shows the system of FIG. 61 in a partially disassembled state. FIG. 63 shows shelf 4300 and force-distributing plates 4410 in position on wall 4010, but with cover 4100 removed. If this system were to be installed without cover 4100, force-distributing plates 4410 would be visible, which can be esthetically undesirable. Cover 4100 provides an esthetically pleasing solution by covering force-distributing plates 4410 and an upper edge 4322 (e.g. horizontal) of shelf 4300.

Cover 4100 has a first section 4110 that, in this example, extends vertically parallel to an outer surface of wall 4010. First section 4110 defines a planar rear surface 4902 and opposing parallel planar front surface 4903. A second section 4130 extends, in this example, parallel to first section 4110 and is configured to press against the outer surface of wall 4010. Second section defines a planar rear surface 4906 and opposing parallel planar front surface 4901. Each section 4110, 4130 has a greater height/width than their respective thickness formed by the bent plate or welded construction. A planar ledge 4120 extends, in this example horizontally, between first section 4110 and second section 4130. Second section 4130 has an upper edge 4132 that, in this example, extends horizontally. In other examples, edge 4132 can be radiused, angled, or of some other shape that is esthetically pleasing and/or satisfies another purpose. Cover 4100 has two holes 4140 through which fasteners can extend. Although two holes 4140 are shown in this example, it is noted that fewer or more fasteners can be used and, as a result, fewer or more holes 4140 can be provided.

Shelf 4300 has, in this example, a first section 4310 that extends horizontally perpendicular to the exposed flat surface or face of wall 4010, and a second section 4320 that extends vertically parallel to the face of wall 4010 and perpendicular to the first section. Each section 4310, 4320 has a greater height/width than their respective thickness formed by the bent plate or welded construction. First section 4310 has a front edge 4312 that, in this example, extends horizontally and is vertically flat. In other examples, edge 4312 can be radiused, angled, or of some other shape that is esthetically pleasing and/or satisfies another purpose. Two holes 4330 are provided in second section 4320 through which fasteners can extend. Although two holes 4330 are shown in this example, it is noted that fewer or more fasteners can be used and, as a result, fewer or more holes 4330 can be provided. Because the same fasteners are used to fasten shelf 4300 and cover 4100 to wall 4010, holes 4330 correspond in location and number to holes 4140 which become concentrically aligned when the shelf and cover are assembled.

Shelf 4300, force-distributing plates 4410, and cover 4100 can be formed of the same or different suitable metals such as, for example, stainless steel, aluminum, titanium, or other. Non-metallic materials such as plastics or any other suitable material may be used for these components provided they have sufficient strength and rigidity.

Two force-distributing plates 4410 are shown in FIG. 63. Force-distributing plates 4410 (discussed in more detail below) distribute the force exerted on the face of wall 4010 by the fasteners so that the fasteners are not pulled though wall 4010 or otherwise deform the outer surface of wall 4010. FIG. 63 illustrates how force-distributing plates 4410 can extend beyond (above in this example) the limits of second section 4320 of shelf 4300 (e.g. above horizontal top edge 4322 of second section 4320). This can produce an undesirable visual effect. As can be seen in FIG. 61, cover 4100 hides force-distributing plates 4410 to produce a more visually pleasing result. Cover 4100 also covers a gap between second section 4320 and the outer surface of wall 4010 caused by force-distributing plates 4410 (shown in more detail below).

It will be appreciated that in other possible constructions, force-distributing plates 4410 may have a height which is less than or flush with the top edge 4322 of shelf 4300. This situation would still create an esthetically displeasing appearance and gap between the wall and shelf which could also benefit from the use of cover 4100 to conceal the force-distributing plates and at least partially cover the gap.

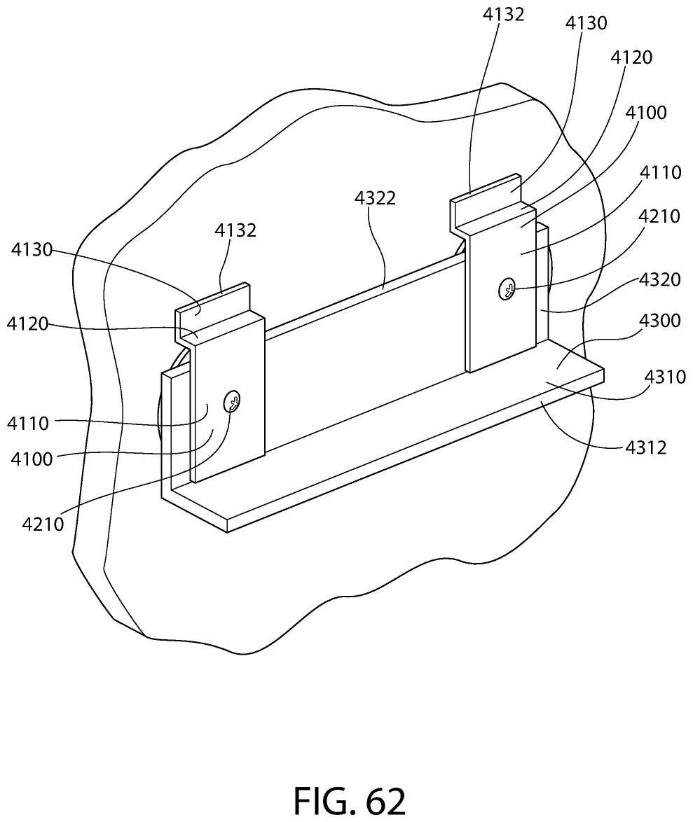

FIG. 62 shows another embodiment of the invention that is similar to the embodiment shown in FIG. 61, except that two covers 4100 are used instead of one. This embodiment covers force-distributing plates 4410 but gives a different visual appearance than the embodiment shown in FIG. 61 such that portions of the section 4320 of shelf 4300 remain visible, whereas in FIG. 61 the single cover 4100 has a horizontal length coextensive with the shelf and conceals the entirety of the section 4320. This present embodiment of FIG. 62 also exposes part of the gap between second section 4320 of shelf 4300 and the outer surface of wall 4010 and, as a result, allows an accessory (such as, for example, a condiment rack) to be hung over the top horizontal edge 4322 of the shelf.

Force-distributing plates 4410 are generally flat or planar broadened structures in the general form of a washer with a width/height greater than their thickness. Force-distributing plates 4410 and may have any suitable shape. In one embodiment, the plates 4410 may be circular as depicted. Other non-polygonal shapes and polygonal shapes including rectilinear shapes (e.g. square or rectangular) may be used. The invention is thus not restricted by the shape of the force-distributing plates.

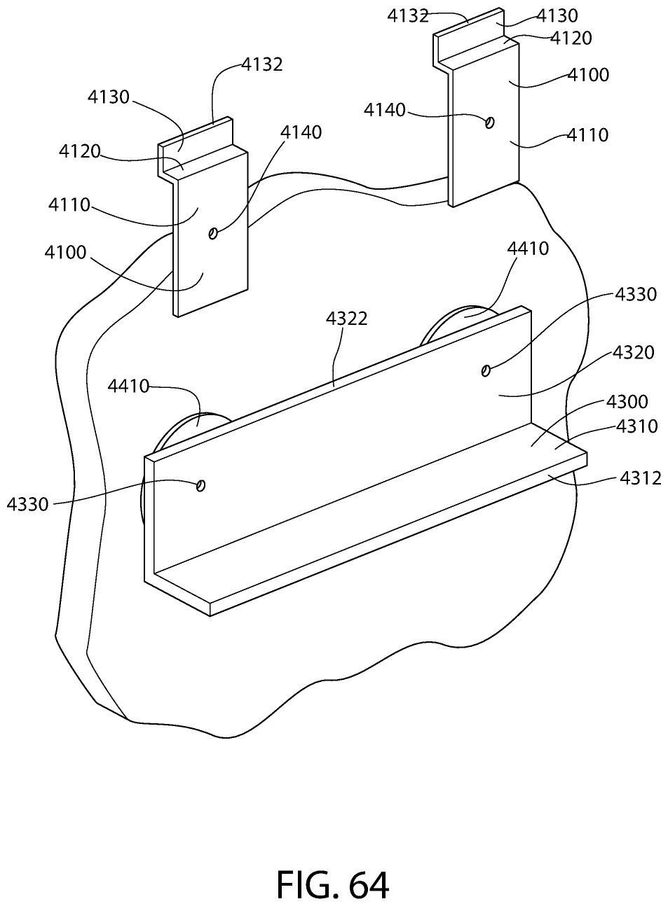

FIG. 64 shows the example shown in FIG. 62 in a partially disassembled state. FIG. 64 shows shelf 4300 and force-distributing plates 4410 in position on wall 4010, but with covers 4100 removed. If this system were to be installed without covers 4100, force-distributing plates 410 would be visible, which can be esthetically undesirable. Covers 4100 provide an esthetically pleasing solution by covering force-distributing plates 4410, while leaving a portion of edge 4322 of shelf 4300 exposed.

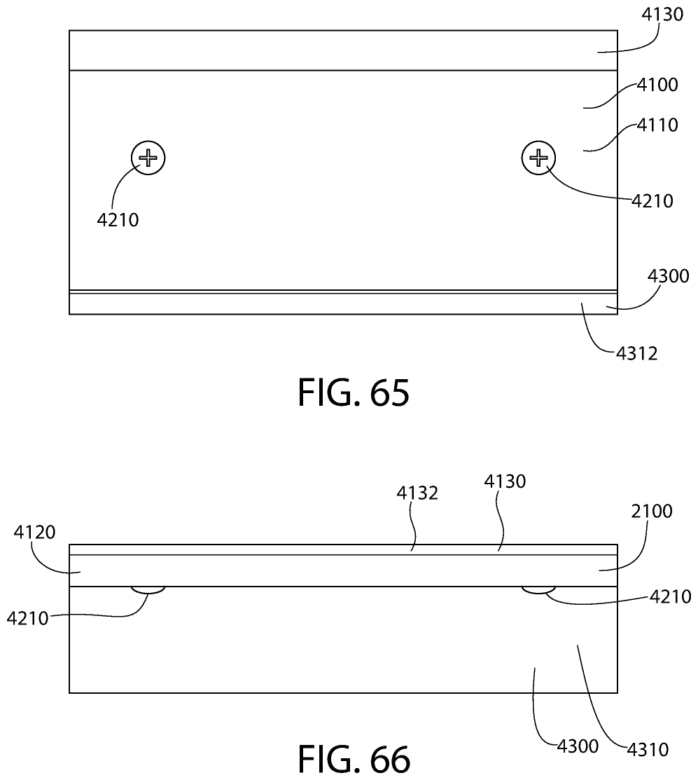

FIG. 65 is a front view of the embodiment shown in FIG. 61. In this example, fastener heads 4210 are shown as Phillip's head bolts. However, any suitable head or engagement portion can be used, such as, for example, an external hex head, an internal hex head, or a slotted head. However, in some embodiments, a smooth, rounded fastener head is desirable in order to removably engage a slot in an accessory that is used with the system (discussed below).

FIG. 66 is a top view of the embodiment shown in FIG. 61. In this example fastener heads 4210 are rounded in order to removably engage a slot in an accessory that is used with the system (discussed below).

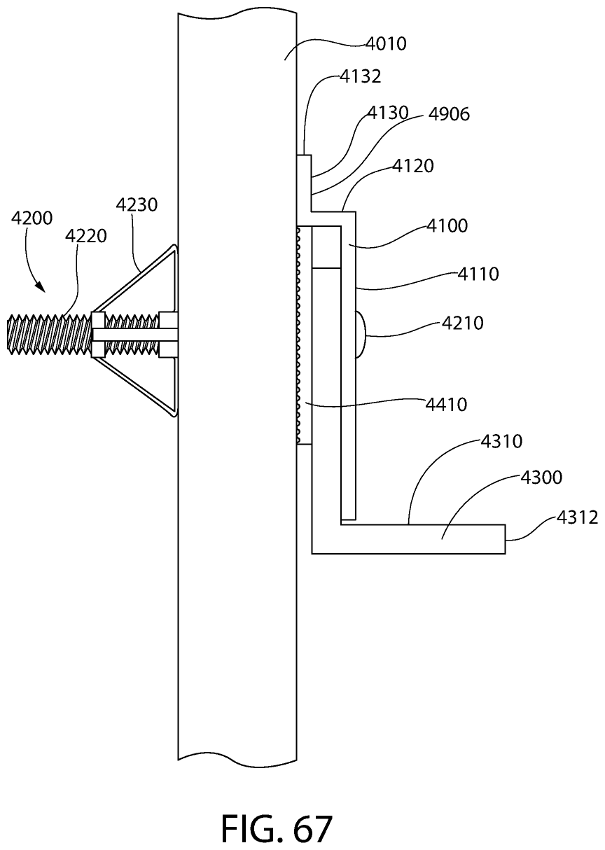

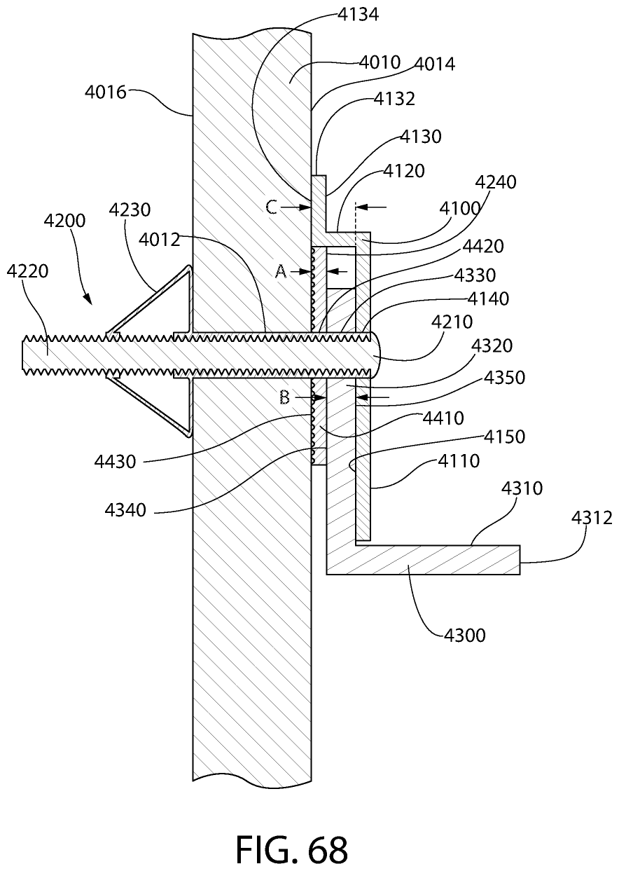

In FIGS. 67 and 68 the example of FIG. 61 is shown mounted to wall 4010. A method for fastening the item (e.g. shelf 4300 or other) to the wall will now be briefly summarized. It bears noting the method and these figures also apply to the example shown in FIG. 62 using two force-distributing plates 4410. In these figures, fastener 4200 has a head 4210, a threaded shaft 4220 and an expansion element or part 4230 (e.g. expansion anchor) for use with a hollow wall that generally comprises two or more deformable triangular shaped arms in one embodiment as shown. Such expansion parts 44230 or anchors are coupled to the shaft of fastener 200, and are well known in the art and commercially available. Other types of expansion anchors/parts may be used and does not limit the invention.

Starting with expansion part 4230 in an unexpanded state, threaded shaft 4220 and expansion part 4230 of fastener 4200 are inserted (in order) through hole 4140 in cover 4100, hole 4330 in shelf 4300, a hole 4420 in force-distributing plate 4410, and a pre-drilled hole 4012 in hollow wall 4010; the holes being all concentrically aligned with each other. If the holes in the cover, shelf, and force-distributing plate are not large enough in diameter to pass the expansion part 4230 therethrough, the threaded shaft 4220 of fastener 4200 may alone be passed through those three holes and the expansion part may be then threaded or inserted over the shaft before inserting the shaft and expansion part through the hole 4010 pre-drilled in the hollow wall 4010. Either assembly scenario is acceptable.

The diametrically enlarged head 4210 of fastener 4200 prevents fastener 4200 from passing all the way through first section 4110 of cover 4100. Head 4210 is engaged by a turning tool (e.g. manual screwdriver or electric drill/driver) and turned to rotate threaded shaft 4220, which causes expansion part 4230 to expand outward and press against an inner face 4016 of wall 4010 as the fastener is tightened and the shaft advances through the wall. This secures the shelf 4300 assembly to the wall in rigid manner.

As can be seen from FIGS. 67 and 68, a planar rear surface or face 4430 of force-distributing plate 4410 is pressed against and abuttingly engages the planar outer surface or face 4014 of wall 4010 when the assembly is fastened to wall 4010. A planar surface or rear face 4340 of second section 4320 of shelf 4300 is pressed against a planar front surface or face 4440 of force-distributing plate 4410 in this assembled state. Also, a planar rear surface or face 4150 of first section 4110 of cover 4100 is pressed against a planar front surface or face 4350 of second section 4320 of shelf 4300 while a planar rear surface or face 4134 of second section 4130 of cover 4100 is pressed against planar outer surface or face 4014 of wall 4010. The front surface or face 4906 is exposed. As can be seen from FIGS. 67 and 68, in this example, the sum of a thicknesses A of force-distributing plate 4410 and a thickness B of second portion 4320 of shelf 4300 equals a length C of ledge 4120 so that rear face 4134 of second section 4130 of cover 4100 and rear face 4430 of force-distributing plate 4410 are co-planar. This configuration results in the compressive fastening force being exerted on the outer surface of wall 4010 via tightening fastener 4200 by both the second section 4130 and force-distributing plate 4410, and that force being substantially equal. The force-distributing plate 4410 and cover both advantageously distribute the force over a collectively larger surface area of the wall to prevent damaging the wall yet provide a secure mount.

In other embodiments, the dimensions of one or more parts can be altered so that rear face 4134 of second section 4130 and rear face 4430 of force-distributing plate 4410 are not co-planar. For example, it may be desirable for the sum of thicknesses A and B be slightly more than length C so that rear face 4134 of second portion 4130 barely rests against outer face 4014 of wall 4010 while rear face 4430 of force-distributing plate 4410 slightly depresses outer face 4014 of wall 4010. This can be desirable when the system is mounted to a particularly delicate wall surface so that no depression of the wall surface is visible when the system is in the installed state. In another example, it may be desirable for the sum of thicknesses A and B be slightly less than length C so that rear face 4134 of second portion 4130 depresses outer face 4014 of wall 4010 more than rear face 4430 of force-distributing plate 4410 depresses outer face 4014 of wall 4010. This can be desirable when it is particularly important that nothing can fall between upper ledge 4132 and wall 4010.

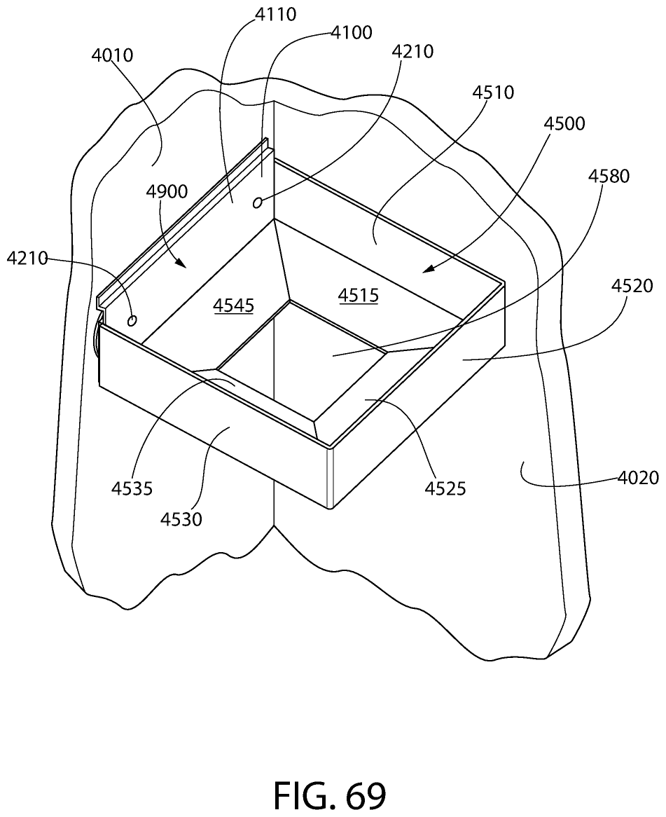

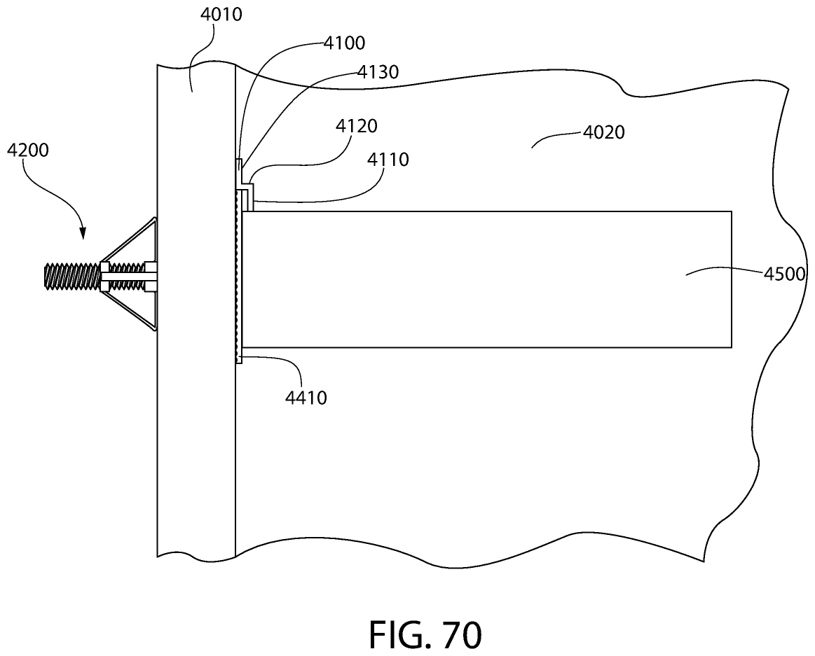

FIGS. 69-71 show an embodiment of a fastening or mounting system comprising an accessory support structure 4500 in the form of a perimeter frame with optionally open, partially open, or fully closed bottoms which can be fastened to wall 4010. The perimeter frame support structure 44500 may be mounted directly to the wall 4010 with fasteners 4200, or alternatively may utilize the wall mounting system assembly previously described herein with respect to FIGS. 61-68 including the force-distributing plate 4410 and cover 4100 to fasten the support structure 4500 to wall 4010 in a cantilevered manner. Support structure 4500 may be used to support various interchangeable items or accessories such as, for example, shelves, soap dispensers, racks, light fixtures, or any other accessory in a cantilevered manner.

It bears noting that although the perimeter frame support structure 500 is shown as having a generally square shape in FIGS. 69-71, in other embodiments the perimeter frame may be elongated having a rectangular shape with two long front/rear sides and shorter lateral left/right sides. The support structure 4500 may have any length and projection from the wall depending on the particular intended use of the support structure.

Perimeter 4300, force-distributing plates 4410, and cover 4100 can be formed of the same or different suitable metals such as, for example, stainless steel, aluminum, titanium, or other. Non-metallic materials such as plastics or any other suitable material may be used for these components provided they have sufficient strength and rigidity.

In this example, support structure 4500 has a rectilinear frame-like structure generally formed by four intersecting vertically-oriented side elements or members 4510, 4520, 4530, 4540 (also referred to herein as “sides” for brevity). Side 4510 includes a horizontal portion 4515 extending from side 4510 toward a central opening 4580 of support structure 4500. Side 4520 includes a horizontal portion 4525 extending from side 4520 toward opening 4580. Side 4530 includes a horizontal portion 4535 extending from side 4530 toward opening 4580. Side 4540 includes a horizontal portion 4545 extending from side 4540 toward opening 4580. The horizontal portions thus define the opening 4580. The vertical portions of sides 4510-4540 may be arranged to create the rectilinear perimeter frame configuration forming perpendicular corners between each pair of the intersecting and adjacent sides. In this example, the foregoing horizontal portions are intersecting such that the diagonal edges of the horizontal portions contact the diagonal edges of the adjacent horizontal portions to create continuous shelf around opening 4580. The diagonal edges may be welded together in one embodiment. In other examples, the diagonal edges of the horizontal portions do not contact the diagonal edges of the adjacent horizontal portions. In yet other examples, the horizontal portions converge in the central area of support 4500 such that no opening 4580 exists.

In this example shown in FIGS. 69-72, side 4510 of the perimeter frame contacts wall 4020 but is not fastened to wall 4020 which meets wall 4010 at a corner. This represents a corner mounting situation of the support structure 4500. In other examples, side 4520 may be fastened to wall 4020 in the same manner that side 4540 is fastened to wall 4010 using force-distributing plates 4410 and covers 4100. This provides two sides and places of support for the perimeter frame to hold the weight of heavy objects supported by the frame. In other examples, the perimeter frame may be attached to a section of wall 4010 or 4020 not adjacent a corner such that side 4510 does not contact wall 4020. In this situation, the perimeter frame is supported in an entirely cantilevered manner.

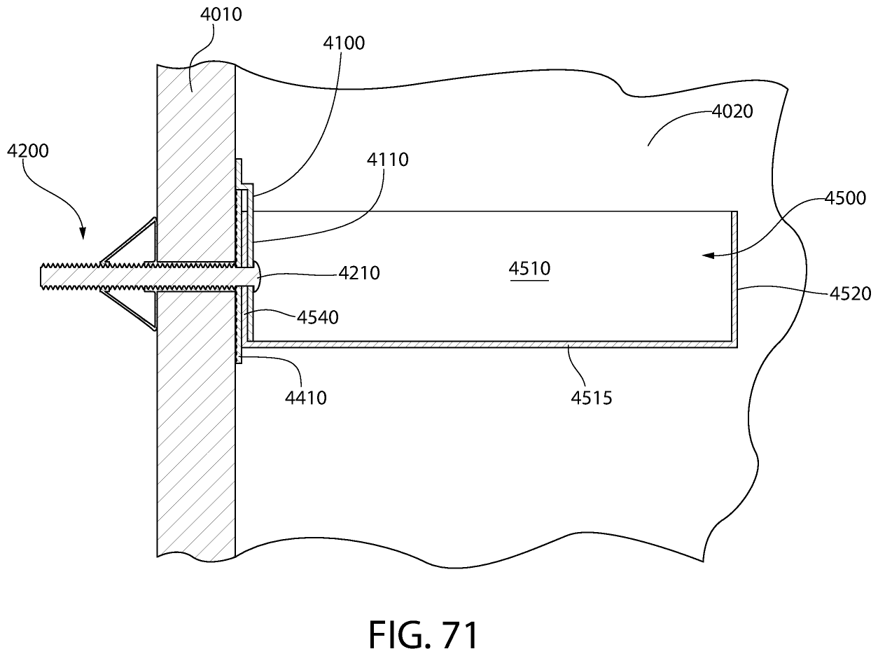

FIG. 71 shows in sectional view that support structure 4500 is fastened to wall 4010 in the same manner that shelf 4300 is fastened to wall 4010 in FIG. 68.

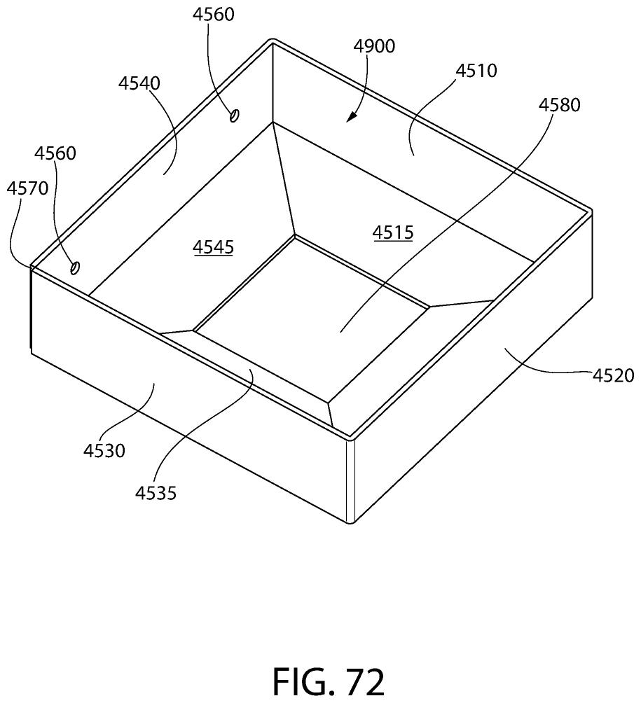

FIG. 72 shows support structure 4500 as having two holes 4560 in side 4540. Holes 4560 serve the same purpose as holes 4330 of shelf 4300. Due to the fabrication method used in this example, a continuous corner exists between sides 4540 and 4510, between sides 4510 and 4520, and between sides 4520 and 4530. In contrast, a joint 4570 exists between sides 4530 and 4540 (explained further below).

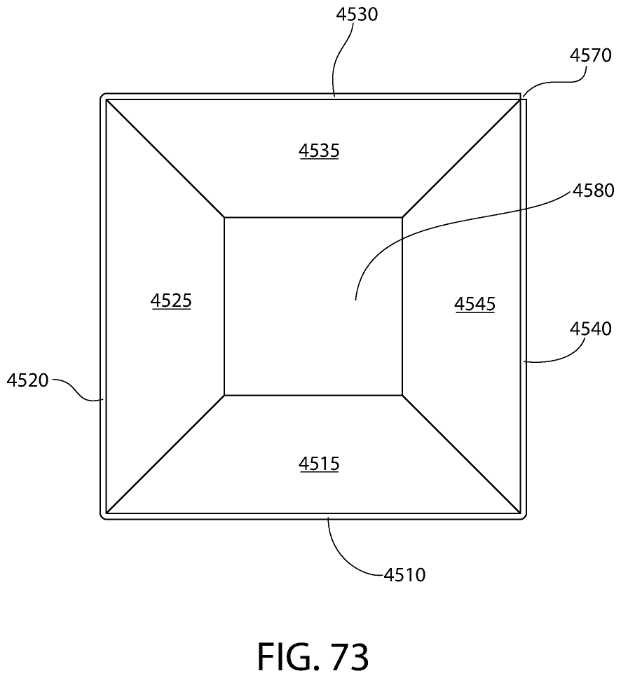

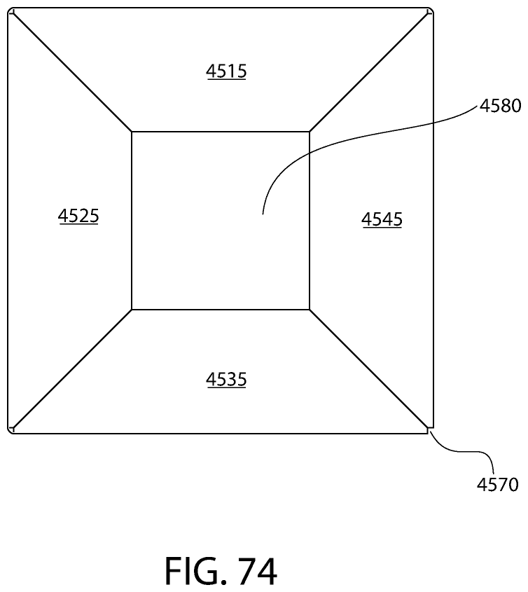

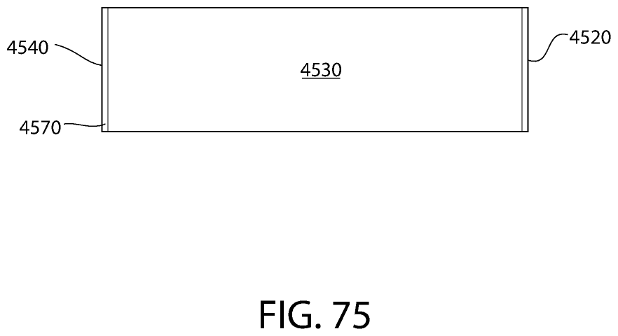

FIG. 73 is a top view of support structure 4500 and shows opening 4580 and joint 4570. FIG. 74 is a bottom view of support structure 4500 and shows opening 4580 and joint 4570. FIG. 75 is a side view of support structure 4500 and also shows joint 4570.

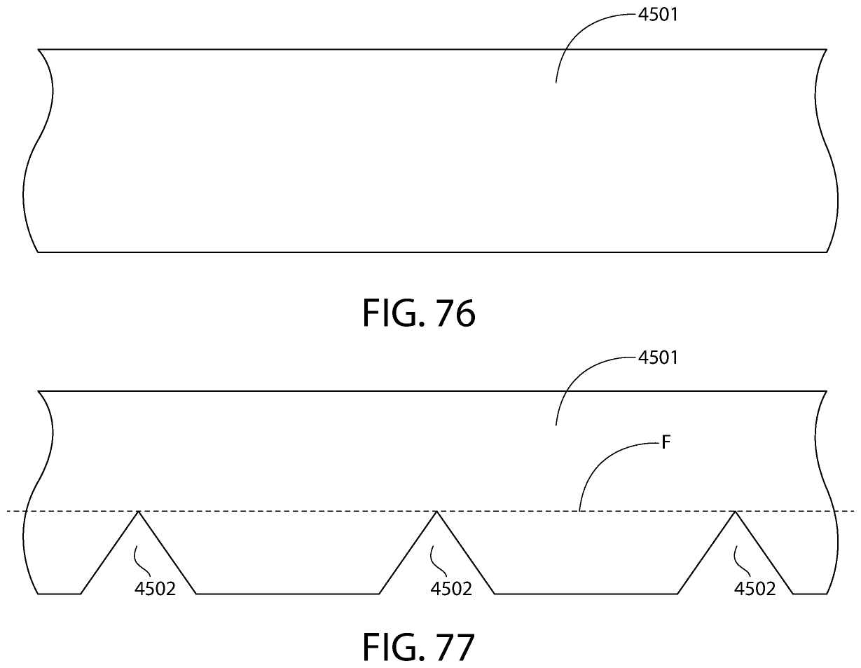

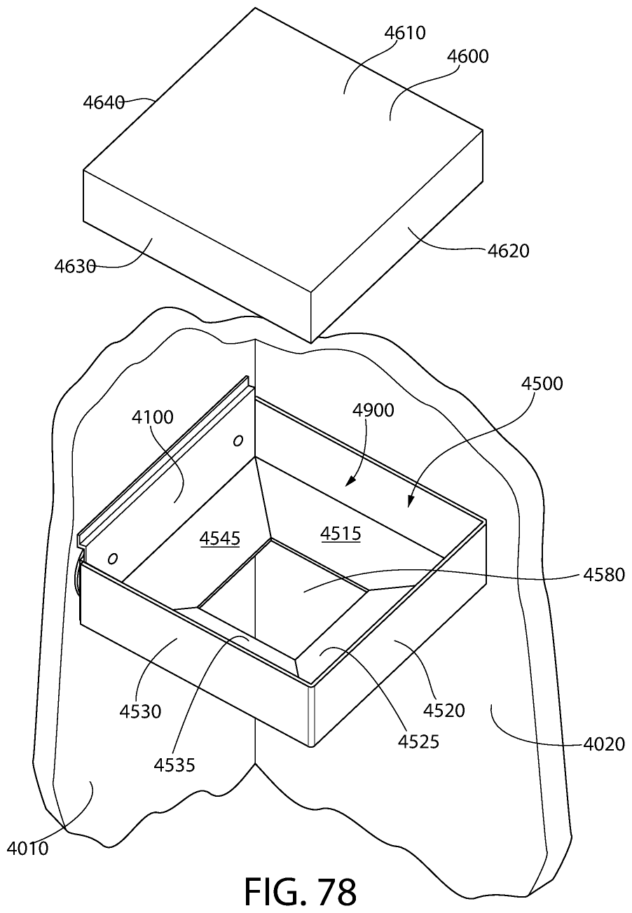

FIGS. 76 and 77 will be used to illustrate one fabrication method of support structure 4500. In this method, a workpiece blank 4501 can be a suitable metal such as, for example, stainless steel, aluminum, titanium, or other. Non-metallic materials such as plastics or any other suitable material may be used provided they have sufficient strength and rigidity. Blank 4501 has sections cut out of it to form notches 4502. The flaps resulting from the notches are folded, in this example, at a 90 degree angle along fold line F to form horizontal portions 4515, 4525, 4535, 4545. Ninety degree bends are than made along lines that are perpendicular to fold line F extending from the apex of each notch 4502. These bends form the corners of support structure 4500. The free ends of the resulting structure form joint 4570. The edges along notches 4502 (which now contact each other) can be welded together, joined in some other fashion, or simply left unjoined. Similarly, the free ends that come together as joint 4570 can be welded together, joined in some other fashion, or simply left unjoined. In the case of unjoined edges or ends, the material from which support structure 4500 is made can be sufficiently strong to not require joining.

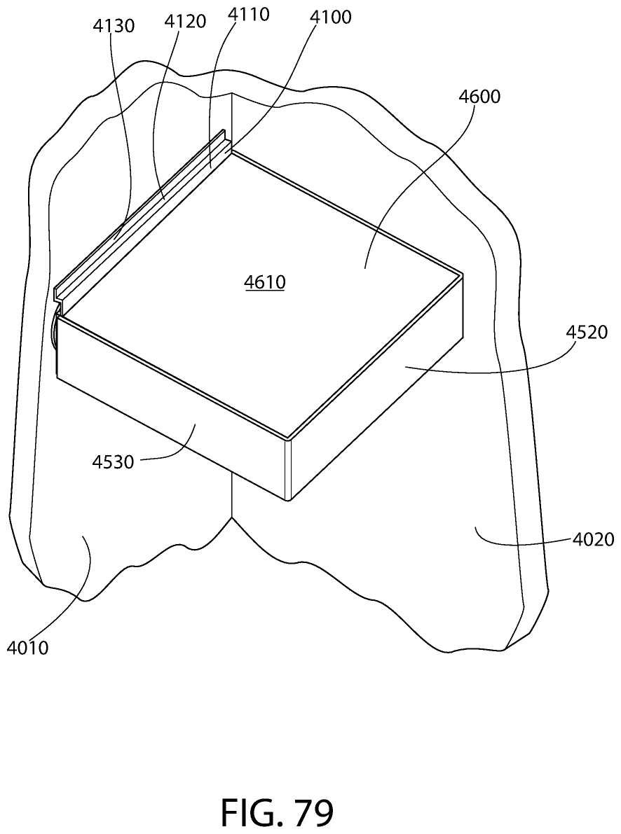

FIG. 78 shows a shelf insert 4600 above support structure 4500. FIG. 79 shows shelf insert 4600 in an installed position in support structure 4500. The perimeter frame support structure 4500 defines an upwardly open receptacle 4900 configured to receive at least a portion, or in some examples the entirety of shelf insert 4600 therein (see also FIG. 69). Shelf insert 4600 has a top surface 4610, plurality of sides including opposing lateral right/left sides 4620, and opposing front side 4630 and rear side 4640. In this example, shelf insert 4600 slides into support structure 4500 with a slight interference fit between its sides and sides 4510, 4520, 4530, 4540 until top surface 4610 is substantially flush with the upper edges of sides 4510, 4520, 4530, 4540. In other embodiments, top surface 4610 is above or below the upper edges of sides 4510, 4520, 4530, 4540.

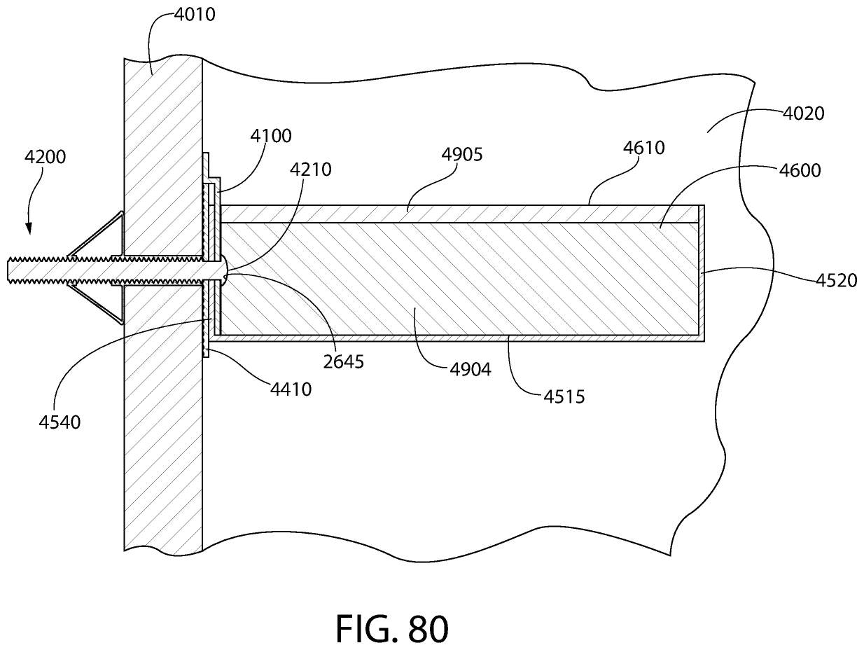

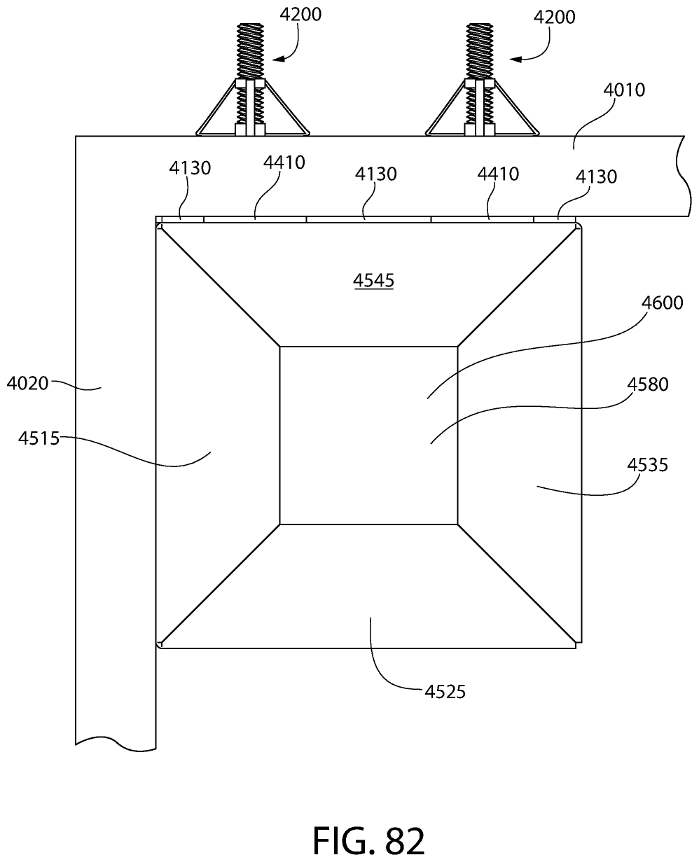

FIG. 80 shows a side sectional view of shelf insert 4600 in the installed position in support structure 4500. In this example, shelf insert 4600 has a groove 4645 that runs horizontally along the side that contacts side 4540 of support structure 4500. Groove 4645 is configured to accept heads 4210 of fasteners 4200 and can provide a locking feature that is not permanent. Shelf insert 4600 is, in this example, pressed into support structure 4500 until heads 4210 engage groove 4645, locking shelf insert 4600 into place. Shelf insert 4600 can then be removed by pushing it upward to disengage heads 4210 from groove 4645. Access to the bottom of shelf insert 4600 is available through opening 4580 (see FIG. 82). In other examples, individual indentations are provided for each head 4210 instead of a single groove 4645 that receives all heads 4210.

Shelf insert 4600 may be made of any suitable material, including for example without limitation wood, marble, plastics, synthetic materials, glass, or others. In some embodiments, shelf insert may have a composite construction formed of two or more materials laminated or adhesively glued together as shown in FIG. 80. The shelf insert depicted includes a veneered decorative top portion layer 4905 of suitable thickness and a bottom core portion or layer 4904 which formed of a different material than the veneer layer. Top layer 4905 is substantially thinner in thickness than the core layer 4904 which supported the decorative layer. Advantageously, this construction allows a less expensive but strong core layer 4904 to be used for supporting objects placed on the shelf insert 4600 which may not be so aesthetically pleasing (e.g. plywood, MDF, particle board, etc.), whereas the decorative top layer 4905, which is exposed and visible to room occupants, can be esthetically pleasing (e.g. hardwood veneers, stone or marble veneers, synthetic veneers with decorative patterns, etc.). This construction is possible in the present embodiment because the core layer 4904 is fully inserted inside the perimeter frame support structure 4500 and not visible to the occupants. The cost of the shelf insert 4600 using the foregoing composite construction can be significantly reduced.

As shown in FIG. 80, the top surface 4610 defined by veneered decorative top layer 4905 may be substantially flush with the top edges of the perimeter frame (i.e. side members 4510-4540). Only the top surface 4610 is thus visible after assembling the shelf insert 4600 into the perimeter frame. In other variations, an upper side portion of the top layer 4905 may extend above the top edges of the perimeter frame such that the top surface 4610 is raised above the top edges of the perimeter frame.

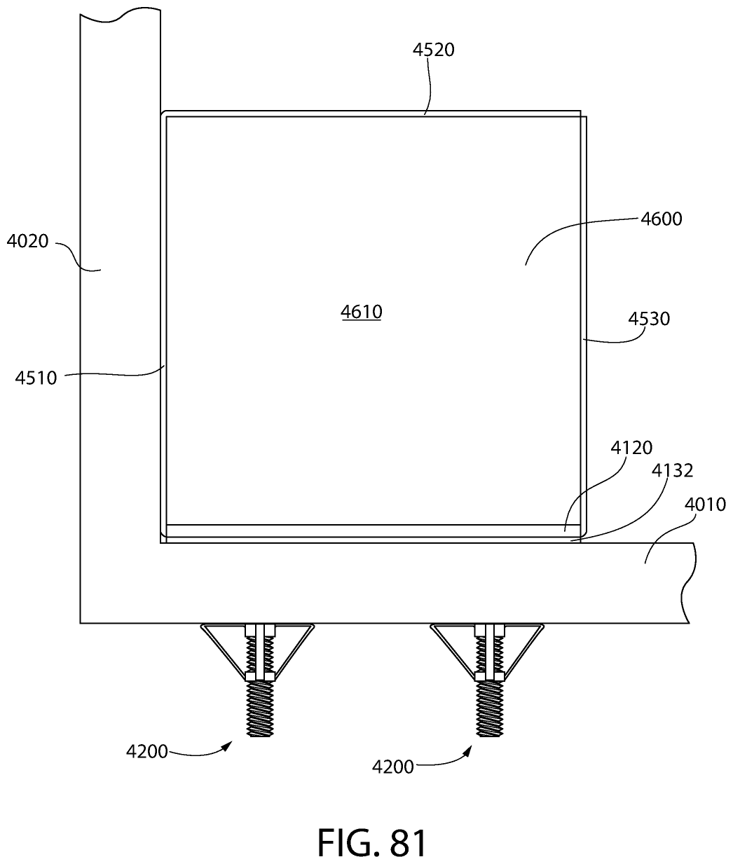

FIG. 81 is a top view of shelf insert 4600 in the installed position. FIG. 82 is a bottom view of shelf insert 4600 in the installed position. The bottom of shelf insert 4600 can be seen through opening 4580 in FIG. 82.

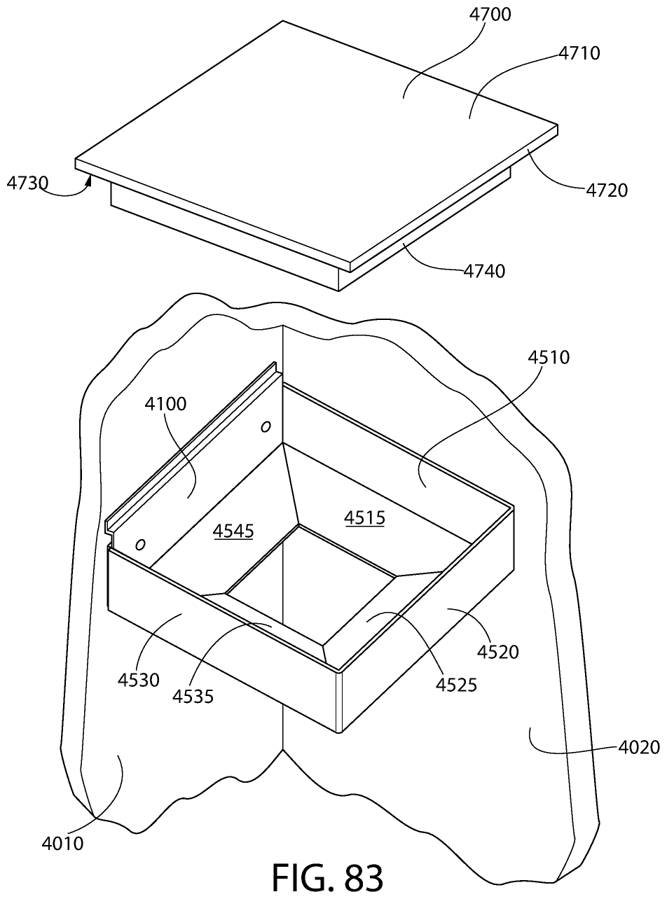

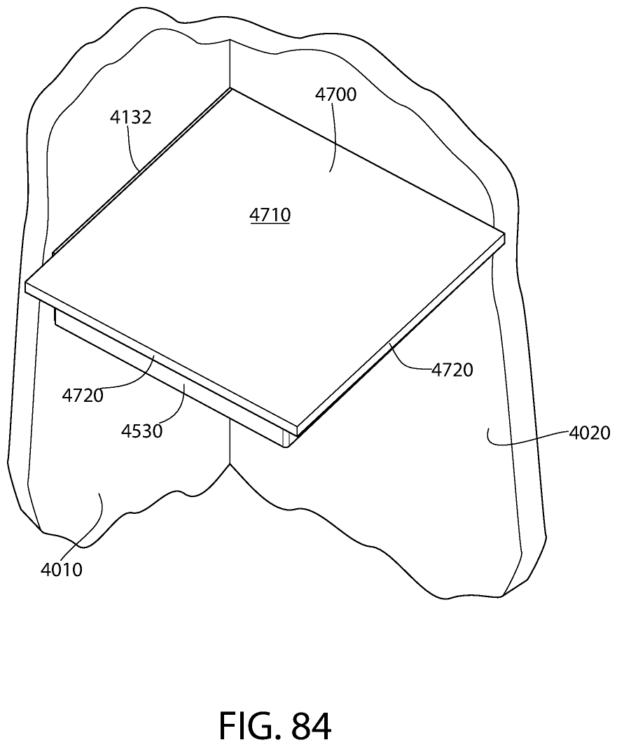

FIGS. 83-87 show another example of a shelf insert 4700 that can be used with support structure 4500. Insert 4700 comprises an upper portion 4709 defining an exposed top surface 4710 of the shelf and a lower insert portion 4740 configured for insertion into open receptacle 4900 of the perimeter frame support structure 4500. Upper portion 4709 has greater lateral dimensions (e.g. width and depth) measured across top surface 4710 than the lower insertion portion 4740. In this example, shelf insert 4700 has a top surface 4710 that extends beyond the perimeter frame and the downwardly projecting insert portion 4740 forming cantilevered overhangs 4711 such that an edge 4720 of shelf insert 4700 is visible. This is in contrast to shelf insert 4600 previously described herein which has a top that does not extend beyond its sides and the perimeter frame (see, e.g. FIGS. 79 and 80).

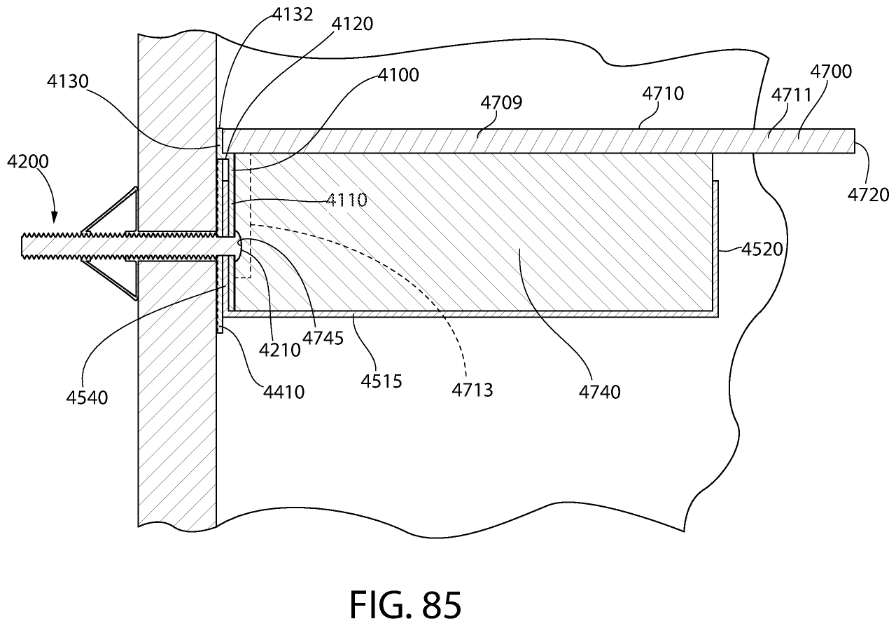

Shelf insert 4700 can be dimensioned so that when it is lowered into the perimeter frame support structure 4500, the insert's bottom surface contacts and rests on horizontal portions 4515, 4525, 4535, 4545 of the support structure (see FIG. 85). In this position, shelf insert 4700 rests on ledge 4120 of cover 4100 and top surface 4710 is flush with upper edge 4132 of cover 4100. The cantilevered overhangs 4711 formed by the upper portion 4709 that extend perimetrically around the upper portion 4709 and which are located above the upper edges of sides 4520 and 4530 of support structure 4500 extend further from insert portion 4740 than does the overhang 4711 that is located above the upper edge of side 4510 of support structure 4500. This is because, in this example, wall 4020 prevents the overhang that is located above the upper edge of side 4510 from extending more than the thickness of side 4510. In other examples where support structure 4500 is not corner mounted and in contact with a wall perpendicular to wall 4010 such as wall 4020, the overhangs of shelf insert 4700 can extend beyond all four the sides of perimeter frame support structure 4500.

As shown in FIG. 85, the upper portion 4709 of the shelf insert 4600 does not contact sides 4510-4540 and is spaced vertically apart from perimeter frame support structure 4500. In other possible embodiments, the shelf insert 4600 and perimeter frame support structure 4500 may be configured so that the overhangs 4711 of the upper portion 4709 may rest on the top edges of the lateral sides 4510, 4530 and front side 4520 of the perimeter frame.

FIG. 84 shows shelf insert 4700 installed in support structure 4500. In this view, upper edge 4132 of cover 4100 is visible. In some embodiments, upper edge 4132 is flush with top surface 4710 of shelf insert 4700. In other embodiments, upper edge 4132 extends above top surface 4710. In other embodiments, upper edge 4132 and ledge 4120 of cover 4100 extend above top surface 4710. In some embodiments where upper edge 4132 and ledge 4120 extend above top surface 4710, an underside 4730 of top surface 4710 rests on the upper edges of sides 4510, 4520, 4530 instead of, or in addition to, the bottom of shelf insert 4700 contacting horizontal portions 4515, 4525, 4535, 4545 of support structure 4500.

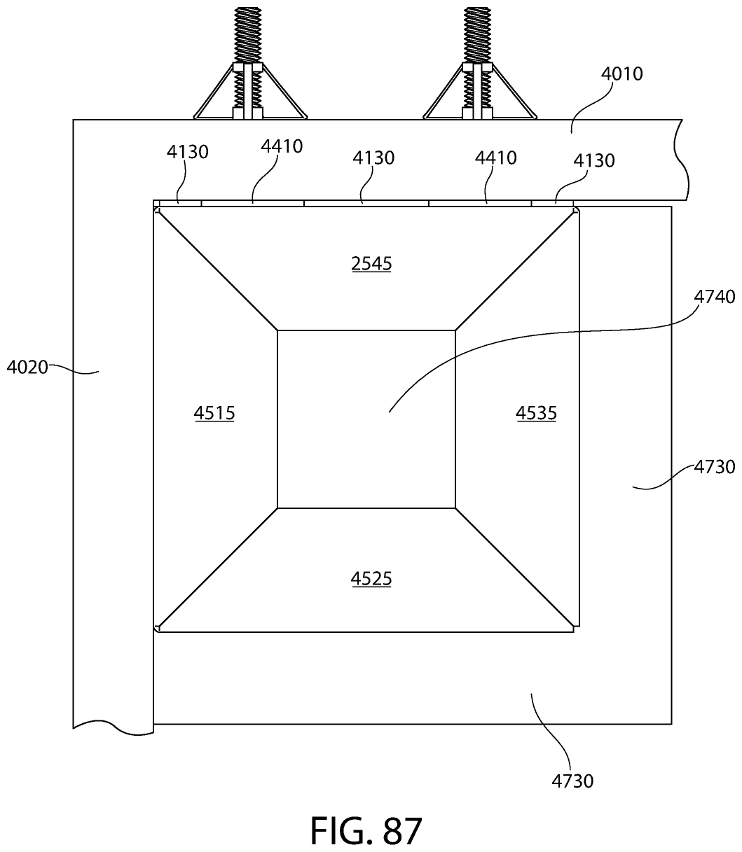

FIG. 85 is a side sectional view of shelf insert 4700 installed in support structure 4500. In this example, shelf insert 4700 has a groove 4745 that runs horizontally along the side that contacts side 4540 of support structure 4500. Groove 4745 is configured to accept the protruding heads 4210 of fasteners 4200 and can provide a locking feature that is not permanent. Shelf insert 4700 is, in this example, pressed into support structure 4500 until heads 4210 engage groove 4745, thereby locking shelf insert 4700 into place. Shelf insert 4700 can then be removed by pushing it upward to disengage heads 4210 from groove 4745. Access to the bottom of shelf insert 4700 is available through opening 4580 (see FIG. 87). In other examples, individual indentations are provided for each head 4210 instead of a single groove 4745 that receives all heads 4210. In other possible constructions, a non-locking shelf insert 4600 may be provided which includes a large single rear facing cavity 4713 (represented by dashed lines) formed in lower insert portion 4740 of the shelf insert for receiving the fastener heads 4210. Alternatively, two individual smaller individual cavities 4713 (i.e. one for each fastener head) may instead be provided. In yet other constructions, flat head fasteners 4200 may be used and the mounting holes 4560 in rear side 4540 of the support structure may be countersunk to eliminate the need for the rear cavities or groove where a self-locking shelf insert 4600 is not required.

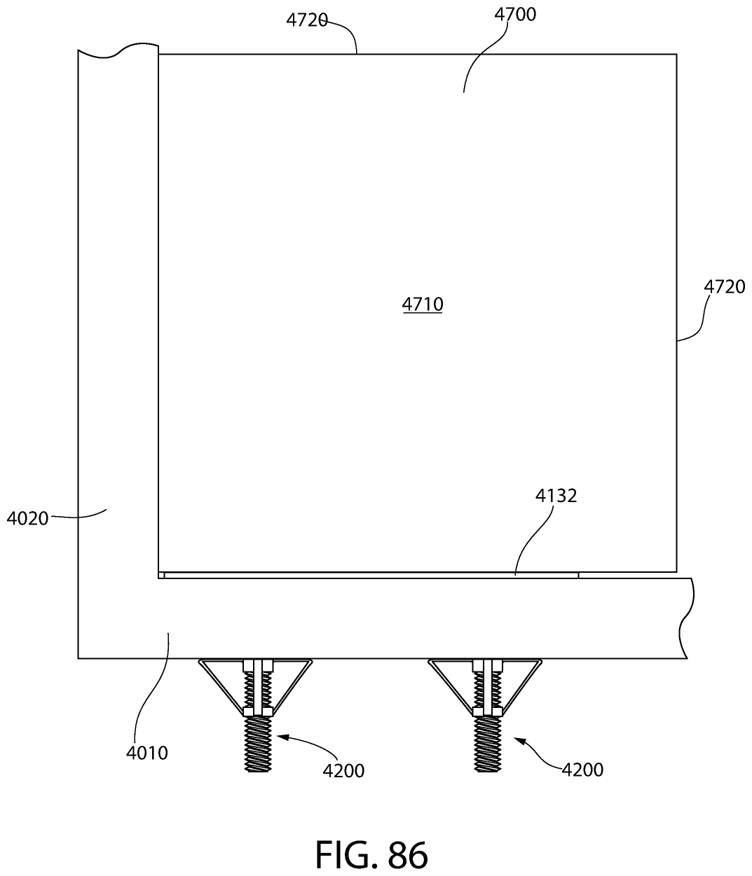

FIG. 86 is a top view of shelf insert 4700 in the installed position. FIG. 87 is a bottom view of shelf insert 4700 in the installed position. In FIG. 87, the bottom of shelf insert 4700 can be seen through opening 4580 and the underside 4730 of top surface 4710 can be seen extending beyond sides 4520 and 4530 of support structure 4500.

It bears noting that the lower insert portion 4740 may be formed of a stronger core material which is not esthetically pleasing while the visible upper portion 4709 is made of a different more esthetically pleasing material in appearance. In other embodiments, the upper and lower portions may be parts of a monolithic unitary structure formed of a single material.

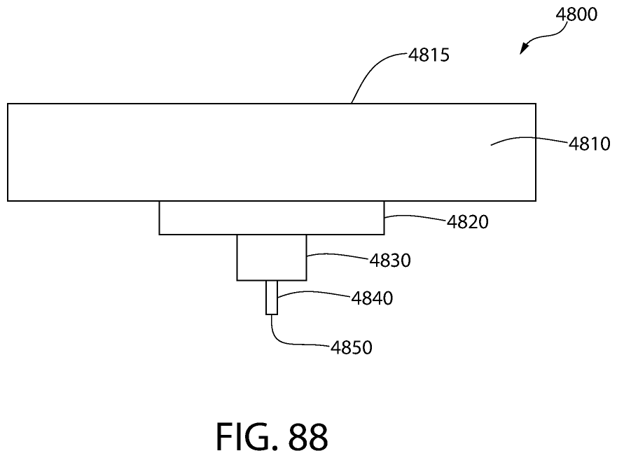

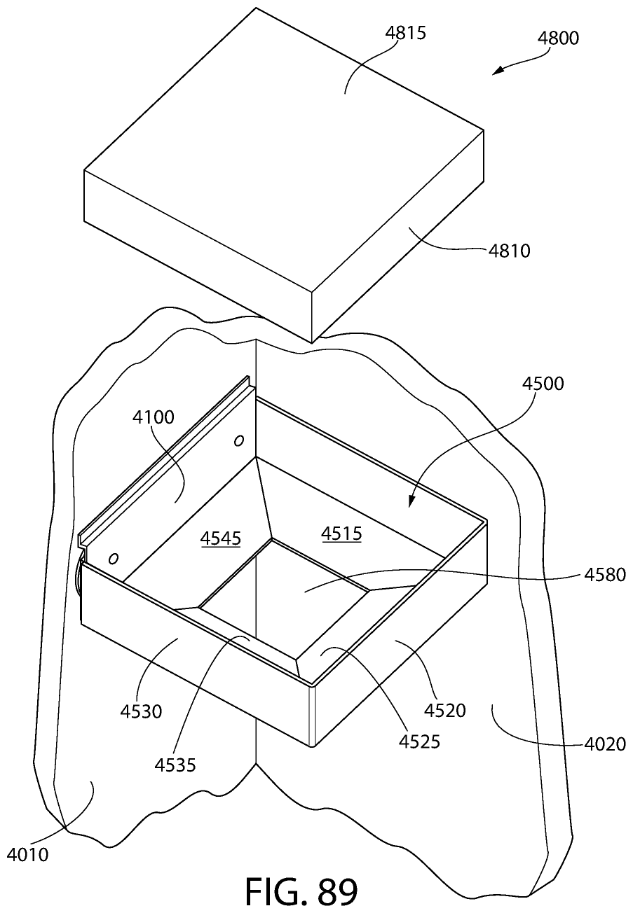

FIGS. 88-90 show an example of an accessory other than a shelf that can be install in support structure 4500. This example shows a soap dispenser 4800, but any accessory that can be supported by support structure 4500 can be substituted for soap dispenser 4800.

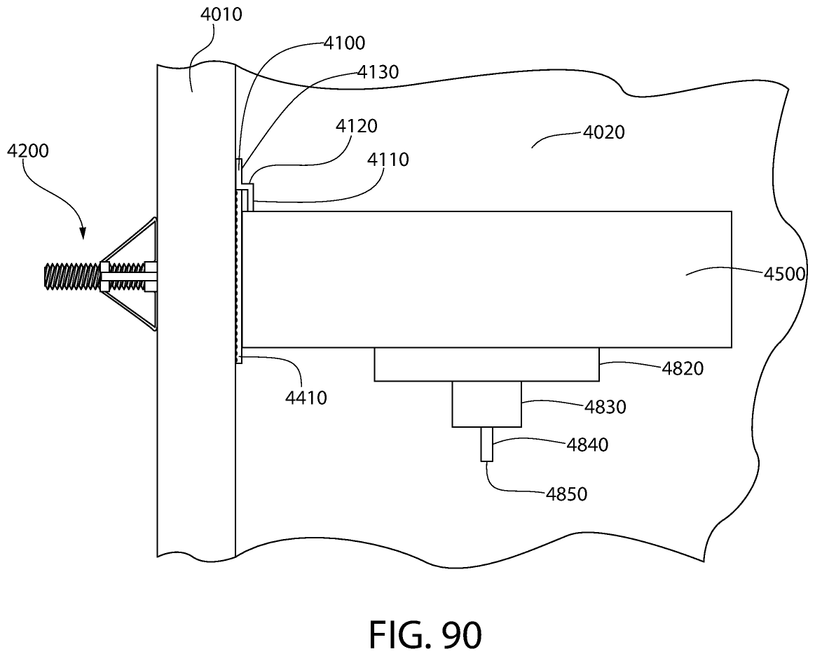

FIG. 88 shows soap dispenser 4800 having a reservoir 4810 that holds soap to be dispensed by soap dispenser 4800. In this example, reservoir 4810 fits completely inside of support structure 4500 such that an upper surface 4815 is flush with the upper edges of the sides of support structure 4500. A first extension 4820 extends down from reservoir 4810 and, when installed in support structure 4500, extends through opening 4580 (see FIG. 90). A second extension 4830 extends down from first extension 4820 and can house a pump that expels soap from soap from soap dispenser 4800. A distributing tube 4840 extends down from second extension 4830 and terminates with a nozzle opening 4850 through which soap is dispensed.

FIG. 90 shows soap dispenser 4800 in an installed position with first extension 4820, second extension 4830, and distributing tube 4840 extending out of opening 4580 and below support structure 4500.

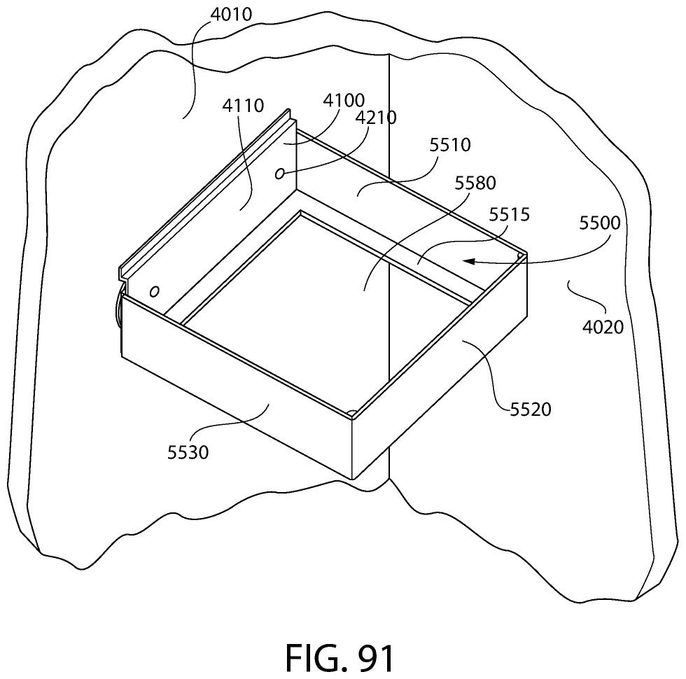

FIGS. 91-94 show an example of an alternate embodiment of the invention. In this example, support structure 5500 has four side elements or members 5510, 5520, 5530, 5540 (also referred to as “sides” for brevity). Unlike other examples that have four horizonal portions, this example has a single horizontal portion 5515 extending from all four sides 5510, 5520, 5530, 5540 toward a central opening 5580 of support structure 5500. In other examples, the four horizontal portions could have their adjacent edges attached to each by welding or some other means. In this example, the vertical edges between the adjacent ones of sides 5510, 5520, 5530, 5540 are attached to each other by welding or some other means. In other examples, the vertical edges of sides 5510, 5520, 5530, 5540 contact the vertical edges of the adjacent sides, but are not attached to those adjacent vertical edges. In other examples, the vertical edges of sides 5510, 5520, 5530, 5540 do not contact the vertical edges of the adjacent sides. In some examples, horizontal portion 5515 is solid such that no opening 5580 exists. In this example, side 5510 does not contact wall 4020. In other examples, side 5510 contacts wall 4020 but is not fastened to wall 4020. In other examples, side 5520 is fastened to wall 4020 in the same manner that side 5540 is fastened to wall 4010.

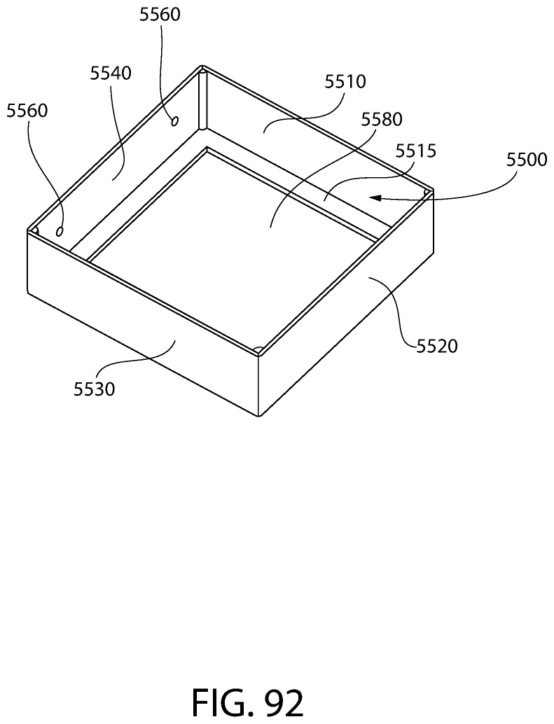

FIG. 92 shows support structure 5500 as having two holes 5560 in side 5540. Holes 5560 serve the same purpose as holes 4330 of shelf 4300 (FIG. 64). Due to the fabrication method used in this example, a continuous corner exists between side 5510 and horizontal portion 5515, between side 5520 and horizontal portion 5515, between side 5530 and horizontal portion 5515, and between side 5540 and horizontal portion 5515. In contrast, a joint exists between each of the adjacent edges of sides 5510, 5520, 5530, 5540 (explained further below).

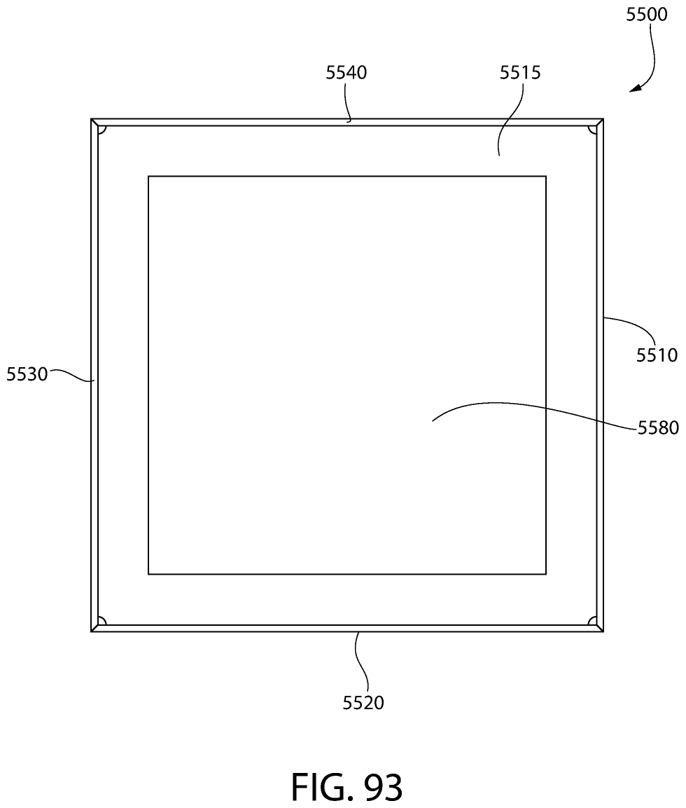

FIG. 93 is a top view of support structure 5500 and shows opening 5580 and the joints at each of the corners between sides 5510, 5520, 5530, 5540.

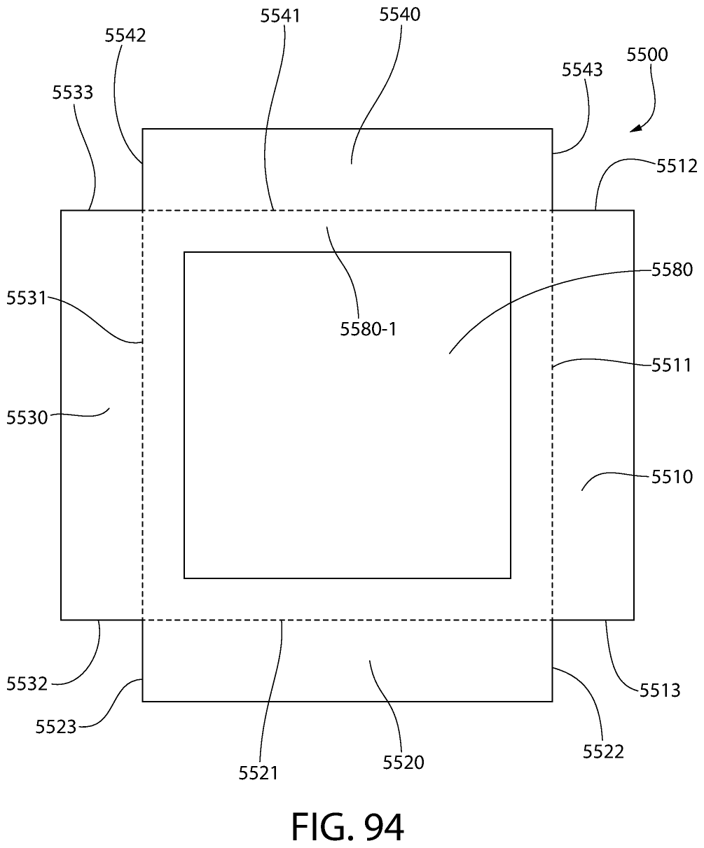

FIG. 94 is a plan view of the perimeter frame support structure 5500 prior to assembly. This view shows a flat piece of workpiece material or blank after being cut to shape, but before being folded/bent and, in some examples, welded. In this view, horizontal portion 5515 is shown surrounding central opening 5580 as is the case after assembly. However, sides 5510, 5520, 5530, 5540 are shown in the same plane as horizontal portion 5515 prior to bending. Side 5510 is bent at, in this example, 90 degrees along line 5511. Side 5520 is bent at, in this example, 90 degrees along line 5521. After sides 5510 and 5520 are bent into position, edge 5513 of side 5510 and edge 5522 of side 5520 come into contact with each other and, in this example, are welded together. Side 5530 is bent at, in this example, 90 degrees along line 5531. After sides 5520 and 5530 are bent into position, edge 5523 of side 5520 and edge 5532 of side 5530 come into contact with each other and, in this example, are welded together. Side 5540 is bent at, in this example, 90 degrees along line 5541. After sides 5530 and 5540 are bent into position, edge 5533 of side 5530 and edge 5542 of side 5540 come into contact with each other and, in this example, are welded together. After sides 5540 and 5510 are bent into position, edge 5543 of side 5540 and edge 5512 of side 5510 come into contact with each other and, in this example, are welded together. This assembly procedure results in the box-shaped support structure 5500 shown in FIG. 92. While welding is used in this example, other examples can use other joining methods. Still other examples do not join the edges of the sides, but instead rely on the strength of the material alone to maintain the desired shape. For example, a stainless steel or other materials of sufficient thickness can be used without welding the edges and still provide the required rigidity and strength. It bears noting that using the present workpiece to fabricate the perimeter frame may be more expedient and cost effective than the workpiece blank shown in FIGS. 76-77. For example, the rectilinear annular bottom horizontal portion 5580-1 of perimeter frame 5500 has a contiguous and continuous structure. This contrasts to the perimeter frame 4500 seen for example in FIG. 72 in which the horizontal portions is formed by multiple segments each associated with a vertical side portion of side elements 510-540 which create diagonal seams/joints between the horizontal portion, which are then optionally welded together alone the joints for rigidity.

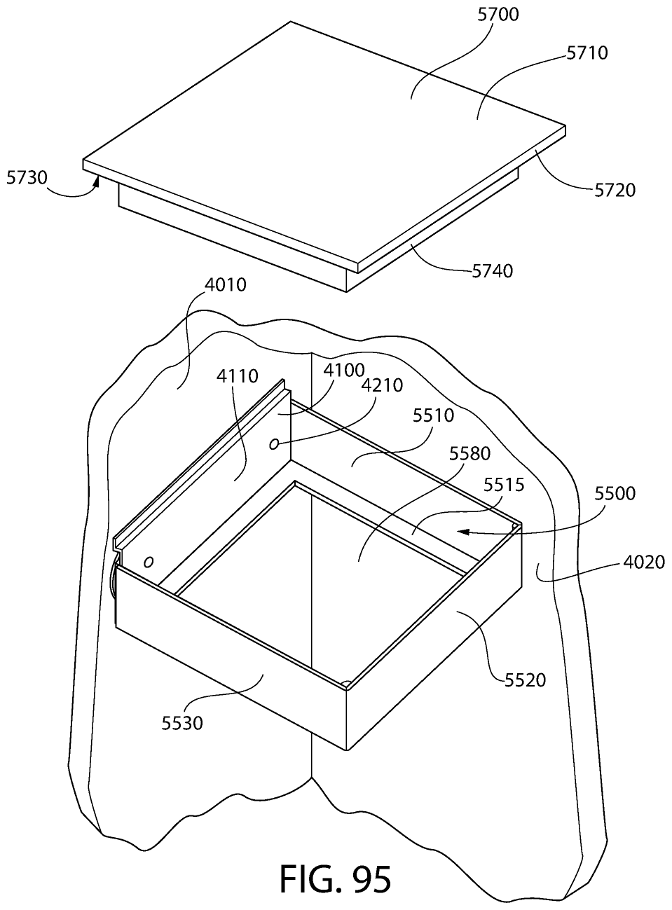

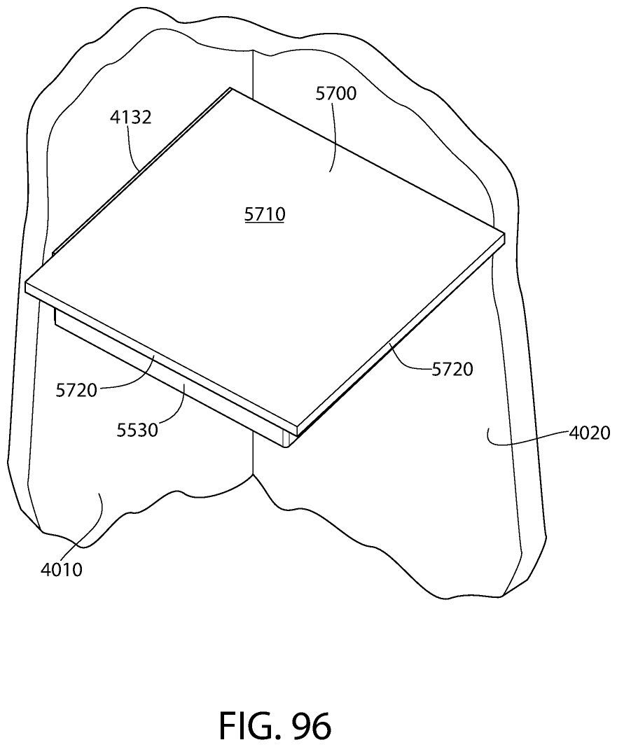

FIGS. 95 and 96 show an example of a shelf insert 5700 that can be used with support structure 5500. In this example, shelf insert 5700 has a top surface 5710 that extends beyond an insert portion 5740 such that an edge 5720 of shelf insert 5700 is visible. This is in contrast to shelf inserts which have a top that does not extend beyond its sides. Shelf insert 5700 is lowered into support structure 5500 until an under side 5730 of shelf insert 5700 contacts the upper edges of sides 5510, 5520, 5530, 5540. In some embodiments, this coincides with a bottom surface of insert portion 5740 contacting horizontal portion 5515 of support structure 5500. In some embodiments, only the bottom surface of insert portion 5540 contacts horizontal portion 5515 of support structure 5500, and underside 5730 does not contact the upper edges of sides 5510, 5120, 5530, 5540. In this position, in some embodiments, shelf insert 5700 rests on ledge 4120 of cover 4100 and top surface 5510 is flush with upper edge 4132 of cover 4100. The overhangs that are located above the upper edges of sides 5510, 5520, 5530 of support structure 5500 extend further from insert portion 4740 than does the overhang that is located above the upper edge of side 5540 of support structure 5500. This is because of cover 4100 preventing the overhang located above side 5540 from extending beyond a certain amount. In other examples, wall 4020 prevents the overhang that is located above the upper edge of side 5510 from extending more than the thickness of side 5510.

FIG. 96 shows shelf insert 5700 installed in support structure 5500. In this view, upper edge 4132 of cover 4100 is visible. In some embodiments, upper edge 4132 is flush with top surface 5710 of shelf insert 5700. In other embodiments, upper edge 4132 extends above top surface 5710. In other embodiments, upper edge 4132 and ledge 4120 of cover 4100 extend above top surface 5710. In some embodiments where upper edge 4132 and ledge 4120 extend above top surface 5710, underside 5730 of top surface 5710 rests on the upper edges of sides 5510, 5520, 5530 instead of, or in addition to, the bottom of shelf insert 5700 contacting horizontal portion 5515 of support structure 5500.

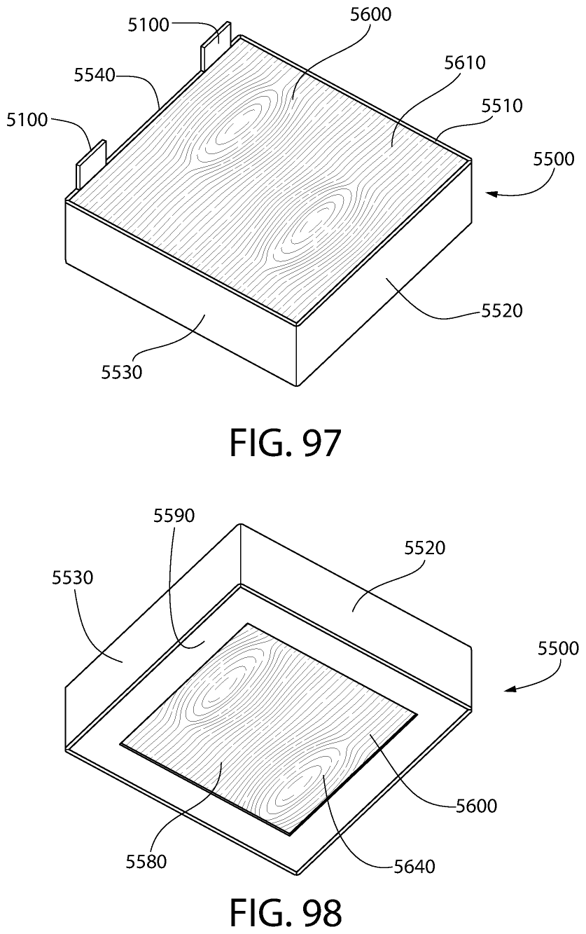

FIG. 97 shows shelf insert 5600 in an installed position in support structure 5500. Shelf insert 5600 has a top surface 5610. In this example, shelf insert 5600 slides into support structure 5500 with a slight interference fit between its sides and sides 5510, 5520, 5530, 5540 until top surface 5610 is flush with the upper edges of sides 5510, 5520, 5530, 5540. In other embodiments, top surface 5610 is above or below the upper edges of sides 5510, 5520, 5530, 5540. In some embodiments, shelf insert 5600 slides into support structure 5500 with no interference between its sides and sides 5510, 5520, 5530, 5540. FIG. 98 shows a bottom view of shelf insert 5600 and support structure 5500. In this view the bottom surface 5640 of shelf insert 5600 is visible through central opening 5580 of support structure 5500. In this example, bottom surface 1640 of shelf insert 5600 rests on horizontal portion 5515 and top surface 5610 is even with the upper edges of sides 5510, 5520, 5530, 5540. In the example shown in FIGS. 97 and 98 shelf insert 5600 is made of wood. In other examples, shelf inserts can be made of metal, plastic, composites, or any other appropriate material.

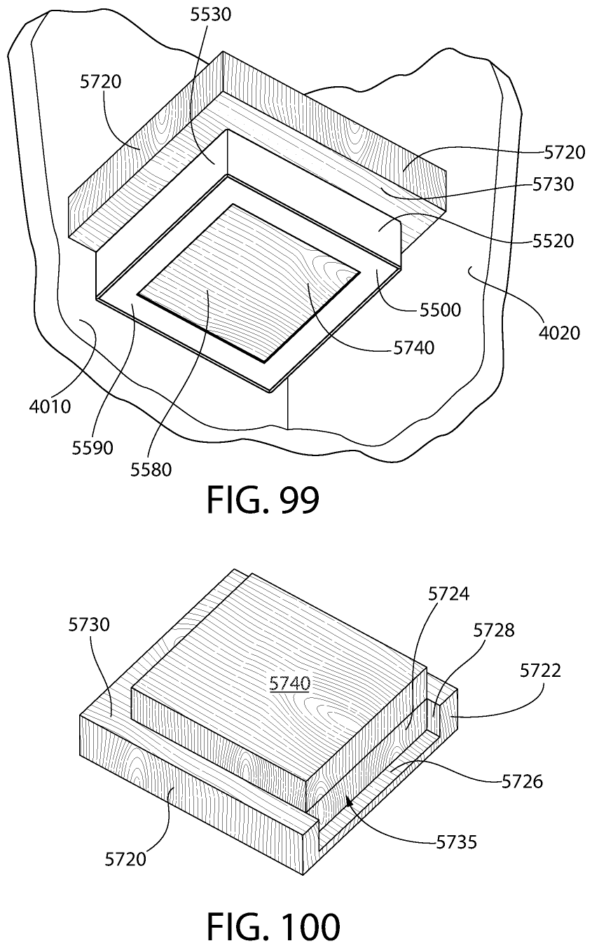

FIG. 99 shows shelf insert 5700 in an installed position in support structure 5500. Shelf insert 5700 has a bottom surface 5740. In this example, shelf insert 5700 slides into support structure 5500 with a slight interference fit between its sides and sides 5510, 5520, 5530, 5540 until bottom surface 5740 contacts and rests on horizontal portion 5515 of support structure 5500 and/or underside 5730 rests on the upper edges of sides 5510, 5520, 5530, 5540. In some embodiments, shelf insert 5700 slides into support structure 5500 with no interference between its sides and sides 5510, 5520, 5530, 5540. FIG. 100 shows a bottom view of shelf insert 5700 and support structure 5500. In this view the bottom surface 5740 of shelf insert 5700 is visible through central opening 5580 of support structure 5500. In the example shown in FIGS. 99 and 100 shelf insert 5700 is made of wood. In other examples, shelf inserts can be made of metal, plastic, composites, or any other appropriate material.

The example shown in FIGS. 99 and 100 has a recess 5735 in the rear side of shelf insert 5700 that is adjacent to, in this case, wall 4010. The following can also be applied to multiple sides of shelf insert 5700 if support structure 5500 is attached to multiple walls. Recess 5735 is provided to allow shelf insert 5700 to fit above and cover the attachment hardware used to attach support structure 5500 to the wall. This attachment hardware can include, for example, one or more covers 44100, fasteners 4200, and force-distributing plates 4410. In this example, recess 5735 is bounded by rear facing surface 5724, and opposing inward lateral surfaces 5726 and 5728. Surface 5724 of recess 5735 is coplanar with the adjacent side of the portion of shelf insert 5700 that sits inside of support structure 5500. In other embodiments, surface 5724 of recess 5735 is on a different plane than the adjacent side of the portion of shelf insert 5700 that sits inside of support structure 5500. The edge 5720 of shelf insert 5700 that is adjacent to the wall when installed is reduced in area by recess 5735 to a smaller surface 5722. In the example shown in FIGS. 99 and 100, shelf insert 5700 is shown as two parts. However, in other embodiments shelf insert 5700 is one piece, or more than two pieces. The dimensions of recess 5735 can be dictated by the size of the hardware that is used and needs to be covered.

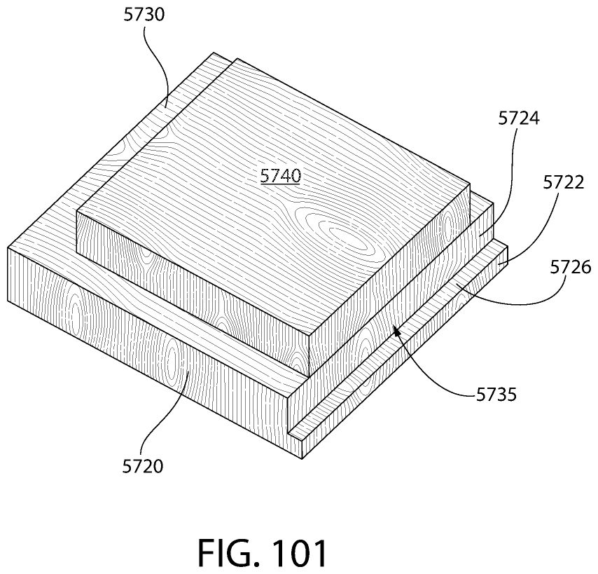

A slightly different embodiment of shelf insert 5700 is shown in FIG. 101. In this example, recess 5735 extends the entire width of shelf insert 5700. This embodiment might be easier to manufacture and does not contact the wall along the entire height of shelf insert 5700. This embodiment can be more universal due to its ability to fit over attachment hardware having a greater width than can the example shown in FIGS. 99 and 100. Surface 5724 of recess 5735 is coplanar with the adjacent side of the portion of shelf insert 5700 that sits inside of support structure 5500. In other embodiments, surface 5724 of recess 5735 is on a different plane than the adjacent side of the portion of shelf insert 5700 that sits inside of support structure 5500. The edge 5720 of shelf insert 5700 that is adjacent to the wall when installed is reduced in area by recess 5735 to a smaller surface 5722. In this example, shelf insert 5700 is shown as two parts. However, in other embodiments shelf insert 5700 is one piece, or more than two pieces. The dimensions of recess 5735 can be dictated by the size of the hardware that is used and needs to be covered.

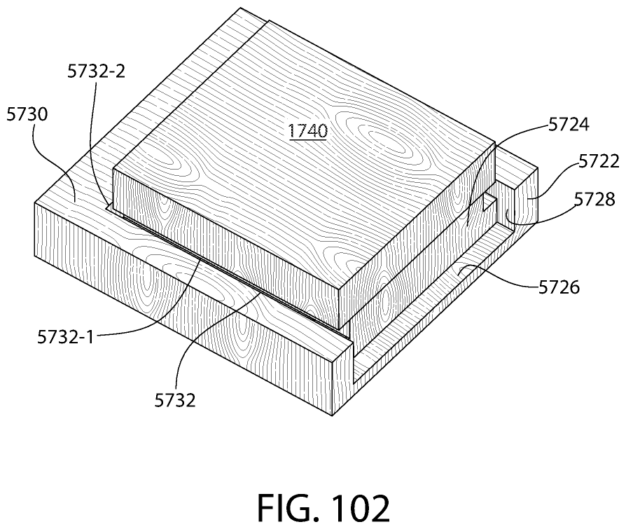

FIG. 102 shows an example of shelf insert 5700 that is similar to the example shown in FIG. 100. However, the example shown in FIG. 102 has a rectilinear groove 5732 formed in underside 5730 of shelf insert 5700 and extends around the portion of shelf insert 5700 that sits inside of perimeter frame support structure 5500. The groove 5732 is U-shaped including two parallel groove sections 5732-1 that extend front to back and perpendicularly to the rear side of shelf insert 5700 (and wall 4010 when the insert is mounted), and a transverse groove section 5732-2 extending right to left between the front ends of the groove sections 5732-1. The rear ends of groove sections 5732-1 may be open. Groove 5732 has a width just slightly larger than the thickness of the side elements 5510-5540 of the perimeter frame. Groove 5732 allows the top edges of side elements 5510, 5520, 5530 of support structure 5500 to extend upwards beyond underside 1730 and into groove 1732 so that the top edges of side elements 5510, 5520, 5530 of the perimeter frame cannot be seen. The lower portions of the perimeter frame (side elements 5510-5530) remain exposed and are visible. This can provide a different and cleaner look than other embodiments disclosed herein having the bottom edges of sides 5510, 5520, 5530 simply abut underside 5730 of the shelf insert 5700. This also can advantageously result in shelf insert 5700 being more positionally constrained by support structure 5500. Groove 5732 has a depth (measured between the top and bottom surfaces of shelf insert 5700) which is less than the height of the side elements 5510-5530 of the perimeter frame (support structure 5500).

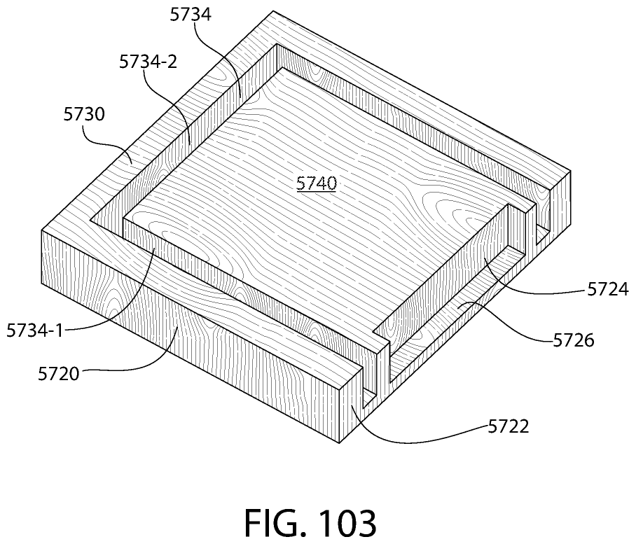

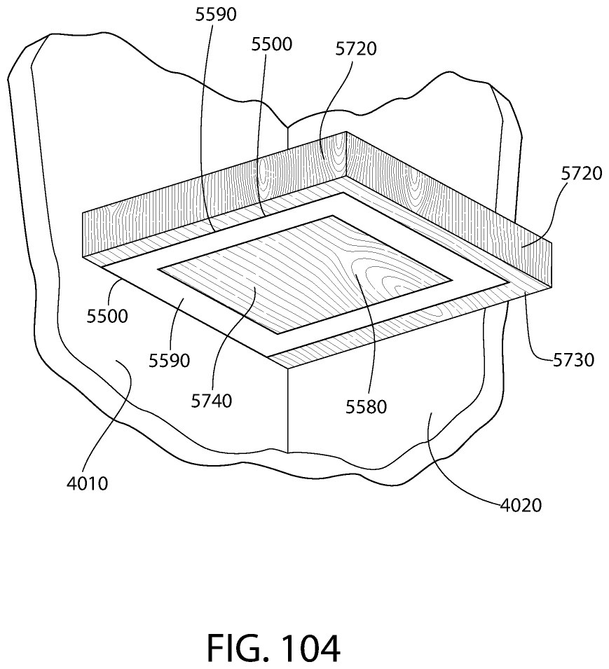

FIG. 103 shows an example of shelf insert 5700 that has a rectilinear channel 5734 formed in underside 5730 of shelf insert 5700. The channel 5734 is U-shaped including two parallel channel sections 5734-1 that extend front to back and perpendicularly to the rear side of shelf insert 5700 (and wall 4010 when the insert is mounted), and a transverse channel section 5734-2 extending right to left between the front ends of the channels sections 5734-1. The rear ends of groove sections 5732-1 may be open. In contrast to groove 5732 above, channel 5734 may have a width substantially larger than the thickness of the side elements 5510-5540 of the perimeter frame (e.g. 2 times or more). Channel 5734 has a depth (measured between the top and bottom surfaces of shelf insert 5700) which is at least coextensive with the height of the side elements 5510-5530 of the perimeter frame (support structure 500) which are completely inserted into the channel to fully conceal the sides of the frame from view. Channel 5734 allows the top edges of side elements 5510, 5520, 5530 of support structure 5500 to extend beyond underside 5730 and upwards into channel 5734 so that side elements 5510, 5520, 5530 are completely concealed. This can provide a shelf that shows the material of shelf insert 5700 on all three of sides 5720, and also completely hides the otherwise exposed sides 5510, 5520, 5530 of perimeter frame support structure 5500 which are fully inserted into the channel. FIG. 104 shows this embodiment from underneath. Advantageously, because the sides 5510-5530 of the perimeter frame support structure 500 are not visible, all side elements 5510-5540 can be formed of unfinished metal which reduces material and fabrication costs. In embodiments where the side elements of the perimeter frame may be visible (see, e.g. side elements 4410, 4420, and 4430 of support structure 4500 not mounted to wall 4010 seen in FIGS. 79 and 84, and side elements 5510, 5520, and 5530 seen in FIGS. 97-98), the side elements preferably have an external finished and esthetically pleasing appearance (e.g. polished/anodized metal, painted metal, etc.).

With either use of the groove 5732 or channel 5734 previously described herein in shelf insert 5700, the horizontal portions of the perimeter frame support structure 5500 will engage the underside of the central portion of the shelf insert circumscribed by the groove or channel to advantageously provide additional stability to the mount. In any of the embodiments with or without grooves/channels disclosed herein, threaded fasteners (e.g. screws) may be driven upwards through the horizontal portions of the perimeter frame support structures 4500 or 5500 (not visible to room occupants) into the underside of shelf inserts 4600, 4700, or 5700 for more semi-permanent fixation and stability. Any suitable type of screws may be used for this purpose. The horizontal portions of the perimeter frames may include fastener holes to facilitate this semi-permanent fixation of the shelf inserts to the frames.

It is noted that features of certain embodiments can be combined with other embodiments to create embodiments not specifically shown in any of the drawings. As a non-exclusive example, recess 5735 can be included in the embodiments shown in any of the drawings.

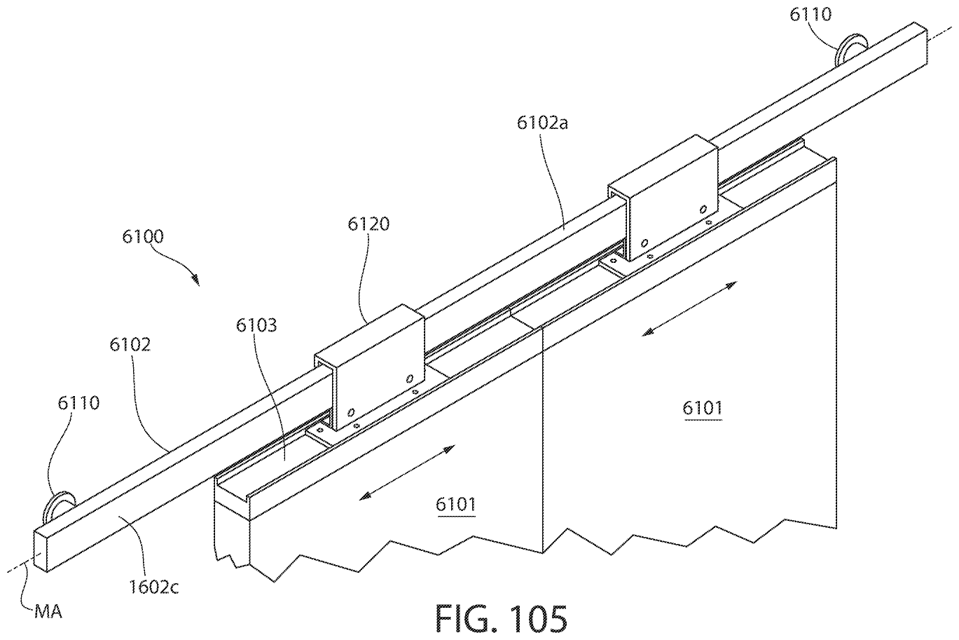

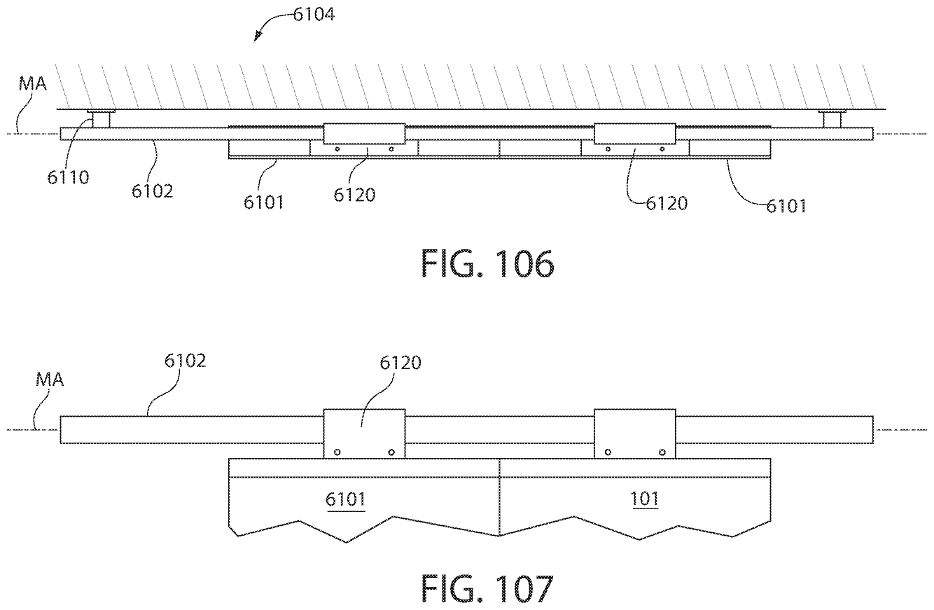

FIGS. 105-108 show one non-limiting embodiment of a sliding door mounting system 6100 according to the present disclosure, which in this case controls operation of a double door system. It will be appreciated that in other embodiments, the door mounting system may instead control operation of a single sliding door.

The door mounting system 6100 generally includes a support rail 6102, one or more wall mounts such as mounting standoffs 6110 for anchoring the support rail to a vertical support surface 6104 in the illustrated embodiment, and at least one door bracket 6120 for each of two doors 6101 which are configured for mounting to the top rail 6103 of the doors. Support rail 6102 provides a track for the sliding door 6101. The support rail 6102 has a body which is horizontally elongated in length and defines a horizontal longitudinal mounting axis MA of the door mounting system for convenience of reference. Mounting axis MA defines a direction or path of travel of sliding doors 6101. The support rail 6102 may have a rectilinear configuration in one embodiment as shown; however, other polygonal and non-polygonal shapes may be used. In the non-limiting illustrated embodiment, support rail 6102 has a rectangular prismatic configuration with a corresponding rectangular transverse cross section. Support rail 6102 may include a combination of planar or flat surfaces including a horizontal top surface 6102a, opposing horizontal bottom surface 6102b, vertical front surface 6102c, and opposite vertical rear surface 6102d as shown. The support rail 6102 may be hollow or solid in construction depending on the required weight of the door to be supported. A suitable metal such as without limitation steel (including stainless steel), aluminum, titanium, or others may be used for the support rail. The support rail has a length sufficient to accommodate the desired full range of motion for the double doors 6101 to provide a fully open position and access to and through the doorway.

The mounting standoffs 6110 each include a fixed end 6113 fixedly coupled to the rear surface 6102d of the support rail 6102 and an opposite free mounting end 114 configured for anchoring to a vertical support surface 104 such as a wall, beam, joist, stud, or any other structural support surface of the building structure. The standoffs 6100 extend perpendicularly from the support rail 6102 and space the rail horizontally/laterally apart from the support surface by a clearance distance. In one embodiment, at least two standoffs may be provided. Additional standoffs 6110 can be provided for added support depending on the weight of the door(s) 6101 and range of motion needed. The standoffs 6110 are arranged so as to not interference with the sliding action of the door. Each standoff 6110 may have an elongated body or shaft which may be cylindrical in one embodiment with circular cross section; however, other non-polygonal or polygonal shapes including rectilinear may be used. The standoffs 6110 may be hollow or solid in construction similarly to the support rail depending on the required weight of the door to be supported. The mounting end 6114 may comprise an enlarged mounting plate 6112 configured for anchoring to the wall or support surface 104 of the building structure. In one embodiment, the mounting plate 6112 may be dimensionally enlarged (e.g. diametrically in the present configuration) relative to the cylindrical shaft 6111 of the standoff 6110 for added support and attachment to the support surface 6104. The mounting plate 6112 may be oriented perpendicularly to the cylindrical shaft 6111 and can include holes for using threaded fasteners to anchor the standoff to the wall. Although a circular mounting plate is shown, other non-polygonal or polygonal shapes (e.g. hexagonal, octagonal, square, rectangular, etc.) may be used which need not match the cross-sectional shape of the shaft 6111. A suitable metal such as without limitation steel, aluminum, titanium, or others may be used for the standoff assemblies.

Although a door system comprising two sliding doors and support rail with two standoffs is shown, the same system may be used for mounting a single door which would comprises only one of the doors shown in FIG. 105 sufficient in width to fully cover and close the doorway. Regardless of the number of doors 6101 provided in the door system, each door may have an associated single or dual door brackets 6120 for mounting the door in a suspended sliding manner from the support rail depending on the weight and size of the door(s). In addition, it bears noting that the support rail 6102 may instead be mounted to a horizontal support surface such as a ceiling or other overhead structure in which case the standoffs 6110 are vertically oriented and attached to the top surface 6102a of the rail.

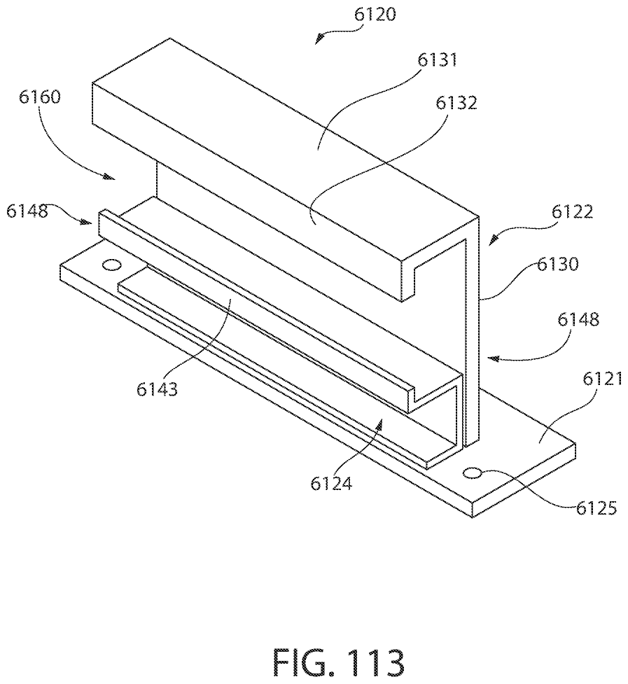

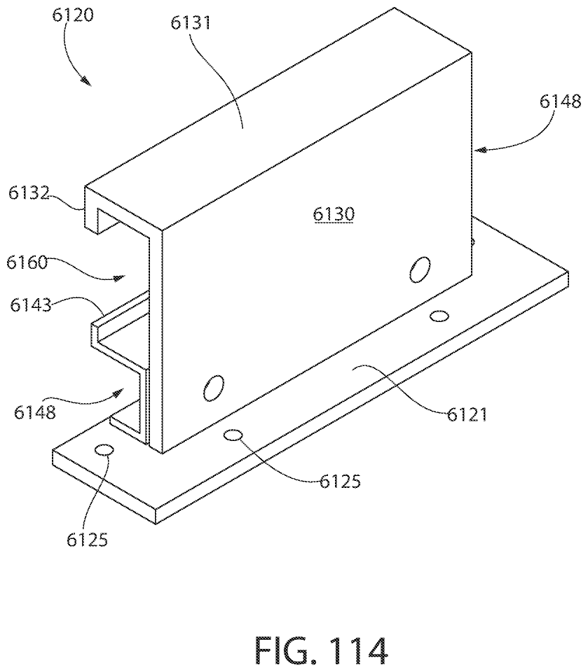

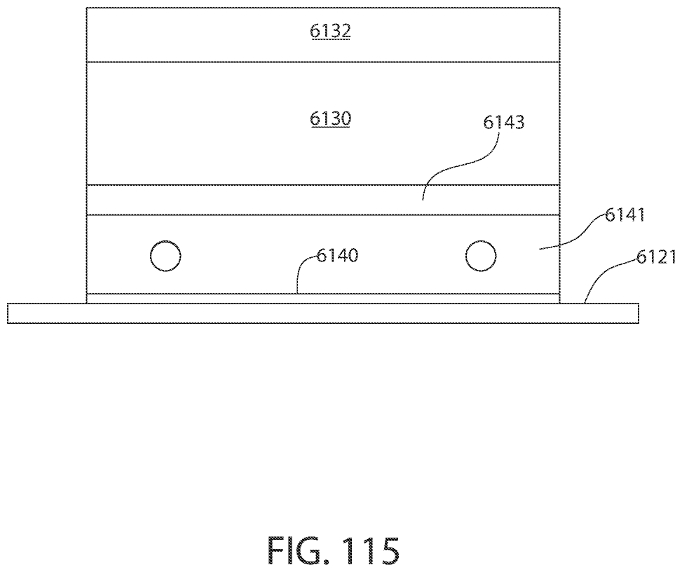

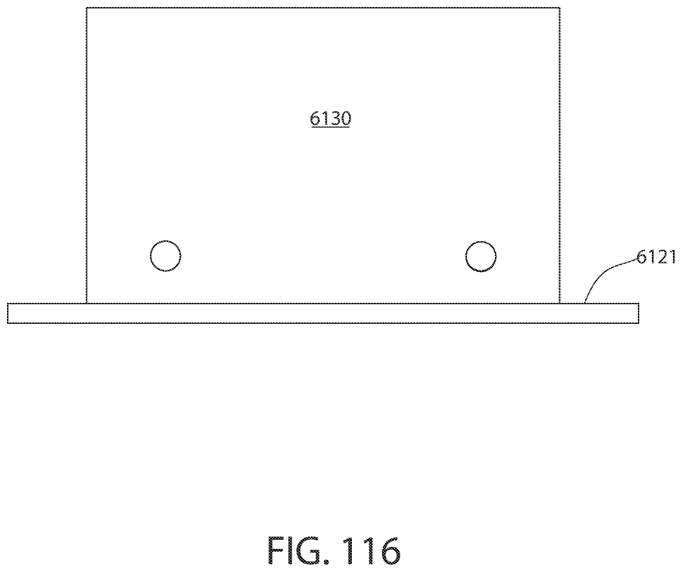

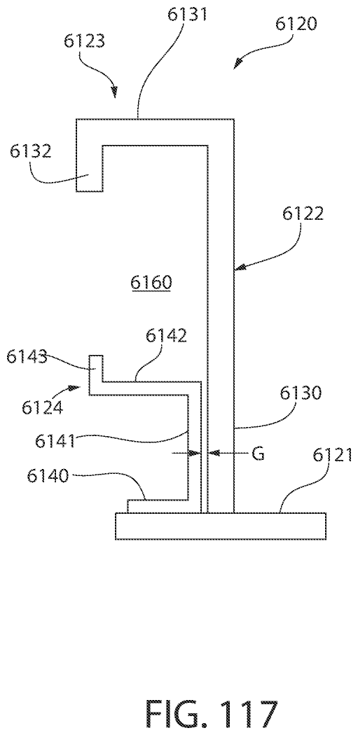

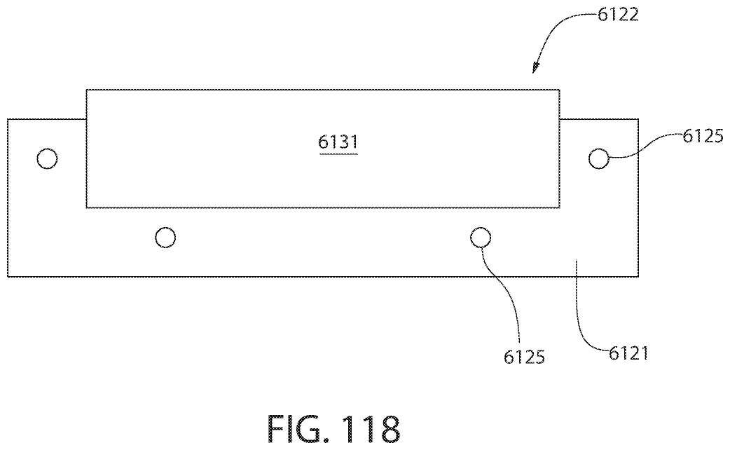

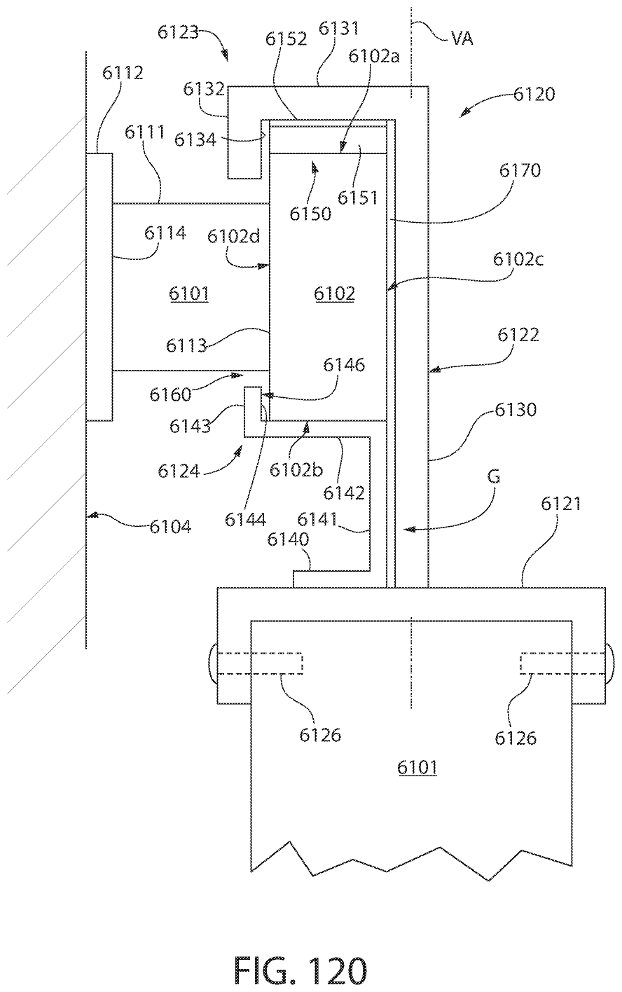

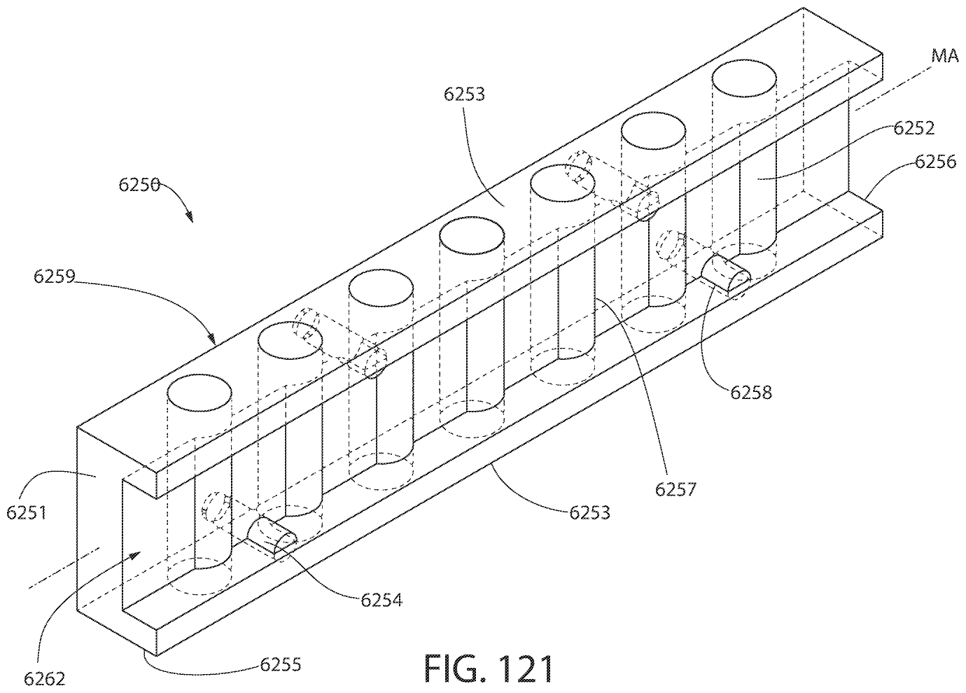

FIGS. 113-118 show the door brackets 6120 in additional detail. Referring generally to FIGS. 105-108 and 9-14, the door brackets 6120 which are attached to the doors are the movable component of the door mounting system 6100 while the support rail 6102 rigidly attached to the vertical support surface wall 6104 is the fixed component. The door brackets 6120 are thus slideably/rollingly mounted to support rail and include features which enhance smooth linear translation and operation of the door. In one embodiment, each door bracket 6120 may be a compound structure including a generally horizontal door mount base plate 6121, a hanger 6122 having a recurvant hooked end 6123 for engaging the support rail, and an anti-sway clip 6124. The anti-sway clip 6124 and hanger 6122 may each be separately attached to the base plate 6121 as shown. The base plate 6121 is configured for mounting to the top rail 6103 of the door(s) 6101. Other than the top rail 6103 which preferably is solid in construction, the remainder of the door beneath this rails may be substantially hollow or solid. In the illustrated embodiment, the base plate 6121 may comprise a flat horizontal metal plate which is configured for attaching to the top rail of the door. A plurality of fastener holes 6125 may be provided in the base plate for securing the mounting bracket 6120 to the door 6101 with threaded fasteners 6126. For aesthetics, a channel 6127 may optionally be routed or otherwise formed in the top rail 6103 of the door 6101 so that the base plate 6121 is recessed and not visible to the user in some embodiments. In other possible embodiments, the base plate 6121 may be shaped as a clevis having an inverted U-shape which slips over the top rail of the door with parallel portions or arms of the clevis engaging the front and rear surfaces of the door via fasteners (see, e.g. FIG. 120). The shape of the base plate 6121 and method of attachment to the top rail 6103 of door 6101 is not limiting of the invention. Any type of door may be used with the door bracket, including for example without limitation wooden doors, composite doors, metal doors, glass doors with metal or wooden top rails for mounting the door bracket, or other.

The hook-shaped hanger 6122 of door bracket 6120 may generally be considered to have a substantially inverted J-shaped configuration in one embodiment. Hanger 6122 includes a vertical front wall section 6130 attached to the base plate 6121 and extending upwards therefrom, a horizontal top wall section 6131 extending perpendicularly and laterally therefrom, and a downward turned vertical rear first flange wall section 6132 extending perpendicular and downwardly therefrom. In one embodiment, the vertical wall section 6130 of hanger 6122 may be centered on the base plate 6121. The centerline of wall section 6130 defines a vertical axis VA of the mounting bracket 6120, which is transversely and perpendicularly oriented to the longitudinal mounting axis MA of the support rail 6102. The vertical axis may be laterally offset from the mounting axis. The hanger wall sections 6130-6132 may be formed as integral parts of a unitary monolithic metal plate-like structure which is cast, extruded, forged, machined, and/or otherwise formed into the configuration shown. The base plate 6121 may be integrally formed with and as part of the monolithic hanger 6122 in some embodiments. In other embodiments, the hanger 6122 and base plate 6121 assembly may have a welded construction wherein some or all of the hanger wall sections are welded together to form an integral construction.

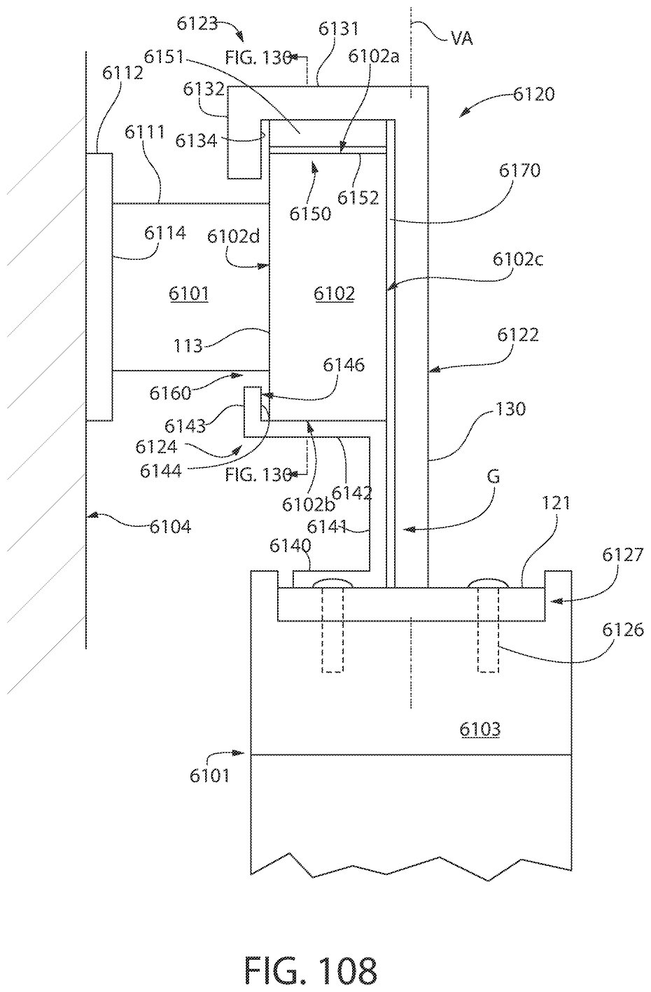

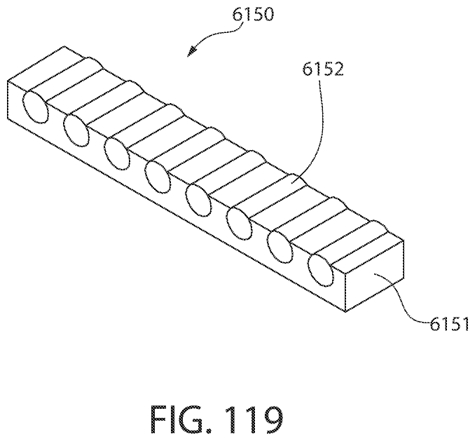

The downward turned rear first flange wall section 6132 of the hanger 6122 has a shorter vertical height than the vertical wall section 6130. The height vertical section added to the thickness of the base plate 6121 defines a height of the door bracket 6120. The first flange wall section 132 is spaced horizontally/laterally apart from and parallel to the vertical wall section 130 and defines downwardly open interior upper recess 6134 beneath the top wall section 6131 for receiving the upper portion of the support rail 102 and a flat linear needle roller bearing 150 assembly (see, e.g. FIGS. 108 and 119), as further described herein.

The anti-sway clip 6124 may generally be considered to have a substantially C-shaped configuration in one embodiment. The anti-sway clip includes a horizontal bottom wall section 6140 attached to the base plate 6121 of the door bracket 6120, a vertical wall section 6141 extending perpendicularly and upwards therefrom, a top wall section 6142 extending perpendicularly and horizontally/laterally therefrom, and an upward turned second flange wall section 6143 extending perpendicularly upwardly therefrom. Similarly to the hanger 6122, the wall sections 6140-6143 of the anti-sway clip 6124 may be formed as integral parts of a unitary monolithic metal plate structure which is cast, extruded, forged, machined, and/or otherwise formed into the configuration shown. The upward turned second flange wall section 143 may have a shorter vertical height than the vertical wall section 141 of the anti-sway clip. The second flange wall section 6143 is spaced horizontally/laterally apart from the vertical wall section 141 and defines an interior lower recess 6144 above the bottom wall section for receiving the lower portion and bottom wall of the support rail (see, e.g. FIG. 108).

As shown, in one embodiment the anti-sway clip 6124 may be shorter in height than the hook-shaped hanger 6122 and/or have a horizontal/longitudinal length which is coextensive to the length of hanger. The base plate 6121 of the hanger may have the same or a greater length than the hanger 6122 and anti-sway clip 6124 to provide a larger purchase area for door fasteners 6126.

The hanger 6122 and anti-sway clip 6124 collectively define a rearwardly open horizontal extending cavity or channel 6160 configured for slideably receiving the support rail 6102 therein. The rear opening of the channel 6160 has a height defined between the first and second flange wall sections 6132, 6143 of the hanger and anti-sway clip respectively which is smaller than the height of the support rail 6102 as shown in FIG. 105. This prevents the support rail 6102 from being laterally/horizontally withdrawn from the channel 6160 in a direction transverse to the longitudinal mounting axis MA of the mounting assembly and captures the support rail in the channel. During assembly of the door mounting system 6100, the support rail 6102 may be inserted in a direction parallel to the horizontal/longitudinal mounting axis MA into the channel 6160 through one of the two open ends 6148 of the bracket 6120.

Advantageously, the second flange wall 6143 of the anti-sway clip 6124 prevents the door 101 from moving or swaying/swinging rearwards in a plane transverse to the sliding direction of the door and longitudinal mounting axis MA if inadvertently pushed against by a user. Flange wall 6143 of anti-sway clip 6124 defines a stop surface 6146 facing inwards towards channel 6160. Stop surface 6146 is arranged to engage the rear surface 6102d of the support rail 6102 if the user inadvertently pushes door 6101 in an outward forward direction away from the vertical support surface 6104 (e.g. wall) in the plane transverse to the mounting axis MA. This arrests undesired swaying motion of the door 6101 and prevents damage to the vertical support surface such as a wall behind the door when the door 6101 is in a partially or fully open position, or edges of the adjacent doorway when in a closed position. It bears noting that the combination of the hanger 6122 and anti-sway clip 6124 of the door bracket 6120 via the first and second flange wall sections 6132, 6143 provide fully guided motion of the door 6101 along the support rail 6102 without the need for any additional or separate type of guide elements which are not part of the door bracket 6120.

In one embodiment, the vertical wall section 6141 of the anti-sway clip 6124 may be spaced horizontally/laterally apart from the corresponding vertical wall section 6130 of the hanger 6122, thereby forming a gap G therebetween (see, e.g. FIG. 108). A nylon gasket 6170, which may comprise a sheet of nylon in one embodiment, may be inserted in the gap to abuttingly engage the front wall of the support rail. The nylon gasket 6170 provides a low friction surface arranged to slideably engage the vertical front surface 6102c of the support rail 6102 when the bracket is slid along the support rail to open/close the door. In the event the user happens to push inwardly and rearwardly on the door 6101 towards the vertical support surface 6104 (e.g. wall) when sliding the door thereby applying a rearward force acting in a plane transverse to the mounting axis MA of the support rail, nylon gasket 6170 on hanger 6122 will engage the front surface 6102c of stationary support rail 6102 ensuring smooth and quiet operation of the door. The nylon gasket 6170 may extend for the full vertical height of the channel 6160 in the mounting bracket in one embodiment. In some embodiments, the nylon gasket 6170 may further extend along the top and first flange walls sections 6131, 6132 of the hanger 6122 within the upper recess 6134. The nylon gasket 6170 may be secured to the vertical wall section 6130 of hanger 6122 by any suitable means such for example adhesives, fasteners, press or frictional fit, clips, fasteners, or other measures. In other possible embodiments, the nylon gasket and gap may be omitted. In yet other embodiments, a felt pad may be substituted for the nylon gasket.

The door bracket 6120 and its foregoing components may be formed of a suitable metal with sufficient thickness and strength to support the weight of the door in a rigid manner without undue deformation or deflection. The door bracket may be formed of steel (including stainless steel), aluminum, titanium, or other metals. When the door mounting system will be used in environments exposed to moisture, the support rail 6102, standoffs 6110, and door bracket 6120 may preferably be constructed of a corrosion resistant material such as without limitation stainless steel or others.

Depending on the width and weight of the door to be hung from the support rail 6102, the door brackets 6120 may have a length which is sufficient to allow a single bracket to be used for each door provided. In other embodiments, preferably two or more door brackets may be used for each door as needed.

The foregoing flat linear needle roller bearing 6150 is disposed at an interface between the support rail 6102 and the hanger 6122 of door bracket 6120. In one embodiment, the roller bearing 6150 may be mounted within the horizontally-extending channel 6160 of the door bracket 6120 on the underside of the top wall section 6131 of the hanger 6122 as shown in FIG. 105. Accordingly, the needle roller bearing 6150 is integrated into the door bracket 6120 and visually concealed for both aesthetics and to avoid dust/debris accumulation which might impede operation of the rollers. The roller bearing 6150 provides a combination of sliding and rolling action of the door bracket 6120 along the support rail 6102 for smooth operation of the door.

Linear needle roller bearings are well known and commercially available from numerous sources. FIG. 119 schematically depicts the components of a typical needle roller bearing usable with the present door mounting system. The roller bearing 6150 generally includes a plurality of cylindrical radial needle rollers 6152 having a low profile which are mounted in linear horizontal spaced apart relationship in an axially elongated cage strip 6151 (e.g. base retainer). The needle rollers 6152 are each mounted in roller pockets formed in the cage strip 6151 in a manner which allows the rollers to rotate relative to the cage strip. The cage strip 6151 has a straight and relatively flat and somewhat thin configuration. The case strip may preferably be formed of plastic (e.g. nylon, etc.) in one embodiment, or alternatively metal in other embodiments. The needle rollers 6152 may preferably be made of a strong plastic (e.g. polypropylene, etc.) in one embodiment with a hardness capable to withstand rolling engagement with metal support rail and support the weight of the door without substantial deformation which adversely affects the ability of the rollers to rotate in the cage strip. In one embodiment, both the cage strip 6151 and rollers 6152 may be plastic with the hardness of the rollers being preferably harder than the cage strip. Other possible embodiments may use metal needle rollers with metal or plastic cage strips.

In one non-limiting example construction, the cage strip 6151 may have a thickness less than 0.5 inches and the needle rollers 6152 may have a diameter less than the cage strip. In one embodiment, the cage strip (base retainer) may be about 0.375 inches thick and the needle rollers may be about 0.25 inches in diameter. Other sizes/dimensions may of course be used. The cage strip and rollers are constructed to withstand compressive forces transmitted thereon by the horizontal top wall section 6131 of the hook member 6122 of the door bracket created by the weight of the door suspended from the bracket. In operation, the weight of the door is transmitted from the hanger 6122 through the needle roller bearing 6150 to the top surface 6102a of the support rail (see, e.g. FIG. 108).

The needle roller bearing 6150 when be mounted to the underside of the top wall section 6131 of the hanger within upper recess 6134 is oriented with the rollers 6152 facing downwards to engage the top surface of the support rail 6102 in the position shown in FIG. 108. Any suitable means may be used for attaching the cage strip 6151 of the roller bearing to the hanger 6122, such as for example without limitation adhesives, retaining clips, tabs, rails, etc. The manner of mounting used is not limiting of the invention. Mounting the needle roller bearing 6150 on the moving door bracket 6120 inside the channel 6160 of the hanger 6122 advantageously minimizes the length of the roller bearing needed to reduce costs. In one embodiment, needle roller bearing 6150 may have a length substantially coextensive with the horizontal length of the door bracket 6120.

Notably, the needle roller bearing 6150 overcomes the high momentum “runaway” door problem encountered with prior suspended sliding door mounting systems noted above. In lieu of large diameter pulley or other style wheels used in the past, use of the present roller bearing 6150 creates less momentum when the door is moved between the open and closed positions. This is attributable to the fact that the multiplicity of needle rollers 6152 provided for the roller bearing each have a substantially smaller diameter (e.g. 0.25 inches diameter) than comparable large prior pulley style wheels previously used which thereby creates less angular momentum than large diameter wheels created by sliding the door open or closed. Typically, one or two significantly larger wheels have been provided heretofore to support the weight of the door in rolling manner. In short, the needle roller bearing 6150 advantageously generates less momentum and linear velocity of the door 6101 itself than prior wheeled barn-style door mounting approaches to avoid damaging the door mounting system hardware at the ends of the track and/or walls adjacent to the track.

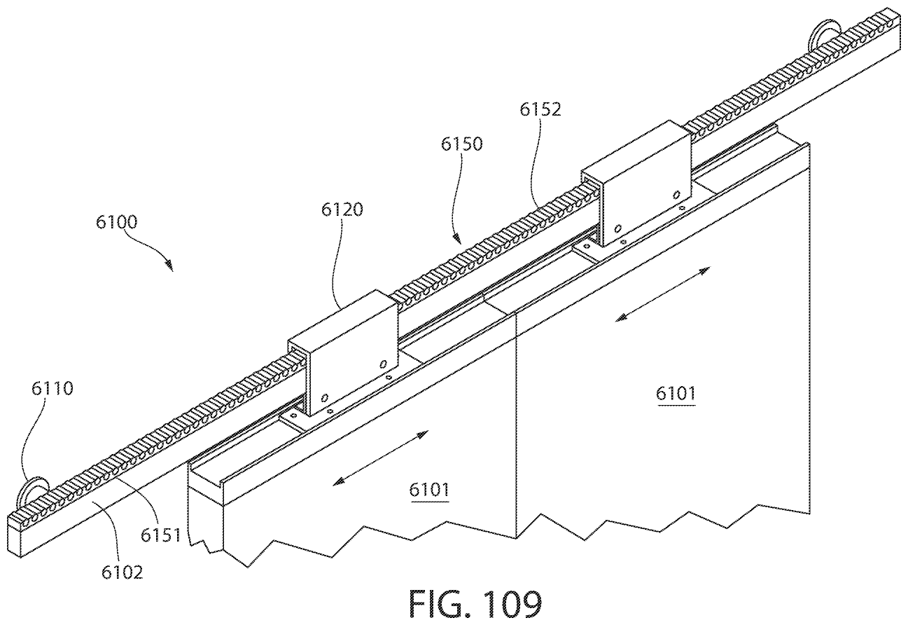

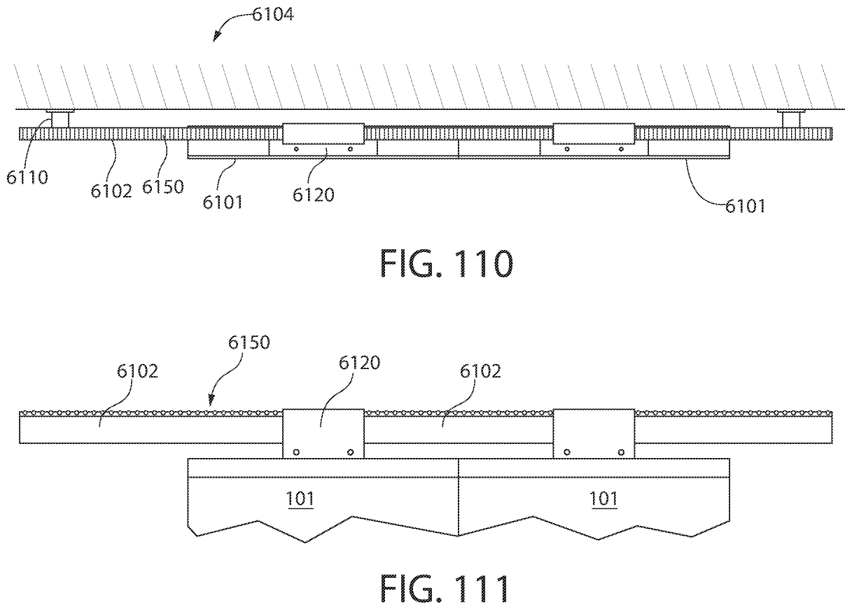

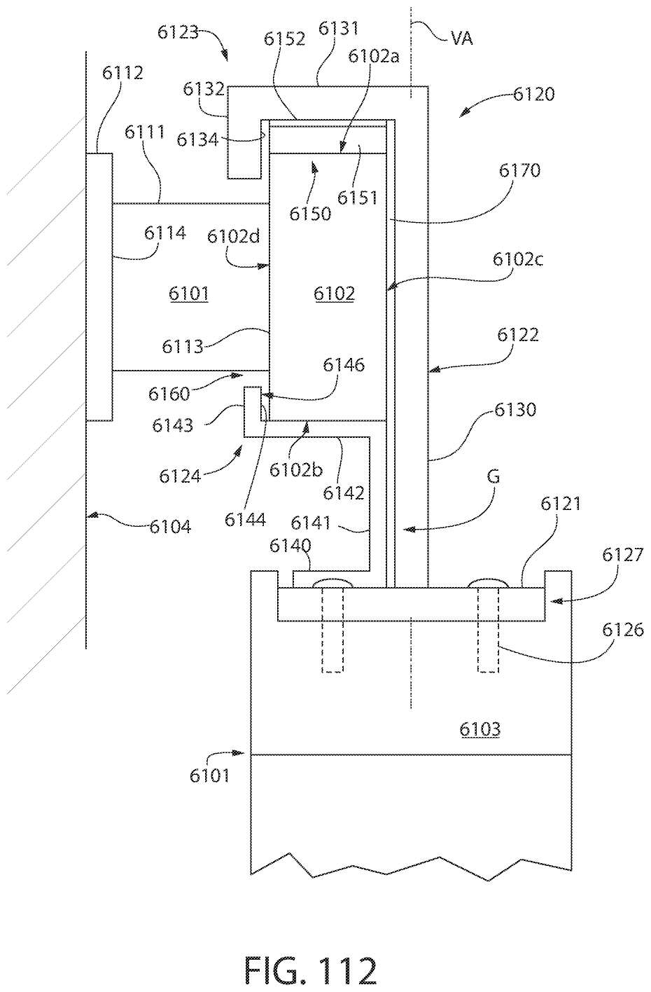

In other possible alternative embodiments, the needle roller bearing 6150 may instead be mounted to the top surface 6102a of the support rail 6102 in the position shown in FIGS. 109-112. The roller bearing 6150 is oriented in this alternative arrangement with needle rollers 6152 facing upwards to engage the hanger 6106 (specifically, the underside of its horizontal top wall section 6131). In such a configuration, the cage strip 6151 of the roller bearing may have a length extending for at least a majority of, or substantially the entire length of the support rail 6102 as shown. Any suitable means may be used for attaching the cage strip 6151 of the roller bearing 6150 to the support rail 6102, such as for example without limitation adhesives, retaining clips, tabs, rails, etc. In one embodiment, a horizontally-extending channel (not shown but similar to channel 6127 routed in the top of door 6101 seen in FIG. 108) may be routed into the top of the support rail 6102 to at least partially recess the roller bearing 6150 in the rail such that the needle rollers 6152 still protrude upwards beyond the top of the support rail to rollingly engage the hanger 6122 (see, e.g. FIG. 112).

A method for using a door mounting system for sliding translation of the door 6101 will now be briefly described. In one embodiment, the method may include: providing components of the door mounting system 6100 including a longitudinally elongated support rail 6102 defining a mounting axis MA, a pair of elongated wall mounts 6110 rigidly attached to the support rail, a door bracket 6120 including an opposing pair of open ends 6148 and a rearwardly open channel 6160 extending between the ends, and a linear roller bearing 6150 disposed inside the channel; attaching the door bracket to a door; anchoring the support rail to a vertical support surface of a building; lifting the door with attached door bracket; inserting the support rail through the open ends of the door bracket into the channel; engaging the linear roller bearing with a top surface of the support rail; and sliding the door in one of two direction on the support rail. The method may further include the door bracket further including an anti-sway clip; applying a lateral transverse force against the hung door; and engaging a stop surface of the anti-sway clip with the support rail to arrest motion of the door in a plane transverse to the mounting axis. Variations in steps and sequence of the foregoing method are possible.

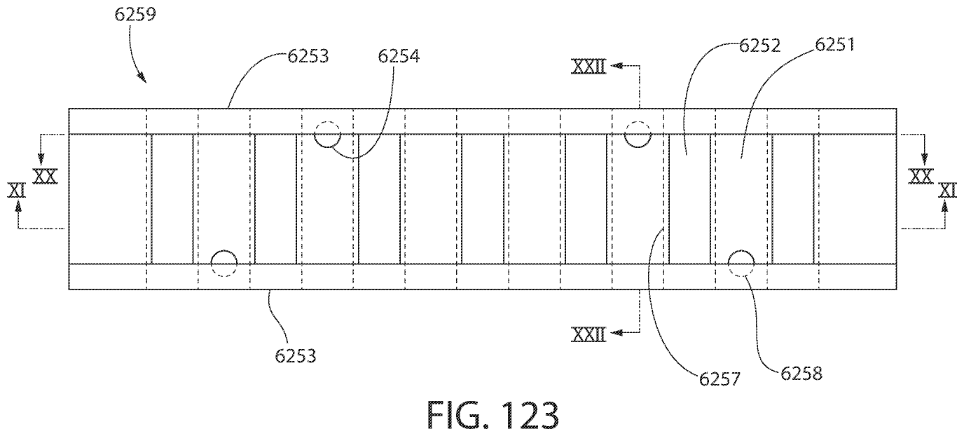

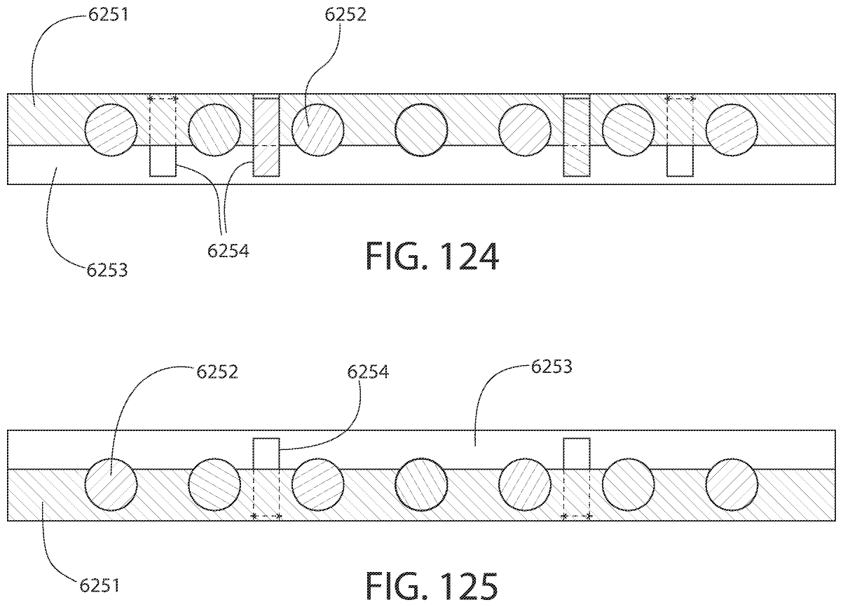

FIGS. 121-128 depict an alternative embodiment of a customized and modified linear roller bearing 6250 usable in generally a similar manner to roller bearing 6150 previously described herein. Roller bearing 6250 may be mounted within the horizontally-extending channel 6160 of the door bracket 6120 on the underside of the top wall section 6131 of the hanger 6122 as shown in FIG. 121. This is a similar use and mounting arrangement to previous roller bearing 6150 shown in FIG. 108.

Whereas roller bearing 6150 was a generally flat bearing comprising a plurality of needle rollers 6152 arranged in a cage strip 6151 extending linearly in a single horizontal direction or plane, roller bearing 6250 on the other hand includes a multi-directional cage strip. As seen in FIG. 108, roller bearing 6150 when mounted within the horizontally-extending channel 6160 of the door bracket 6120 is positioned and operable to receive the vertical dead weight load or forces of the door 6101 acting in a vertical direction. These forces are transmitted by the bearing to the support rail 6102. By contrast, roller bearing 6250 is configured to absorb both vertical and laterally/horizontally acting loads/forces by virtue of its two-way load bearing design, as described below.

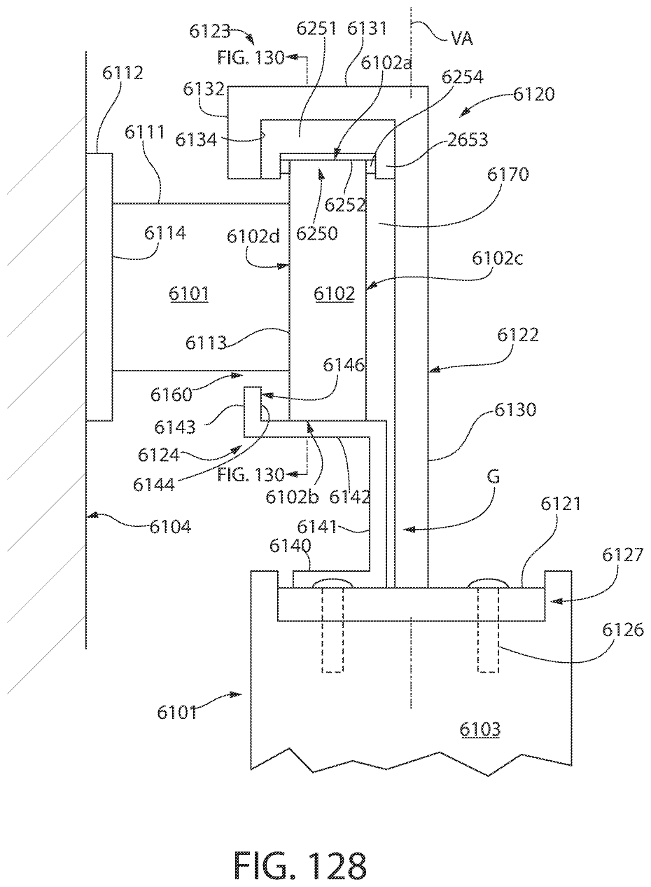

Roller bearing 6250 has a generally elongated U-shaped body which extends axially along mounting axis MA when mounted in door bracket 6120 between opposing ends 6255, 6256. The roller bearing 6250 comprises a cage strip 6259 including a horizontal top wall 6251 and opposing vertical sidewalls 6253 projecting downwards therefrom. Sidewalls 6253 are horizontally/laterally spaced apart defining a downwardly open recess 6262 configured for receiving the top portion of door bracket 6120 therein as shown in FIG. 128. In one embodiment, sidewalls 6253 are arranged perpendicularly to top wall 6251.

A plurality of cylindrical top needle rollers 6252 having a low profile are mounted in linear horizontal spaced apart relationship in the elongated horizontal wall 6251 of the cage strip 6259 (similar to cage strip 6151 and needle rollers 6152 of roller bearing 6150). Needle rollers 6252 are horizontally oriented.

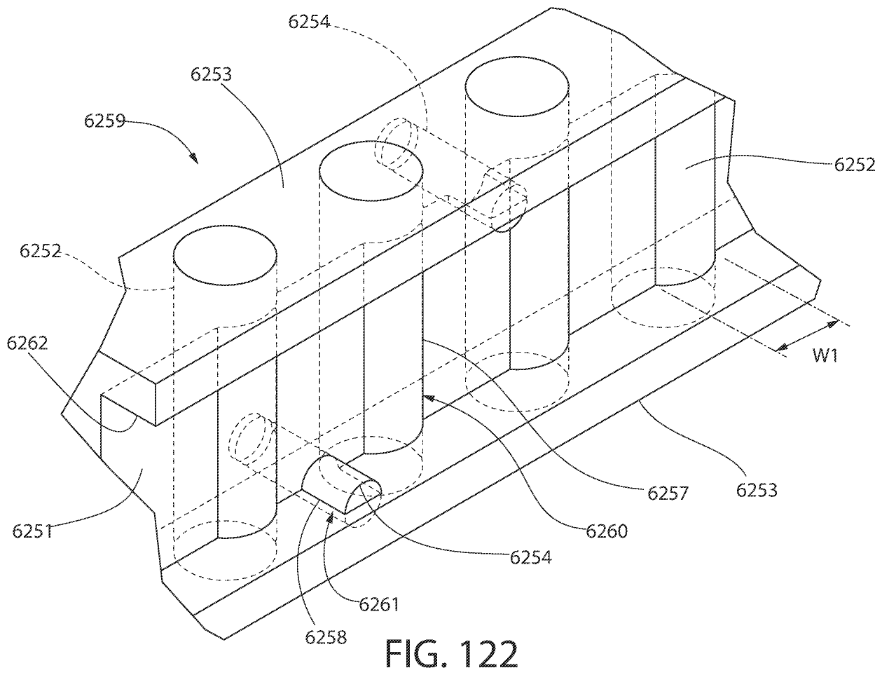

The top needle rollers 6252 are each mounted in respective complementary configured and elongated roller pockets 6257 formed in the horizontal wall 6251 in a manner which allows the rollers to rotate relative to the cage strip. Roller pockets 6257 are arranged perpendicularly to mounting axis MA when roller bearing 6250 is in a mounted position in door bracket 6120. As best shown in FIG. 122, the roller pockets 6257 each define elongated windows or openings 6260 facing inwards towards recess 6262 and through which only a portion of the diameter of needle rollers 252 are exposed and project upwards above horizontal wall 6251 to rollingly engage the top surface of support rail 6102 (see, e.g. FIG. 128). Openings 6260 have an axial width W1 measured in the direction of mounting axis MA which is less than the diameter of rollers 6252 to trap the rollers in the cage strip 6259, yet allow rotation of the rollers and engagement with support rail 6102.

Each of the sidewalls 6253 of roller bearing 6250 in one embodiment also includes a plurality of axially spaced apart and elongated lateral needle rollers 6254 having a similar cylindrical configuration to rollers 6252. Lateral needle rollers 6254 are oriented vertically and perpendicularly to top needle rollers 6252. Lateral needle rollers 6254 are each similarly mounted in respective roller pockets 6258 having openings 6261 facing inwards towards recess 6262 of the cage strip 259, and through which only a portion of the diameter of needle rollers 6254 are exposed and project laterally inwards into recess 6262 beyond sidewalls 6253 (see, e.g. FIG. 128). Roller pockets 6258 are configured to retain the rollers 6254 in the cage strip in a similar manner to rollers 6252. The lateral needle rollers 6254 are arranged to engage the lateral side surfaces of support rail 6102. In one embodiment, each sidewall 6253 of cage strip 6259 includes at least one pair of lateral needle rollers 6254 as shown for engaging the support rail 6102 (i.e. vertical front and rear surfaces 6102c, 6102d) at two different points of rolling contact. Advantageously, the lateral needle rollers 6254 prevent rubbing and friction between the lateral side surfaces of support rail 6102 and the door bracket 6120 to ensure smooth rolling movement of door bracket and door 6101 along the support rail during opening and closing sliding motions of the door. In addition, these lateral needle rollers 6254 advantageously also resist any front-to-back swaying motion of the door at the top of support rail 6102, whereas stop surface 6146 formed on anti-sway clip 6124 and facing inwards towards channel 6160 resists any front-to-back swaying motion of the door at the bottom of the support rail 6102 (see, e.g. FIG. 128). This combination of top and bottom anti-sway features advantageously enhances lateral support and resistance to swaying door motions to ensure smooth rolling of the door 6102 along the support rail 6102 even if the user pushes against the door while rolling it open or closed.

In other possible embodiments, only the rear sidewall 6253 of roller bearing 6250 in one embodiment may include a plurality of axially spaced apart and elongated lateral needle rollers 6254 to arrest motion of the door in a plane transverse to the mounting axis MA if the user pushes against the door. In such embodiments, the front sidewall 6253 of the roller bearing 6250 may optionally be omitted in some embodiment, or alternatively retained but without lateral needle rollers 6254. In yet other embodiments having only rear lateral needle rollers 6254 and no front sidewall 6253, such a roller bearing 6250 construction may be used in conjunction with nylon gasket 6170 on hanger 6122 previously described herein.

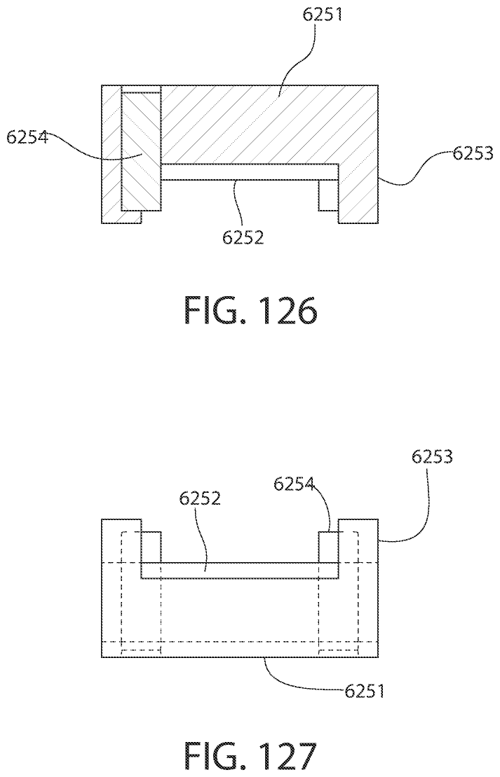

To ensure the lateral needle rollers 6254 are securely retained in the U-shaped cage strip 6259, a portion of the roller pockets 6258 and rollers 6254 extend at least partially into top wall 6251 of the cage strip (referring FIGS. 121-122 and 124-127). This advantageously maximizes the length of the rollers 6254 while minimizing the height of the cage strip 6250 to allow for a compact bearing mounting arrangement. In one embodiment, at least half of the length of rollers 6254 (e.g. upper portions) may be embedded in the top wall 6251 of the cage strip (see, e.g. cross section of FIG. 126). Accordingly, only the lower portion of rollers 6254 are exposed in cage strip recess 6262 to engage the support rail 6102.

In one embodiment, the lateral needle rollers 6254 may each be interspersed between the top needle rollers 6252. Advantageously, this minimizes the size and profile of the cage strip 6259 allowing for a compact construction. Because the laterally-acting loads or forces imparted to the cage strip 6259 by the door bracket 6120 bracket caused by swaying of door 6101 into/out of the plane of the door are significantly less than the vertically-acting loads or forces caused by the dead weight the door, the lateral needle rollers 6254 may be smaller in diameter and/or length than the top needle rollers 6252 in some embodiments as shown. This further contributes to the compactness of the cage strip 6259. In addition, the lateral needle rollers 6254 may be smaller in number than the top needle rollers 6252. In some embodiments, the lateral needle rollers 6254 may spaced farther apart than the top needle rollers 6252.

The case strip 6259 may preferably be formed of plastic (e.g. nylon, etc.) in one embodiment, or alternatively metal in other embodiments. The needle rollers 6252, 6254 may preferably be made of a suitably strong plastic (e.g. polypropylene, etc.) in one embodiment to withstand engagement with the metal support rail 6102 for supporting the weight of the door without deformation. Other possible embodiments may use metal needle rollers. Accordingly, any combination of metal or plastic rollers and cage strip materials may be used together. In a preferred but non-limiting embodiment, a plastic case strip 6259 and rollers 6252, 6254 are used. The foregoing same combinations of materials may be used for roller bearing 6150 previously described herein.

FIG. 128 shows the present multi-directional roller bearing 6250 in a mounted position within the horizontally-extending channel 6160 of the door bracket 6120 on the underside of the top wall section 6131 of the hanger 6122. Roller bearing 6250 may have a length substantially coextensive with the horizontal length of the hanger 6122 (in a similar vane to roller bearing 6150 previously described herein). In operation, the top needle rollers 6252 of bearing 6250 ride along the horizontal top surface 6102a of the support rail 6102 as the door 6103 is rolled back and forth on the rail. The needle rollers 6252 support the weight of the door and any attached hardware such as door brackets 6120, as previously described herein. If the user happens to push and apply an inward or outward directed force acting normally to the door (i.e. towards the left or right in FIG. 128) while sliding the door axially along mounting axis MA, this will cause the door to tilt or cant out of its normal vertical hanging plane about the hanger 6122 at top which suspends the door 6101 from the mounting rail 6102. The lateral needle rollers 6254, however, advantageously provides lateral guidance for door 6101 via rolling engagement with the lateral vertical front surface 6102c and/or opposite vertical rear surface 6102d of the support rail 6102. This not only helps stabilize the door, but advantageously reduces friction between the door bracket 6120 and support rail 6102 to ensure smooth gliding motion of the door.

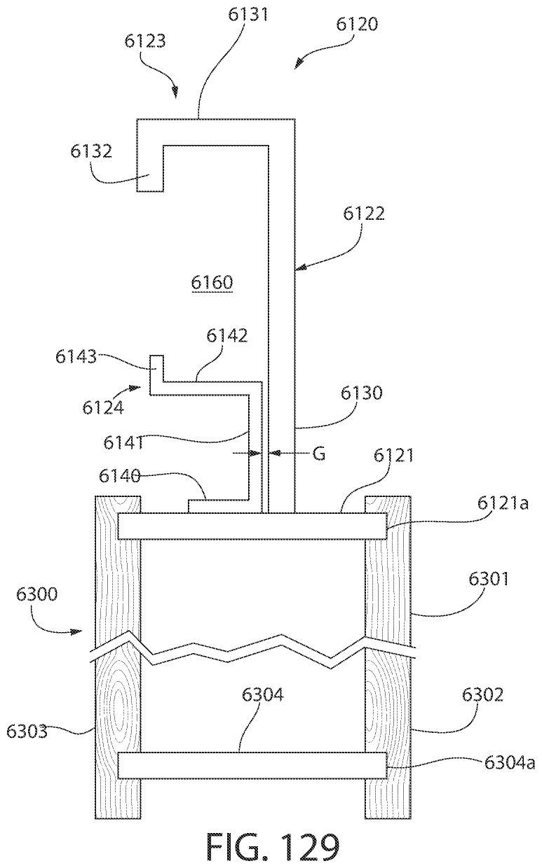

FIG. 129 shows an alternative embodiment of mounting door bracket 6120 configured for mounting to hollow door 6300 which may lack a solid top rail 6103 as described in previous embodiments. This allows a low cost and extremely light weight sliding door system to be provided. Door 6300 includes substantially planar non-structural front panel 6302 and rear panel 6303 each of which define a major exterior surface. Panels 6302 and 6303 may have a solid construction and be arranged in spaced parallel relationship, thereby collectively defining a substantially hollow interior 6301 of the door. The interior 6301 may or may not optionally include suitable acoustic sound insulation (e.g. fiberglass, mineral wool, etc.) in some embodiments to reduce sound transference from one building space to the adjacent one. In some embodiments, the interior 6301 may include a paper or fiberglass honeycomb cellular core insert comprising a plurality of open cells if added strength is desired to structurally reinforce the door.

The opposing lateral front and rear edges 6121a of the door mount base plate 6121 on the bottom of door bracket 6120 are fixedly embedded in and secured within door interior 6301 to the front and rear panels 6302, 6303. The embedment may include the use of suitable industrial adhesives in some embodiment to permanently affix the base plate 6121 to the panels. Base plate 6121 is positioned for mounting at the upper or top portion of door 6300 as shown. It bears noting that in addition to fixing the base plate 6121 of door bracket 6120 to the door 6300, the base plate also serves the role of structurally coupling the front and rear door panels 6301, 6302 together at the top of the door. To couple the panels together near the bottom of the door, an embedment plate 6304 of similar construction and size to base plate 6121 may be provided having front and rear edges 6304a also embedded in the panels in similar fashion. Each of base plate 6121 and embedment plate 6304 may have a planar rectangular shape similar to that further shown in FIG. 113 for door bracket 6120. The base plate 6121 and/or embedment plate 6304 may have axial widths that extend for less than a majority of the axial width of the door 6300 (similar to that shown in FIG. 105 for door 6101), or alternatively more than a majority of the width for firmly securing the front and rear panels together. The base plate 6121 and embedment plate 6304 may have the same or different widths.

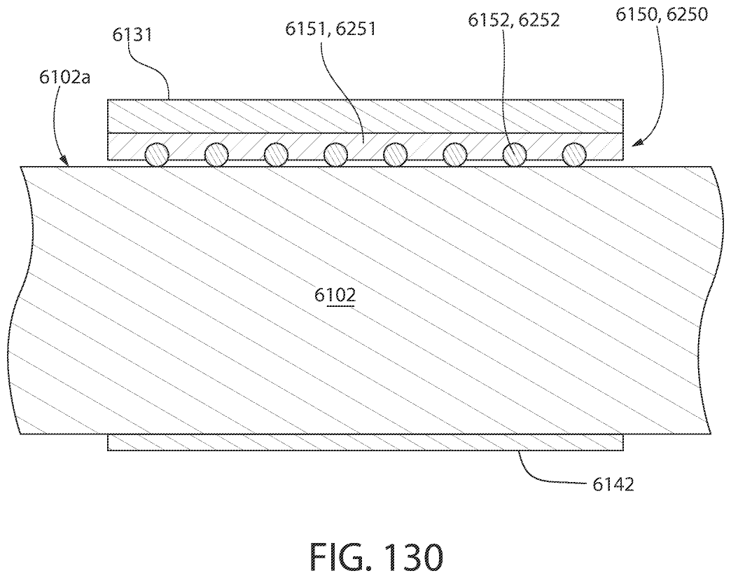

FIG. 130 is a longitudinal cross sectional view representative of both of the linear needle roller bearings 6150, 6250 of the door mounting system brackets of FIGS. 108 and 128 with respect to engagement of the needle rollers 6152, 6252 with the top surface 6102a of the mounting rail 6102. This sectional view is taken along a bisecting vertical plane as indicated in FIGS. 108 and 128 through the central portion of the roller bearings 6150, 6250 so that the vertical needle rollers 6254 of the door hanger embodiment of roller bearing 6250 is not visible in FIG. 130. As seen, the horizontal oriented needle rollers 6152, 6252 rollingly engage the top surface 6102a of mounting rail 6102 when the door(s) is/are operated.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention.

It will be understood that while the invention has been described in conjunction with specific embodiments thereof, the foregoing description and examples are intended to illustrate, but not limit the scope of the invention. Other aspects, advantages and modifications will be apparent to those skilled in the art to which the invention pertains, and these aspects and modifications are within the scope of the invention and described and claimed herein.

1.-36. (canceled)

37. A mounting system for fastening an accessory to a wall, the system comprising:
a support structure configured for mounting an accessory thereto, the support structure comprising a perimeter frame formed by a plurality of side elements each including a vertical portion and a horizontal portion;
a force-distributing plate configured to be positioned against an outer surface of the wall, the force-distributing plate interspersed between the wall and a rear side element of the plurality of side elements which is configured for fastening to the wall, the force-distributing plate creating a gap between the rear side element and the outer surface of the wall;
a cover configured to cover at least a portion of the gap, the cover having a first rear face and a second rear face offset from the first rear face;
a fastener that extends through the cover, the mountable one of the side elements, and the force-distributing plate, the fastener being configured to fasten the cover, the rear side element, and the force-distributing plate to the wall in stacked relationship;
wherein the first rear face of the cover contacts the rear side element in an installed position, and the second rear face of the cover contacts the outer surface of the wall in the installed position.

38. The system according to claim 37, wherein the vertical portions and the horizontal portions are substantially planar and intersect forming perpendicular corners between adjacent vertical portions.

39. The system according to claim 38, wherein the horizontal portions converge to define a central opening of the support structure.

40. The system according to claim 38, wherein the perimeter frame defines an upwardly open receptacle configured to receive at least a portion of a soap dispenser therein, the soap dispenser including a reservoir and a distributing tube extending downward from the reservoir and through the central opening of the support structure from which soap is dispensed.

41. The system according to claim 38, wherein the support structure defines an upwardly open receptacle configured to receive at least a portion of a shelf insert therein.

42. The system according to claim 41, wherein the shelf insert has a top which extends beyond top edges of the side elements of the support structure to form cantilevered overhangs.

43. The system according to claim 41, wherein the shelf insert has a top which does not extend beyond the side elements of the support structure.

44. The system according to claim 43, wherein the top of the shelf insert is substantially flush with top edges of the side elements.

45. A shelf support system comprising:
a wall defining an outer surface;
a perimeter frame formed by a plurality of side elements, at least one of the side elements mounted to the wall which supports the perimeter frame in a cantilevered manner;
the perimeter frame defining an upwardly open receptacle; and
a shelf insert inserted into the upwardly open receptacle, the perimeter frame circumscribing the shelf insert and at least partially concealing a side surface of the shelf insert, a top surface of the shelf insert being exposed.

46. The system of claim 45, wherein the shelf insert is completely inserted into the perimeter frame such that only the top surface is visible after insertion into the perimeter frame and the shelf insert does not extend laterally beyond the side elements.

47. The system according to claim 46, wherein the top surface of the shelf insert is substantially flush with top edges of the side elements.

48. The system of claim 45, wherein the shelf insert has a monolithic unitary construction formed of a single material.

49. The system of claim 45, wherein the shelf insert has a composite construction comprising a lower core layer formed of a first material, and a veneered upper layer formed of a second material and which defines the top surface.

50. A shelf support system comprising:
a wall defining an outer surface;
a perimeter frame formed by a plurality of side elements, at least one of the side elements mounted to the wall which supports the perimeter frame in a cantilevered manner;
the perimeter frame defining an upwardly open receptacle; and
a shelf insert including a lower portion inserted into the upwardly open receptacle and an upper portion defining a top surface which extends beyond top edges of the side elements of the perimeter frame which are not mounted to the wall to form cantilevered overhangs.

51. The system according to claim 50, further comprising a U-shaped groove formed on an underside of the shelf insert, the side elements not mounted to the wall at least partially inserted into the groove, the groove having a depth such that a portion of the side elements not mounted to the wall remain exposed.

52. The system according to claim 51, wherein the groove includes two parallel groove sections that extend front to back and perpendicularly to the rear side of shelf insert and a transverse groove section extending right to left between front ends of the parallel groove sections.

53. The system according to claim 51, wherein the groove has a depth less than a height of the side elements not mounted to the wall.

54. The system according to claim 50, further comprising a U-shaped channel formed on an underside of the shelf insert, the side elements not mounted to the wall being fully inserted into the channel, the groove having a depth at least coextensive with a height of the side elements not mounted to completely conceal those side elements.

55. The system according to claim 54, wherein the channel has a width larger than at least twice a thickness of the side elements not mounted to the wall.

56. The system according to claim 50, wherein the shelf insert includes a recess in a rear side of shelf insert that is adjacent to the wall.

57.-84. (canceled)
